(19) United States
(12) Patent Application Publication
(10) Pub. No.: US 2004/0249676 A1
(43) Pub. Date: Dec. 9, 2004

(54) Management systems and methods

(76) Inventors: W. John S. Marshall, Kingston (CA); John S. Lott, Kingston (CA); Jonathan L. Bennett, Kingston (CA)

Correspondence Address: DOWELL & DOWELL PC, 2111 Eisenhower Ave., Suite 406, Alexandria, VA, 22314, US

(21) Appl. No.: 10/860,737

(22) Filed: Jun. 4, 2004

Related U.S. Application Data
(60) Provisional application No. 60/475,913, filed on Jun. 5, 2003.
(60) Provisional application No. 60/487,230, filed on Jul. 16, 2003.

(51) Int. Cl. G06F 17/60

(52) U.S. Cl. 705/2

(57) ABSTRACT

A management system is used for management of patients on waiting lists in such fields as elective surgery, diagnostic services, clinic services and endoscopies. The system also administers administrative entities based on aggregate data provided by the system. The system has data entry, list management, audit and reporting functions. It acquires and creates its data. It calculates much data dynamically (in real time). For example, it stores data on when a patient entered onto a waiting list, and a patient's urgency score. Based on the urgency score, it calculates a target date for the patient. It dynamically (in real time) calculates the number of days a patient is from the target date, and ranks the patients accordingly. It filters a list of patients awaiting procedures according to various resource criteria. It provides for and manages referrals between systems, and lists, in different fields, and it allows calendar booking.

### CROSS-REFERENCE TO RELATED APPLICATIONS

This application claims is entitled to the benefit of previously filed U.S. provisional patent application Nos. 60/475,913 and 60/487,230 filed 5 Jun. 2003 and 16 Jul. 2003, respectively, under the title Management System, Methods and Tools. The contents of each of the above applications is hereby incorporated by reference into the Detailed Description.

### FIELD OF THE INVENTION

The invention relates to management systems and methods. In particular it relates to such systems and methods for medical resource management and such systems and methods for patient management.

### BACKGROUND OF THE INVENTION

In many fields resources are scarce. Management is required to balance competing interests in determining how to allocate resources, and how to improve resource availability. An example of current concern throughout the world is the medical field. Medical resources are very costly and often in short supply. Even in the developed world there is a limited number of operating rooms, surgeons, anaesthetists, support personnel and diagnostic tools. Doctors and administrators are constantly making judgments as to how to allocate resources.

For a patient, this can mean a lengthy wait on a doctor's waiting list without knowing when treatment will occur. For a doctor, it can mean constant decisions as to which patient should be treated next. For an administrator, it can mean difficult decisions about how to staff and support hospitals, when to close or create hospitals and, how to allocate other resources.

A surgeon, and the surgeon's support staff, typically maintains a list of patients requiring medical procedures. The list may be paper-based or, more and more, the list is stored on a computer. A surgeon is typically allocated a certain amount of operating room time during a given period, for example two weeks or a month. The surgeon, using his or her professional judgment, assigns a portion of the surgeon's available operating room time to each patient, until the time runs out. Those not on the surgical list will have to wait until more time becomes available.

An assignment of operating room time to a particular patient is not a guarantee that the procedure will take place as a change in circumstances, such as the condition of other patients, the availability of the surgeon, or a lack of resources may require a reassignment of operating room time right up until the moment that a given procedure was to be performed.

Except to hear from surgeons about the above difficulties and to read about waiting lists in the newspaper, patients have very little specific information about when their surgery might occur, or what is causing the difficulty.

Doctors are often asked to provide a report about the status of their waiting lists. From this information, administrators (including hospital administrators, politicians and others) base their decisions on allocating resources, removing resources and creating new resources. Often the information is out of date, incomplete and inaccurate. This is particularly difficult for large institutions, especially those that are publicly funded. Resources are very tight, and administration is large, cumbersome and disconnected from what is happening day to day in the delivery process.

Assistance with one or more of these problems or other related problems would be helpful.

### SUMMARY OF THE INVENTION

In a first aspect the invention provides an automated tool for assisting those responsible for patient care in managing patients awaiting procedures. The tool has a dynamic database including referral date and other data related to scheduling and carrying out procedures, such data being integrated. It also has mechanisms for setting priorities of the patients awaiting procedures, and defined interdependencies between the integrated data. The automated tool provides for a healthcare provider to facilitate decision-making while capturing aggregate data to enable reporting on a patient waiting continuum.

Among other providers, the healthcare provider may include physicians, their office staff, case managers, nurses, hospital and system managers and administrators. Among other things, managing patients may include ensuring the patients require the procedures, determining relative priority of patients, ensuring the patient's preparation for the procedure, determining the patients availability to undergo the procedure, determining the patient's readiness to undergo the procedure, or matching the resources required for the patient to undergo the procedure with the resources available at the time of potential booking.

Among other procedures, procedures may include surgical procedures in an operating room, other therapeutic procedures such as endoscopic procedures, or diagnostic procedures such as MRIs and CT Scans and clinic and office visits and consultations.

The database may be dynamic in that data in the database is recorded, stored and updated in real time as circumstances change for individual patients. The referral date may be the date on which the request for the procedure was made to the healthcare provider.

Among other things, other data related to scheduling and carrying out procedures may be demographic data relating to individual patients, the relative degree of urgency of the procedure for individual patients, required preparation of the patient for the procedure, or the availability or unavailability of the patient to receive the procedure and the resources required to deliver the procedure.

Among other things, demographic data relating to individual patients may include the patients name, age date of birth, unique identification number, patient address or contact information relevant to the patient. The relative degree of urgency of the procedure for individual patients may include an urgency score that can be associated with a target waiting time.

Among other things, the required preparation of the patient for the procedure may include required consultations, required investigations, required documentation or required patient education.

Among other things, the availability or unavailability of the patient to receive the procedure may include knowledge of patients under going other healthcare procedures, patients absent on vacation and not willing to return for the procedure, patients unable to attend because of unavoidable work commitments, or patients unable to attend because of responsibilities as sole caregiver to an invalid dependant.

Among other things, the resources required to deliver the procedure may include the site where the procedure is to be delivered, the time required to deliver the procedure, the special equipment required to deliver the procedure, the specific personnel required to deliver the procedure or when relevant the need for an available hospital bed to deliver the procedure.

Among other things, the integrating these data elements may include the production of tables and reports which itemize the relevant data elements for individual patients which will support decision making as to their readiness and appropriateness for surgery at particular times, processes that allow selection of patients meeting single or multiple defined criteria or presenting that data in a fashion that supports the selection of the most appropriate patient to receive procedure on a particular day in light of the available resources on that day.

Among other things, the mechanisms for setting priorities may include calculating on the basis of the urgency score and its associated target time for the procedure for the particular patient the number of days to target, in real time, or presenting that information for all the patients of an individual care provider in rank order.

Among other things, defined interdependence between integrated data may include organizing data in reports to allow identification of interdependent elements that will determine the patient's suitability to receive the procedure at a particular time.

Among other things, the tool may include data presented by a user-friendly interface with interactive logic for clinical decision making.

Among other things, at the same time capturing aggregate data may include recording in retrievable format all data elements referred to above, which data elements are made concurrent and valid by being part of the patient care process, these data elements being continuously updated during the process of the patient's care and contain all relevant information on the continuum of the waiting process, the nature of the data capture and recording process being such that each element can be related to any other or any combination of multiple other data elements in reports.

Among other things, enabling reporting on a patient waiting continuum may include the production of at least one predefined report, such as real time status of waiting for individual patients; on real time status of waiting for procedures from specific providers or groups of providers; on the real time status of waiting for specific procedures between individual providers or groups of providers; the waiting experience of patients who have received the required procedure presented on the basis of procedure, provider, groups of providers or institution; trends in waiting times over time on the basis of procedure, provider groups of providers or institutions; the contribution of various elements such as waiting for pre-procedure requirements, patient availability, waiting for initial consultation to the total waiting time; or the compliance with data standards by the users of the system and those who enter data.

In a second aspect the invention provides a management system having a database for storing patient waiting data. Such data includes the date a patient entered onto a list for a procedure, an urgency score for the patient for the procedure, a target number of days to receive the procedure based on the urgency score, and whether or not the patient indicates that the patient is unavailable. The management system also has means for calculating a target date for the patient for the procedure based on the date the patient entered onto the list for that procedure and the target number of days, and means for calculating, for any given date prior to the procedure taking place, the number of days the given date is from the target date. Alternatively, the means for calculating may be calculators for calculating.

The database may be for storing and the means for calculating may be for a plurality of patients, and the system may rank the patients according to the number of days each patient is from target for the procedure.

The system may also have data entry means for acquiring at least part of the patient waiting data. The data entry means may have data acquisition forms. The means for calculating may have data processing modules.

The system may have a list management module that includes the means for calculating, and includes means for displaying the number of days each patient is from its respective target date. The system may have a list management module that includes the means for calculating, and includes means for displaying the ranking of each patient.

The system may have means for displaying aggregate days from target date data for a plurality of patients. The plurality of patients may be grouped according to a single procedure. The plurality of patients may be grouped according to a single doctor. The plurality of patients may be grouped according to a single site or multiple sites. The plurality of patients may be grouped according to an administrative entity.

The system may have means for generating audits of waiting list data based on the target date of a patient. The system may have means for auditing waiting list data of patients that have waited longer than a defined period.

The system may also have means for calculating a total number of days a patient is unavailable and means for calculating the total number of days a patient has been on the list, and the database may store the total number of days a patient is unavailable for the procedure. The system may also have means for adjusting the calculated number of days that the patient has been on the list by the total number of days the patient is unavailable.

The database may store a record of pre-procedure requirements required before the procedure can take place, and store whether or not each pre-procedure requirement has taken place. The system may have means for providing notification of outstanding requirements related to the pre-procedure requirements. The system may have means for indicating that the patient is ready. The system may have means for filtering the list of patients awaiting procedures according to at least one resource criteria. The system may have means for indicating that the patient is ready when all preoperative requirements have been met and the patient is not unavailable.

The system may have means to generate reports on active patient waiting list status. The system may have an interface to an operating room (OR) booking system, facilitating the flow of data to and from such a system. The system may have an interface to a hospital central patient index database, facilitating the flow of data to and from such a database.

In a third aspect the invention provides a management system having a database for storing patient waiting data. Such data includes the date a patient entered onto a list for a procedure, an urgency score for the patient for the procedure, a target number of days to receive the procedure based on the urgency score, and pre-procedure requirements required before the procedure can take place, and whether or not each pre-procedure requirement has taken place. The management system also has means for calculating a target date for the patient for the procedure based on the date the patient entered onto the list for that procedure and the target number of days, and means for calculating, for any given date prior to the procedure taking place, the number of days the given date is from the target date. Alternatively, the means for calculating may be calculators for calculating.

The database may be for storing and the means for calculating may be for a plurality of patients, and the system may rank the patients according to the number of days each patient is from target for the procedure.

The system may also have data entry means for acquiring at least part of the patient waiting data. The data entry means may have data acquisition forms. The means for calculating may have data processing modules.

The system may have a list management module that includes the means for calculating, and includes means for displaying the number of days each patient is from its respective target date. The system may have a list management module that includes the means for calculating, and includes means for displaying the ranking of each patient.

The system may have means for displaying aggregate days from target date data for a plurality of patients. The plurality of patients may be grouped according to a single procedure. The plurality of patients may be grouped according to a single doctor. The plurality of patients may be grouped according to a single site or multiple sites. The plurality of patients may be grouped according to an administrative entity.

The system may have means for generating audits of waiting list data based on the target date of a patient. The system may have means for auditing waiting list data of patients that have waited longer than a defined period.

The database may store whether or not the patient indicates that the patient is unavailable, and the system may also have means for calculating a total number of days a patient is unavailable and means for calculating the total number of days a patient has been on the list, and the database may store the total number of days a patient is unavailable for the procedure. The system may also have means for adjusting the calculated number of days that the patient has been on the list by the total number of days the patient is unavailable.

The system may have means for providing notification of outstanding requirements related to the pre-procedure requirements. The system may have means for indicating that the patient is ready. The system may have means for filtering the list of patients awaiting procedures according to at least one resource criteria. The system may have means for indicating that the patient is ready when all preoperative requirements have been met and the patient is not unavailable.

The system may have means to generate reports on active patient waiting list status. The system may have an interface to an operating room (OR) booking system, facilitating the flow of data to and from such a system. The system may have an interface to a hospital central patient index database, facilitating the flow of data to and from such a database.

In a fourth aspect the invention provides a database schema for use in a management system. The schema has a first field for storing the date a patient entered onto a list for a procedure, a second field for storing an urgency score for the patient for the procedure, and a third field for storing a target number of days to receive the procedure based on the urgency score and a fourth field for storing whether or not the patient indicates that the patient is unavailable. The data stored in the fields is available prior to the procedure taking place.

In a fifth aspect the invention provides a database schema for use in a management system. The schema has a first field for storing the date a patient entered onto a list for a procedure, a second field for storing an urgency score for the patient for the procedure, a third field for storing a target number of days to receive the procedure based on the urgency score, a fourth field for storing a pre-procedure requirement required before the procedure can take place, and a fifth field for storing whether or not each pre-procedure requirement has taken place. The data stored in the fields is available prior to the procedure taking place.

In a sixth aspect the invention provides computer program instructions on computer readable media for use in association with a database containing a first field storing the date a patient entered onto a list for a procedure, a second field storing an urgency score for the patient for the procedure, a third field storing a target number of days to receive the procedure based on the urgency score, and a fourth field for storing whether or not the patient indicates that the patient is unavailable. The computer program instructions on computer readable media have instructions for a computer to calculate a target date for the patient for the procedure based on the date the patient entered onto the list for that procedure and the target number of days, and instructions for a computer to calculate, for any given date prior to the procedure taking place, the number of days the given date is from the target date.

In a seventh aspect the invention provides computer program instructions on computer readable media for use in association with a database containing a first field storing the date a patient entered onto a list for a procedure, a second field storing an urgency score for the patient for the procedure, a third field storing a target number of days to receive the procedure based on the urgency score, and a fourth field for storing a pre-procedure requirement required before the procedure can take place, and a fifth field for storing whether or not each pre-procedure requirement has taken place. The computer program instructions on computer readable media have instructions for a computer to calculate a target date for the patient for the procedure based on the date the patient entered onto the list for that procedure and the target number of days, and instructions for a computer to calculate, for any given date prior to the procedure taking place, the number of days the given date is from the target date.

In an eighth aspect the invention provides a user interface screen having a first data element for viewing the date a patient entered onto a list for a procedure, a second data element for viewing an urgency score for the patient for the procedure, and a third data element for viewing a target number of days to receive the procedure based on the urgency score, and a fourth data element for viewing whether or not the patient indicates that the patient is unavailable.

In a ninth aspect the invention provides a user interface screen having a first data element for viewing the date a patient entered onto a list for a procedure, a second data element for viewing an urgency score for the patient for the procedure, a third data element for viewing a target number of days to receive the procedure based on the urgency score, and a fourth data element for viewing a pre-procedure requirement required before the procedure can take place, and a fifth data element for viewing whether or not each pre-procedure requirement has taken place.

In a tenth aspect the invention provides a method of operating a management system, the method storing in a database patient waiting data, including the date a patient entered onto a list for a procedure, an urgency score for the patient for the procedure, a target number of days to receive the procedure based on the urgency score, and whether or not the patient indicates that the patient is unavailable, calculating a target date for the patient for the procedure based on the date the patient entered onto the list for that procedure and the target number of days, and calculating, for any given date prior to the procedure taking place, the number of days the given date is from the target date.

In an eleventh aspect the invention provides a method of operating a management system, the method storing in a database patient waiting data, including the date a patient entered onto a list for a procedure, an urgency score for the patient for the procedure, a target number of days to receive the procedure based on the urgency score, pre-procedure requirements required before the procedure can take place, and whether or not each pre-procedure requirement has taken place, calculating a target date for the patient for the procedure based on the date the patient entered onto the list for that procedure and the target number of days, and calculating, for any given date prior to the procedure taking place, the number of days the given date is from the target date.

In a twelfth aspect the invention provides a method of managing a patient, the method determining that a patient needs a medical procedure, selecting an urgency score for the patient for the procedure, calculating a target date for the patient for the procedure based on the date the patient entered onto a list for that procedure and the target number of days, and calculating, for any given date prior to the procedure taking place, the number of days the given date is from the target date, and storing whether or not the patient indicates that the patient is unavailable.

The method may filter the list based on the above criteria. The method may track pre-procedure requirements that must take place prior to the patient having the procedure.

The method may provide notification of outstanding requirements related to the pre-procedure requirements.

In a thirteenth aspect the invention provides a method of managing a patient, the method determining that a patient needs a medical procedure, selecting an urgency score for the patient for the procedure, calculating a target date for the patient for the procedure based on the date the patient entered onto a list for that procedure and the target number of days, and calculating, for any given date prior to the procedure taking place, the number of days the given date is from the target date, storing a pre-procedure requirement required before the procedure can take place, and storing whether or not each pre-procedure requirement has taken place.

The method may filter the list based on the above criteria. The method may track pre-procedure requirements that must take place prior to the patient having the procedure.

The method may provide notification of outstanding requirements related to the pre-procedure requirements.

In the above aspects there may be a plurality of modalities, each modality utilizing the stored patient waiting data for a distinct waiting list, and a referral process for online referral of a patient to a waiting list of one of the modalities. The modalities may utilize the stored patient waiting data for waiting lists in a plurality of healthcare fields.

The referral process may permit patients to be referred from one modality to another modality, and the management system may enable patient status to be tracked through all modalities.

The above aspects may also have a calendar booking process for online booking of a patient for a procedure based on data from the database, and data of times resources for the procedure are available to be booked.

In a further aspect, the invention provides a management system having a database for storing patient data, including an urgency score for a patient for a procedure, and whether or not the patient indicates that the patient is unavailable; a plurality of modalities, each modality utilizing the stored patient data for a distinct waiting list of patients; and a referral process for online referral of a patient to a waiting list of one of the modalities.

The database may store a record of pre-procedure requirements required before the procedure can take place, and may store whether or not each pre-procedure requirement has taken place.

In the above aspects or in other aspects, a management system for elective surgery reflects one modality of the management system. It is recognized that other modalities of the management system could manage patients in other fields in a similar manner with necessary adaptations for the specific fields. For example, patients waiting for endoscopies may be ranked by an urgency score, their readiness status tracked through the wait continuum, their unavailability tracked, etc. Various modalities of the management system may incorporate other features, while incorporating similar basic functionality.

It is recognized that each of these modalities could be, but need not be, isolated systems. Each modality could be a component of a whole management system. As a totality, these components can be tied together by a process of referrals. This referrals process remains consistent throughout the modalities, and allows users to refer patients between various modalities electronically. Each modality represents a source of waiting for the patient. The flow of the patient from component to component, or modality to modality, represents a “path”. These patient paths may converge and/or diverge on each component or modality. A path is initiated by the noting of an individual complaint by the patient.

Further to the concept of the patient path, is the tracking of patient outcomes. Patient outcomes allows for the management system to note the patient status through the path of each component or modality, thereby allowing for a fuller picture of the patient's treatment through the wait continuum.

As mentioned previously, the system may facilitate the process of online referrals from component to component or modality to modality, within a single computer, between computers or across networks. Patients may be referred from any waiting list to another. For example, the system may permit users to online refer a patient from a clinic modality to an elective surgery modality. The office receiving the referral may either accept or reject the referral. The system may then report on the entire continuum of care for a patient as they are referred from modality to modality or component to component, and list to list.

The system may support the process of booking patients for procedures by way of an online calendar booking process. Users indicate which times are available to be booked on the calendar. Users may then see at a glance which patients are scheduled for procedures on which days from a calendar. When the user selects a particular day, the user may see which patients are scheduled, and the estimated time for the procedures both used and unused. The list of available patients for the day may be filtered and sorted on a variety of criteria. Users also receive notification when a particular slot of time has been overbooked based on the estimated procedure time for the patient.

The various aspects of the invention described above may have additional features and functions based on the same principles as those on which the additional features and functions of the first, second, and third aspect are based. In other aspects the invention provides other systems, databases, subsystems, modules, database schema, computer programs, user interface screens, methods and other tools based on the principles described herein.

### BRIEF DESCRIPTION OF THE DRAWINGS

For a better understanding of the present invention and to show more were clearly how it may be carried into effect, reference will now be made, by way of example, to the accompanying drawings that show the preferred embodiment of the present invention and in which:

FIG. 1 is a context level data flow diagram illustrating a management system according to the preferred embodiment of the invention interacting with a plurality of external systems.

FIG. 2 is a data flow diagram of the systems of FIG. 1 with the management system subsystems (modules) shown.

FIG. 3 is a network diagram illustrating hardware on which the management system of FIG. 1 operates, and systems that may be used to access the management system.

FIG. 4 is a schematic illustration of a database schema used in the management system of FIG. 1.

FIGS. 5A-G are a data dictionary in chart form for the database schema of FIG. 4

FIG. 6 is a flow diagram of a data entry module used in the management system of FIG. 1.

FIG. 7 is a get patient unique identifier user interface screen for the data entry module of FIG. 6.

FIG. 8 is a first list information collection user interface screen for the data entry module of FIG. 6.

FIG. 9 is a second list information collection user interface screen for the data entry module of FIG. 6.

FIG. 10 is a flow diagram of a list management module used in the management system of FIG. 1.

FIG. 11 is a wait list main user interface screen for the list management module of FIG. 10.

FIG. 12 is a view list user interface screen, before filtering for the list management module of FIG. 10.

FIG. 13 is a view list user interface screen, showing the process of a user selecting resource filters for the list management module of FIG. 10.

FIG. 14 is a view list user interface screen, after resource filtering has occurred for the list management module of FIG. 10.

FIG. 15 is a removed patients list user interface screen for the list management module of FIG. 10.

FIG. 16 is a restore patient user interface screen for the list management module of FIG. 10.

FIG. 17 is a restore patient-processing user interface screen for the list management module of FIG. 10.

FIG. 18 is a view patient user interface screen for the list management module of FIG. 10.

FIG. 19 is an OR booking form user interface screen for the list management module of FIG. 10.

FIG. 20 is a quick statistics list user interface screen for the list management module of FIG. 10.

FIG. 21 is a booking calendar user interface screen for the list management module of FIG. 10.

FIG. 22 is a edit surgery blocks user interface screen for the list management module of FIG. 10.

FIG. 23 is a edit surgery block user interface screen for the list management module of FIG. 10.

FIG. 24 is a scheduler user interface screen for the list management module of FIG. 10.

FIG. 25 is a request referral list user interface screen for the list management module of FIG. 10.

FIG. 26 is a execute referral user interface screen for the list management module of FIG. 10.

FIG. 27 is a referral summary user interface screen for the list management module of FIG. 10.

FIG. 28 is a quick remove referral user interface screen for the list management module of FIG. 10.

FIG. 29 is a flow diagram of an audit module used in the management system of FIG. 1.

FIG. 30 is a pending audits user interface screen for the audits module of FIG. 29.

FIG. 31 is a procedure audit user interface screen for the audits module of FIG. 29.

FIG. 32 is a list audit user interface screen for the audits module of FIG. 29.

FIG. 33 is a pre-operative requirements user interface screen for the audits module of FIG. 29.

FIG. 34 is an insert procedure audit user interface screen for the audits module of FIG. 29.

FIG. 35 is an insert list audit user interface screen for the audits module of FIG. 29.

FIG. 36 is a delete procedure audit user interface screen for the audits module of FIG. 29.

FIG. 37 is a delete list audit user interface screen for the audits module of FIG. 29.

FIG. 38 is a delete pre-operative requirement user interface screen for the audits module of FIG. 29.

FIG. 39 is an edit list audit user interface screen for the audits module of FIG. 29.

FIG. 40 is a flow diagram of a reports module used in the management system of FIG. 1.

FIG. 41 is a wait times user interface screen for the reports module of FIG. 40.

FIG. 42 is a patient search user interface screen for the reports module of FIG. 40.

FIG. 43 is an administrative reports user interface screen for the reports module of FIG. 40.

FIG. 44 is a list status by division (administrative entity) user interface screen for the reports module of FIG. 40.

FIG. 45 is a view removed patient user interface screen for the reports module of FIG. 40.

FIG. 46 is a chart showing a patient-centric workflow for the system of FIG. 1.

FIG. 47 is a block diagram of layers in the management system of FIG. 1.

FIG. 48 is a logon user interface screen for the management system of FIG. 1.

FIG. 49 is a first add patient user interface screen for the management system of FIG. 1.

FIG. 50 is a second add patient user interface screen for the management system of FIG. 1.

FIG. 51 is a third add patient user interface screen for the management system of FIG. 1.

FIG. 52 is an urgency descriptions user interface screen for the management system of FIG. 1.

FIG. 53 is a patient overview user interface screen for the management system of FIG. 1.

FIG. 54 is an unavailable dates user interface screen for the management system of FIG. 1.

FIG. 55 is a list overview user interface screen for the management system of FIG. 1.

FIG. 56 is a preoperative requirements overview user interface screen for the management system of FIG. 1.

FIG. 57 is a preoperative requirements user interface screen for the management system of FIG. 1.

FIG. 58 is an OR booking form user interface screen for the management system of FIG. 1.

FIG. 59 is a pending audits user interface screen for the management system of FIG. 1.

FIG. 60 is a quick statistics user interface screen for the management system of FIG. 1.

FIG. 61 is a completed cases by procedure user interface screen for the management system of FIG. 1.

FIG. 62 is a completed patients for procedure category user interface screen for the management system of FIG. 1.

FIG. 63 is a patient overview (completed patient) user interface screen for the management system of FIG. 1.

FIG. 64 is an active list status by physician user interface screen for the management system of FIG. 1.

FIG. 65 is a “help” user interface screen for the management system of FIG. 1.

FIG. 66 is a create referral user interface screen for the management system of FIG. 1.

FIG. 67 is a referrals summary user interface screen for the management system of FIG. 1.

FIG. 68 is a completed cases by procedure user interface screen for the management system of FIG. 1.

FIG. 69 is a completed patients for procedure category user interface screen for the management system of FIG. 1.

FIG. 70 is a patient encounter report user interface screen for the management system of FIG. 1.

FIG. 71 is an active list status by physician user interface screen for the management system of FIG. 1.

FIG. 72 is a user access off hours user interface screen for the management system of FIG. 1.

FIG. 73 is a field change report user interface screen for the management system of FIG. 1.

FIG. 74 is a quick statistics report by disease site and physician user interface screen for the management system of FIG. 1.

FIG. 75 is a list performance by disease site user interface screen for the management system of FIG. 1.

FIG. 76 is a list performance by physician by disease site user interface screen for the management system of FIG. 1.

FIG. 77a-g is a data dictionary chart for use on the management system of FIG. 1.

FIG. 78 is a network diagram illustrating hardware on which the management system of FIG. 1 may be operated.

FIG. 79 is a schematic illustration of a database model (schema) for use in the system, of FIG. 1.

### DETAILED DESCRIPTION OF PREFERRED EMBODIMENTS

In general, a system and method are provided for managing, and in particular, prioritizing, items in a dynamic database, wherein the items are to be subjected to one or more procedures, and wherein status of any item in the database, and constraints in completing the one or more procedures, services, or actions are factors in managing and prioritizing. For the purposes of this description and the claims herein, procedures include, for example, services or actions. Managing and prioritizing of items is carried out in relation to availability of resources required (e.g., space, personnel, time, equipment, materials), how urgently a procedure must be completed, availability of items, and readiness of items (e.g., if a pre-procedure is required prior to a procedure, readiness is whether the pre-procedure has been completed). Managing and prioritizing of items is carried out in a dynamic database, in which data is recorded, stored, and updated in real time as circumstances change for individual items. The systems and methods are useful wherever there are resource constraints (i.e., resources to ration) and varying priority of items waiting. The principles of the systems and methods can be broadly applied to healthcare (wherein the items are patients awaiting procedures) and industries such as manufacturing and shipping of items. Although the systems and methods are described herein primarily as applied to healthcare, it will be understood that the invention is not limited thereto.

It is known to create lists of items awaiting procedures. In the healthcare industry, for example, a waiting list might include a list of patients awaiting various procedures. However, such known waiting lists are static registries or queues, the most advanced of which use algorithms to prioritize patients on their way into the queue. With such systems it is not possible to manage patients once on the list, in relation to their readiness and availability, changes in priority, and availability of resources. With such prior systems the focus is on maximizing the efficiency of the system so that it moves as quickly and efficiently as possible to minimize the overall waiting time of a patient. In contrast, the systems and methods described herein provide a management tool in which data relating to, for example, item readiness and availability, changes in priority, and availability of resources, for each item are organized into various interdependent fields, such that items can be actively (i.e., dynamically) managed and prioritized.

The systems and methods described herein provide for the active management of multiple lists of items consecutively and/or concurrently (i.e., simultaneously). Such multiple lists may be, for example, contained within a master list or exist as separate lists, but in either case, the lists are appropriately interdependent so as to provide for active management of items. For example, there may be such multiple lists in a patient waiting list in a healthcare setting. There may be consecutive lists as a patient moves through a wait continuum (i.e., from one procedure to the next) or is “handed-off” from one care giver to another, for end to end tracking of a patient (e.g., waiting for an appointment with a family physician, then referred to specialist (next waiting list), then referred to surgeon (next waiting list), then referred to rehabilitation centre (yet another), and so on). There may also be concurrent lists, such as where a patient is waiting for multiple procedures at the same time; for example, a patient on a surgery waiting list who must complete two pre-operative procedures (i.e., “pre-procedures”). The two pre-operative procedure lists need to communicate to avoid conflict. They also need to communicate to the surgery waiting list to notify when the patient is ready. It will be appreciated that the systems and methods provide for a continuity of active management and prioritization of items, such as patients, across multiple disciplines.

The systems and methods may also provide aggregate data. For consecutive lists, interdependence of the lists provides for an aggregate view of a patient waiting along the continuum. Aggregate data can be used at various levels to assess factors such as performance; for instance, on a standalone basis by individual practitioner, within a department of an organization, or by an organization or network of organizations. Data can be aggregated as appropriate to obtain various levels of information/reporting. For example, a hospital department can obtain data relating to performance of individual physicians or the department as a whole. Similarly, a hospital administrator can obtain data relating to performance of each department, comparatively, and of the hospital as a whole. Such data on demand may be useful in determining how to allocate resources.

The system can be installed in many ways, for example, as an application service provider (ASP) model, locally installed on a stand-alone computer such as a desktop or laptop personal computer (i.e., a PC), a personal digital assistant (PDA), a local server, a remote server, or multiple computers/servers communicating via the internet, an intranet, VPN, or a wireless network. The system can be accessed via a client PC, a PDA, a tablet computer, and the like. Information may be input and output to/from the system remotely, e.g., input information from a PDA or pull out information onto a PDA. The system may also interface with one or more other systems such as databases/servers corresponding to specific procedures (e.g., radiology), and scheduling, accounting, laboratory, pharmacy, information, and admission/discharge systems.

According to a preferred embodiment of the invention there is provided a system and method for managing and prioritizing patients awaiting procedures in a healthcare setting. The system assists a healthcare provider in managing patients awaiting procedures by compiling a dynamic database containing referral date and other data relevant to scheduling and carrying out these procedures, and by integrating these data elements and adding mechanisms for priority setting and defining areas of interdependence between data elements. The healthcare provider is provided with an electronic tool to facilitate decision making while at the same time capturing aggregate data thus enabling reporting on the whole waiting continuum.

The tool may have means by which a healthcare provider can refer a patient to the provider of another procedure by creating a request for that procedure and initiating processes for managing patients awaiting that procedure. The tool may have means for receiving a request for a procedure and initiating processes for managing patients awaiting procedures. The tool may have means for integrating the care of a patient waiting for more than one procedure by more than one healthcare provider.

A management system for elective surgery reflects one modality of a management system. It is recognized that other modalities of a management system could manage patients in other fields in a similar manner with necessary adaptations for the specific fields. For example, patients waiting for endoscopies may be ranked by an urgency score, their readiness status tracked through the wait continuum, their unavailability tracked, etc. Various modalities of the management system may incorporate other features, while incorporating similar basic functionality.

It is recognized that each of these modalities could be, but need not be, isolated systems. Each modality could be a component of a whole management system. As a totality, these components can be tied together by a process of referrals. This referrals process remains consistent throughout the modalities, and allows users to refer patients between various modalities electronically. Each modality represents a source of waiting for the patient. The flow of the patient from component to component, or modality to modality, represents a “path”. These patient paths may converge and/or diverge on each component or modality. A path is initiated by the noting of an individual complaint by the patient.

Further to the concept of the patient path, is the tracking of patient outcomes. Patient outcomes allows for the management system to note the patient status through the path of each component or modality, thereby allowing for a fuller picture of the patient's treatment through the wait continuum.

As mentioned previously, the system may facilitate the process of online referrals from component to component or modality to modality, within a single computer, between computers or across networks. Patients may be referred from any waiting list to another. For example, the system may permit users to online refer a patient from a clinic modality to an elective surgery modality. The office receiving the referral may either accept or reject the referral. The system may then report on the entire continuum of care for a patient as they are referred from modality to modality or component to component, and list to list.

The system may support the process of booking patients for procedures by way of an online calendar booking process. Users indicate which times are available to be booked on the calendar. Users may then see at a glance which patients are scheduled for procedures on which days from a calendar. When the user selects a particular day, the user may see which patients are scheduled, the estimated time for the procedures both used and unused. The list of available patients for the day may be filtered and sorted on a variety of criteria. Users also receive notification when a particular slot of time has been overbooked based on the estimated procedure time for the patient.

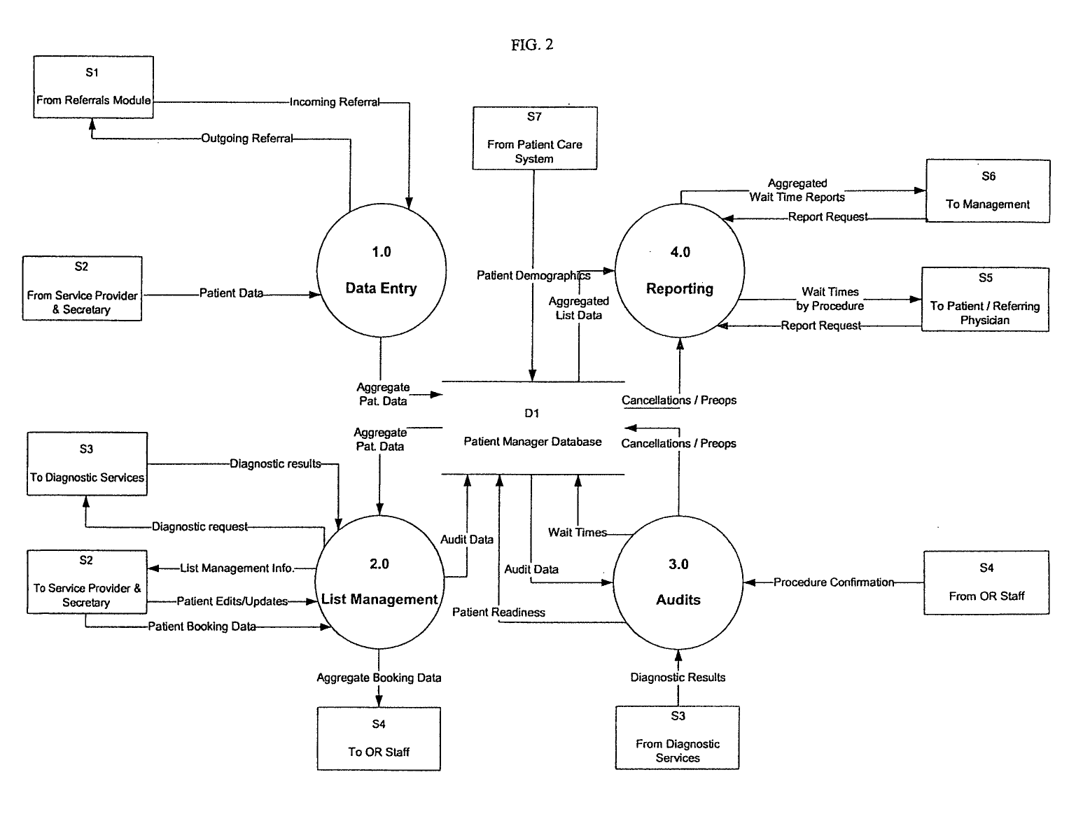

A management system for assisting a healthcare worker in managing patients awaiting procedures can take many different forms. In the preferred embodiment to be described (see FIG. 2) these forms include a management system 0, computer programs 1.0-4.0, and database D1, as well as their related methods of operation. The system assists with the entire patient waiting continuum from referral to a health care provider, scheduling, diagnosis, pre-procedure requirements, carrying out the procedure, and post-procedure follow-up. It can also assist with additional procedures to be carried out at the same as a given procedure.

The data in the database D1 can be dynamically updated and integrated. The data in the database D1 may store a record of the nature and amount of resources required for the carrying out of a procedure for a patient, such as type of anaesthetic required, inpatient or outpatient facilities, and length of time the facilities are required. The system may have means to generate reports for patients based on the resource requirements of patients for individual procedures. Mechanisms for setting priorities of patients awaiting procedures are included in the system, based for example on urgency scores and the time spent waiting for a procedure. Also included in the system are defined interdependencies between integrated data.

The healthcare provider can be, for example, a physician, a physician's office staff, a surgeon, a technician or technologist, researcher, an assistant, a case manager, a nurse, a hospital or system manager or administrator, or a regional, state, provincial, or federal health authority. Managing patients can include activities such as ensuring a patient requires a procedure, determining relative priorities of patients, ensuring a patient's preparation for a procedure, determining a patient's availability to undergo a procedure, determining the patient's readiness to undergo a procedure, and matching required resources for the patient to undergo a procedure with resources available at the time of potential booking of a procedure.

Procedures may, for example, include surgical procedures, therapeutic procedures such as endoscopy, chemotherapy, and angioplasty, diagnostic procedures such as MRIs, X-rays, and CT scans, clinic services such as blood tests, exercise tests, chiropractic services, physical therapy services, rehabilitation services, dentist and orthodontist services, home care, long-term care, office visits, consultation, counselling, and psychology and psychiatry services.

A patient may be, for example, any person needing access to a healthcare procedure, such as those procedures listed above.

The database D1 may be dynamic in that data in the database D1 is recorded, stored and updated in real-time as circumstances change for individual patients. A referral date may be the date on which a request for a procedure was made to the healthcare provider.

Other data related to scheduling and carrying out procedures may include demographic data relating to individual patients, the relative degree of urgency of a procedure for individual patients, required preparation of the patient for the procedure, the availability or unavailability of the patient to receive a procedure, or the resources required to deliver a procedure.

Demographic data relating to individual patients may include name, age, date of birth, unique identification number, address, or contact information. A relative degree of urgency of the procedure for an individual patient may include an urgency score that can be associated with a target waiting time.

Required preparation of a patient for a procedure may include such pre-procedure requirements as consultations, investigations, documentation, or patient education. The availability or unavailability of a patient to receive a procedure may include knowledge of patients undergoing other healthcare interventions, patients absent on vacation and not willing to return for a procedure, patients unable to attend because of unavoidable work commitments and patients unable to attend because of responsibilities as sole caregiver to a dependent.

The resources required to deliver a procedure may include the site where the procedure is to be delivered, the time required to deliver the procedure, the specific personnel required to deliver the procedure and, when relevant, the need for an available hospital bed to deliver the procedure.

Integrating these data elements may include the production of tables and reports that itemize relevant data elements for individual patients to support decision making as to their readiness and appropriateness for surgery at particular times, processes that allow selection of patients meeting single or multiple defined criteria, and presenting that data in a fashion that supports the selection of the most appropriate patient to receive procedure on a particular day in light of the available resources on that day.

Mechanisms for setting priorities may include calculating on the basis of the urgency score and its associated target time for the procedure for the particular patient the number of days to target, in real time, and presenting that information for all the patients of an individual care provider in rank order.

Defined interdependence between integrated data may include organizing data in reports to allow identification of interdependent elements that will determine the patient's suitability to receive the procedure at a particular time. An automated system for a healthcare provider to facilitate decision making may include the data described above presented by a user friendly interface with interactive logic for clinical decision making.

At the same time capturing aggregate data may include recording in retrievable format all data elements referred to above, which data elements are made concurrent and valid by being part of a patient care process, these data elements being continuously updated during the process of the patient's care and containing all relevant information on the continuum of the waiting process, the nature of the data capture and recording process being such that each element can be related to any other or any combination of multiple other data elements in reports.

Enabling reporting on a patient waiting continuum may include the production of at least one predefined report selected from a group such as: real time status of waiting for individual patients; real time status of waiting for procedures from specific providers or groups of providers; real time status of waiting for specific procedures between individual providers or groups of providers; the waiting experience of patients who have received the required procedure, presented on the basis of procedure, provider, groups of providers or institution; trends in waiting times over time, on the basis of procedure, provider, groups of providers or institutions; the contribution of various elements such as waiting for pre-procedure requirements, patient availability, and waiting for initial consultation to the total waiting time; and the compliance with data standards by the users of the system and those who enter data.

Audit functions can be used to maintain the integrity and validity of the data in the database D1.

The preferred embodiment of a system for use in a surgical waiting environment will now be described. In this environment procedures are operations and pre-procedure requirements are preoperative requirements.

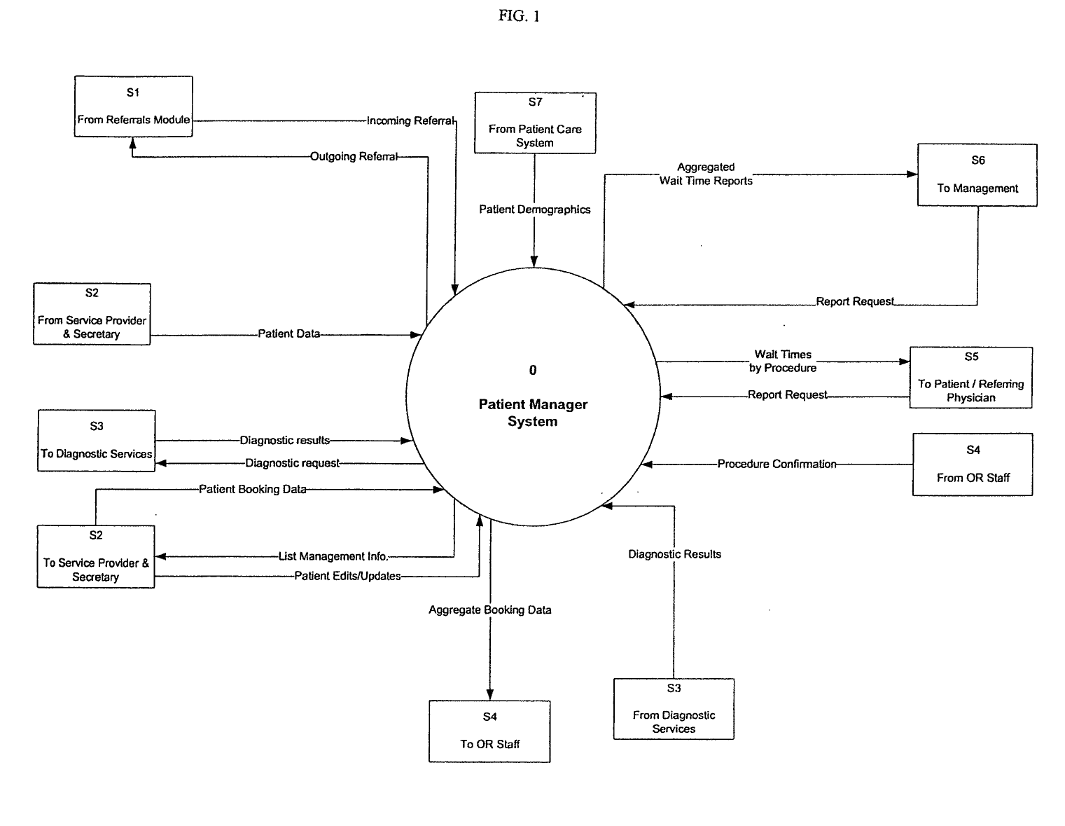

Referring to FIG. 1, a management system 0 has inputs from and outputs to many separate systems S1-S7. The system 0 takes in data from external systems S1-S7, generates its own data dynamically (in real time) as required for other aspects of the management system 0, stores data, manages lists of patients, audits the management of patients, and provides analysis of patient management the result of which is provided in the form of reports.

The management system 0 can provide assistance to healthcare providers in making decisions on the preparation, readiness, selection and timing of patients for services. The preferred embodiment of the management system 0 is used for the management of elective surgical patients. It is, however, important to note that the basic principles used by management system 0 have a variety of applications. For example, virtually any process that involves patients waiting for service can use the functionality of management system 0. Examples of this include but are not limited to elective surgery, diagnostic services, clinic services and endoscopies. In this way, the systems S1-S7 (sources/sinks) represented in FIG. 1 for management system 0 could be changed to reflect different interactions. The internal application functionality, however, could remain much the same. Thus, management system 0 for elective surgery (the so called “preferred embodiment”) represents one of the many broad uses for management system 0.

Similarly, the current implementation (to be described) of coding patient urgency, procedure, and diagnostic information within management system 0 is interchangeable. For example the scoring system for patients (urgency score) could be entirely replaced by a system such as the Western Canada Waiting List Project Patient Priority Forms (additional details may currently be found at http:/www.wcw1.org/) or alternatively substitute triage scoring systems for clinics. Similarly, diagnosis and procedure coding systems are interchangeable dependent on client needs, and can reflect various embodiments of the core functionality of management system 0, for example, diagnostic services, clinic services or endoscopies.

FIGS. 1 and 2 follow the DeMarco & Yourdon convention of data flow diagramming. Please refer to the following for additional details and examples:

http://www.keele.ac.uk/depts/cs/Staff/Homes/Mdb3/courses/SD2001/procmod.pdf

Referring to FIG. 2, the management system 0 is broken into four subsystems (data entry 1.0, list management 2.0, audits 3.0, and reporting 4.0) and a database D1. The subsystems 1.0-4.0 interact with external systems S1-S7 and database D1.

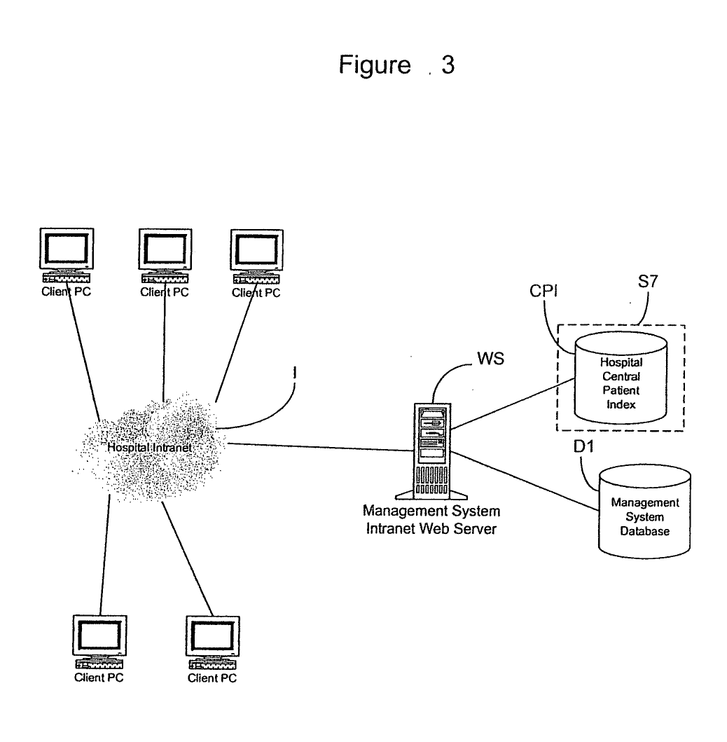

Referring to FIG. 3, subsystems 1.0-4.0 consist of software modules (more detail to follow) that run on an intranet server I. The database D1 is shown separately from the server I as it D1 can be operated from a separate server, not shown. Alternatively, it D1 may be running on server I.

The server I outputs screens to a user and receives user input. In the preferred embodiment, the server I serves (outputs) screens in the form of web pages created by the management system 0 to an intranet I, or the internet (not shown). The server I also receives user input through the served web pages. The web pages act as user interface and, also, computer program for the subsystems 1.0-4.0.

In the preferred embodiment the web pages use a combination of html tags, ColdFusion™ tags, and Javascript™ tags. The ColdFusion™ tags interact with additional computer programs written in and using ColdFusion™ that perform many of the functions described herein. Other programming and user interface environments can be used to provide similar functionality. These computer programs are also part of the subsystems 1.0-4.0.

The computer programs interact with the database D1 primarily through creating new table records, updating fields in those records, and queries of the tables and fields. The use of a web-based environment allows for easy access through web browser enabled computers (such as the personal computers, PCs, shown). As will be evident to those skilled in the art, other architectures could easily be employed for accessing management system 0; its use is not limited to browser-enabled communication. For example, users could be on a local area network each running a database back end containing the necessary user interface screens (forms) and code modules to access a proprietary database or an ANSI SQL based server.

The computer programs include computer program instructions for carrying out the features and functions described herein, and the computer program instructions are contained on computer readable media, such as a hard drive or other storage device in the computer. The computer program instructions can be distributed in many ways for installation, including on storage media or via telecommunications signal. The instructions may be encoded in a compressed format prior to installation. Screens, for example web pages, may be transmitted as telecommunications signals to users.

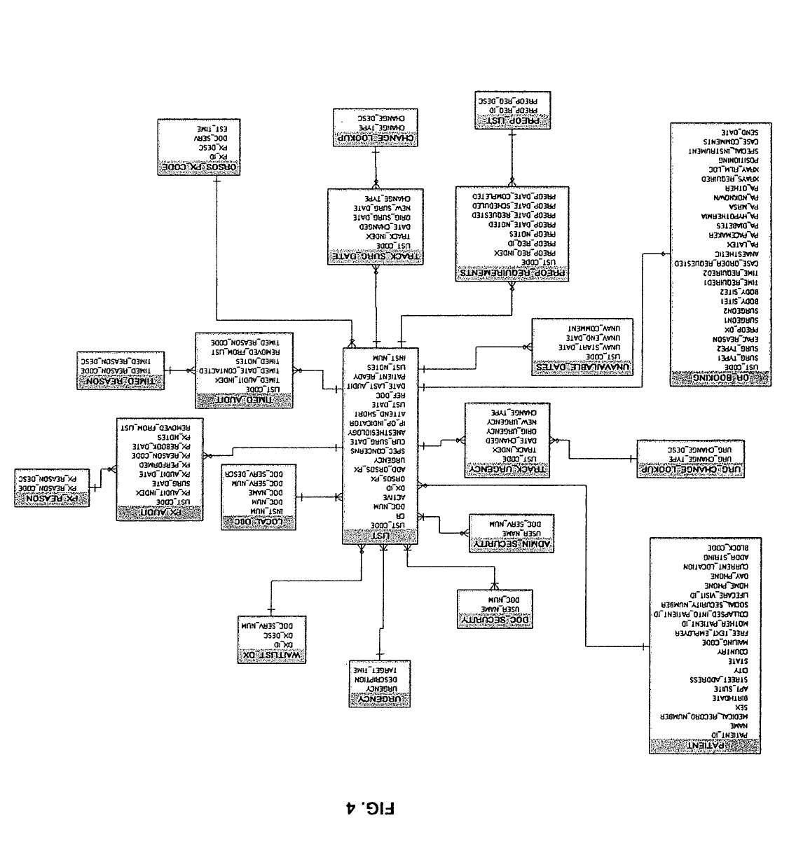

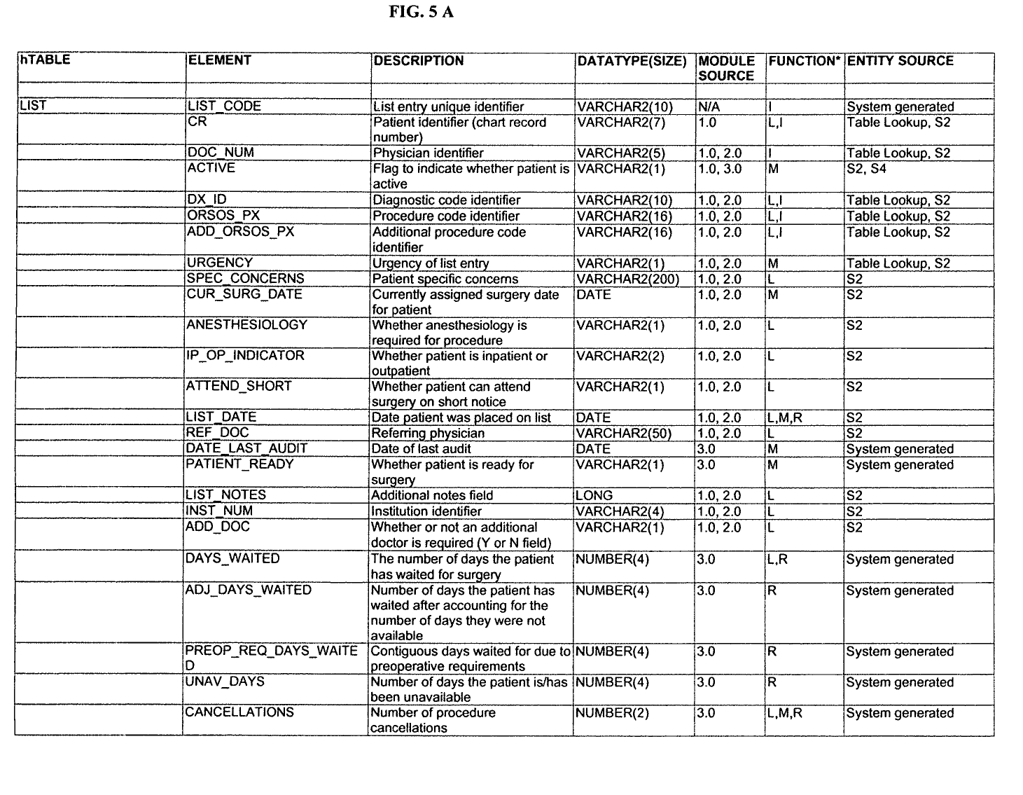

Referring to FIG. 4, database D1 has a database schema comprising many related tables, enumerated by name and shown as separate boxes. Each table contains various fields (elements), enumerated by field name. It is important to note that not all fields are necessary for all applications and implementations of the management system 0. It is also not necessary to use the specific schema set out in FIG. 4. It has been found that the use of related tables allows for ease of comprehension and for efficient storage and access; however, other database structures could be used, for example, and without limitation, flat files. Specific fields are not limited to placement in specific tables.

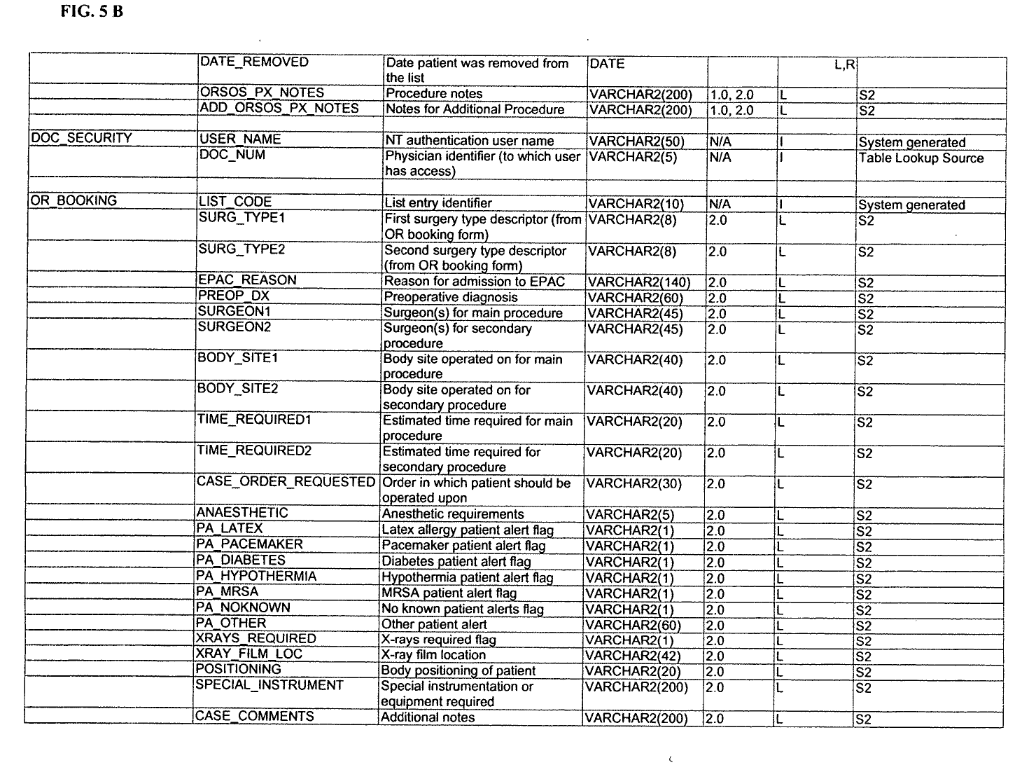

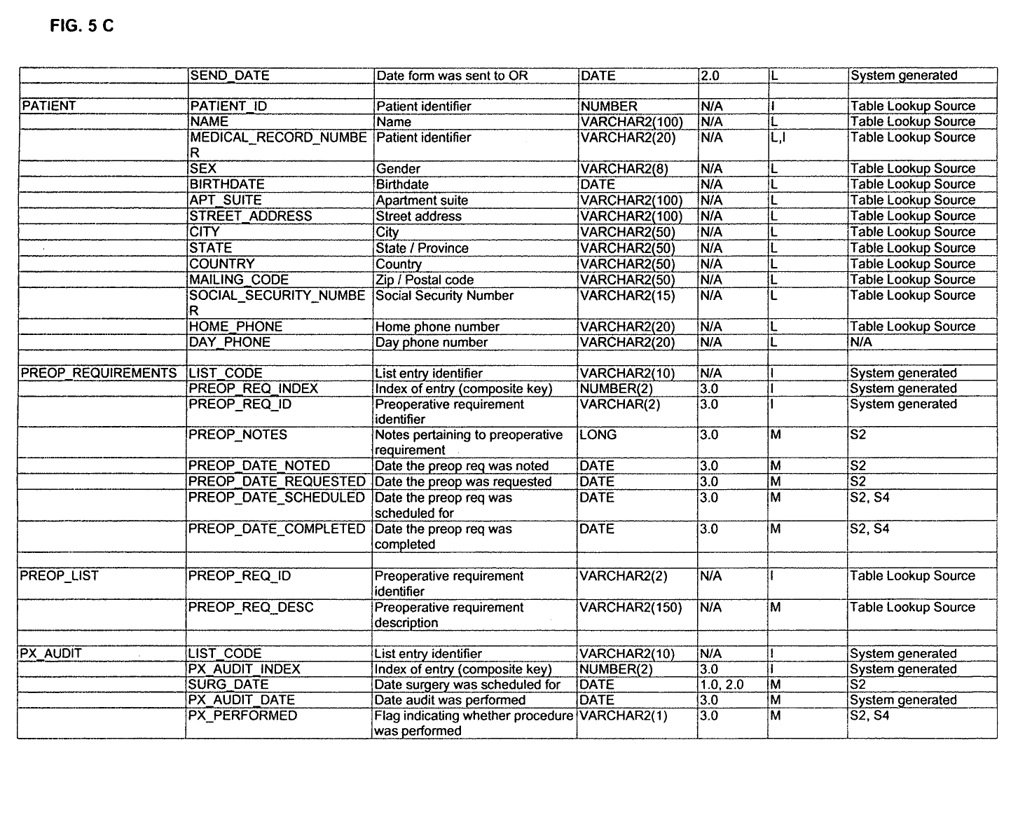

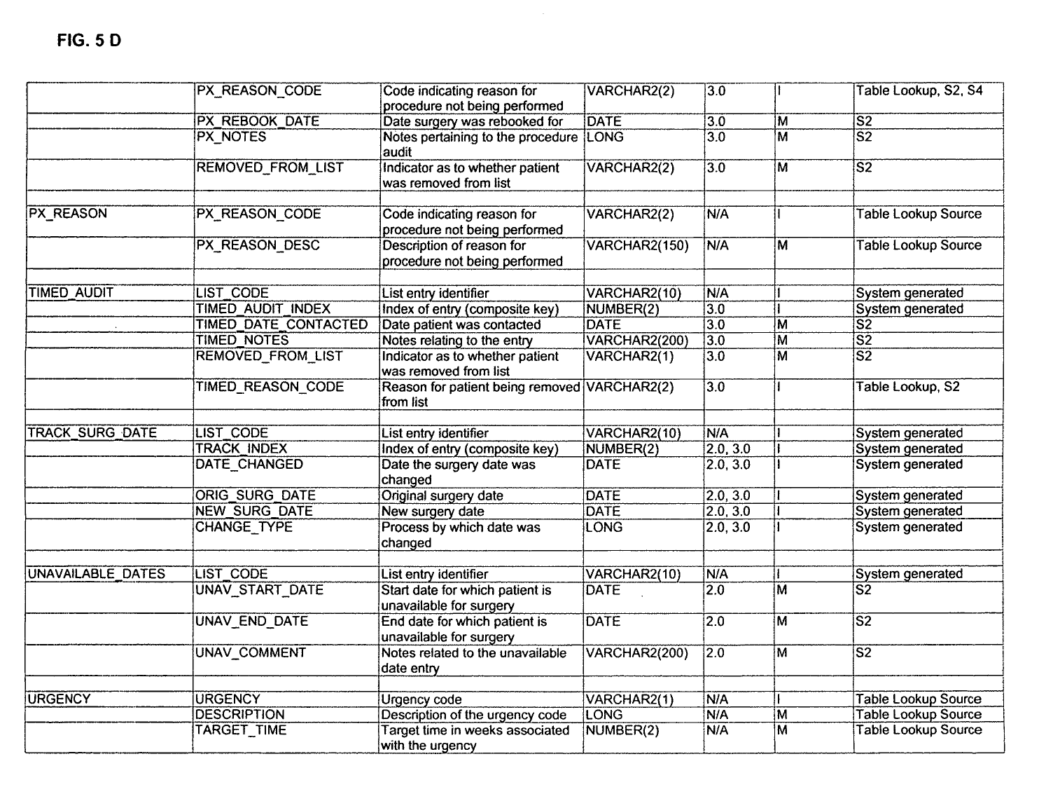

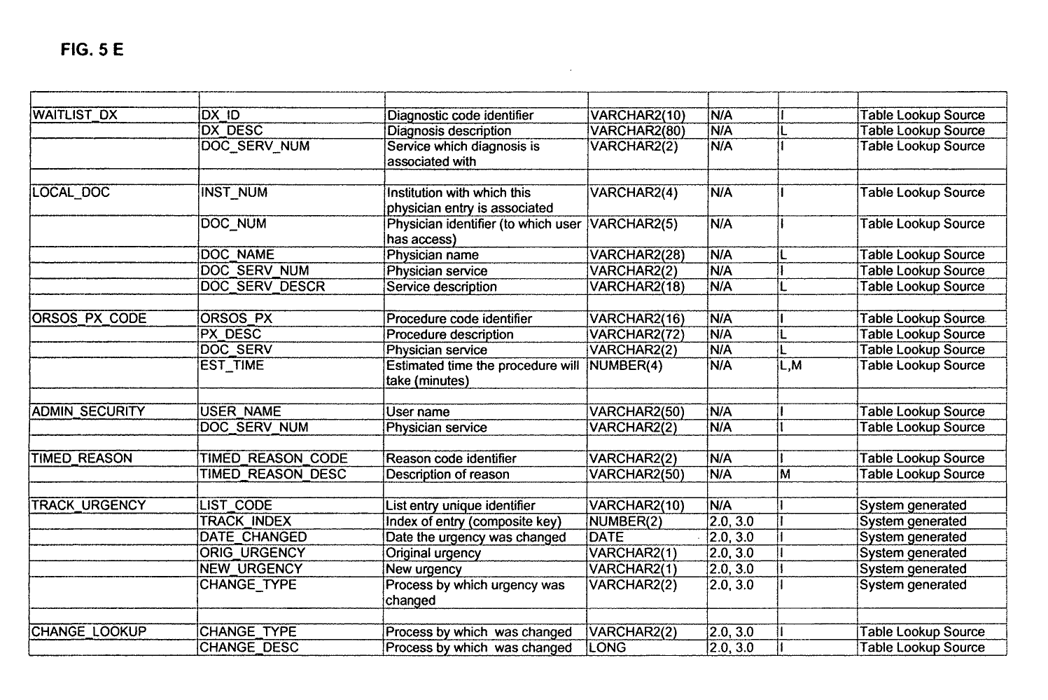

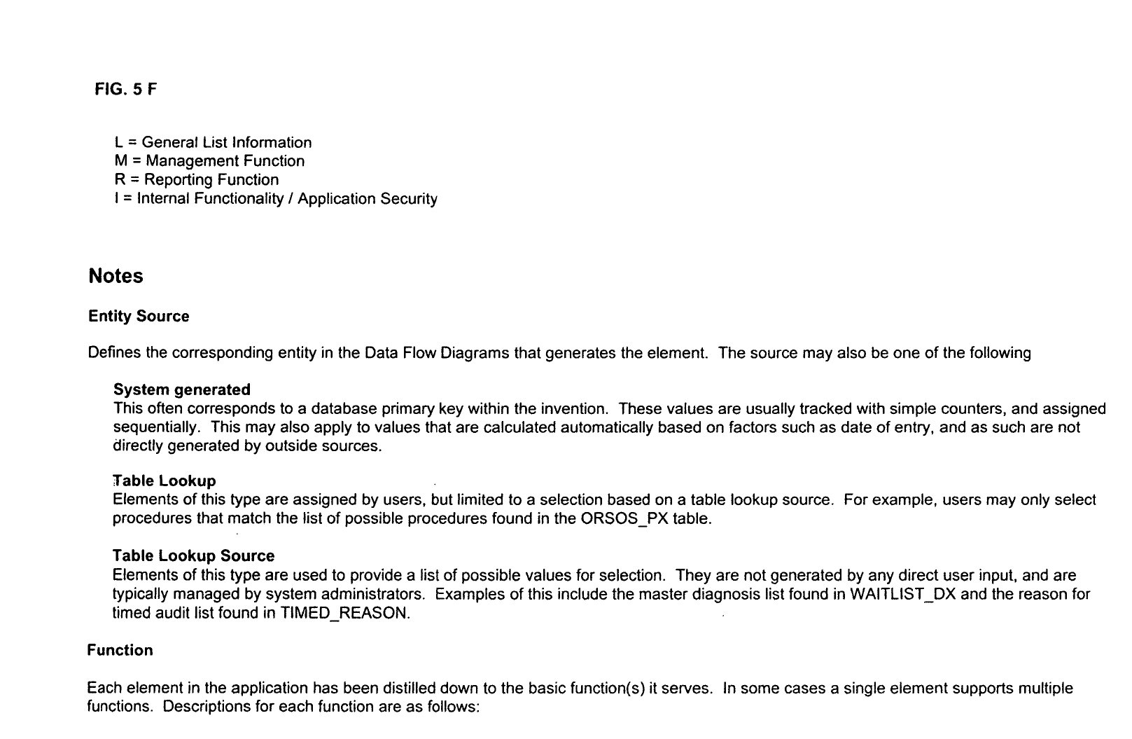

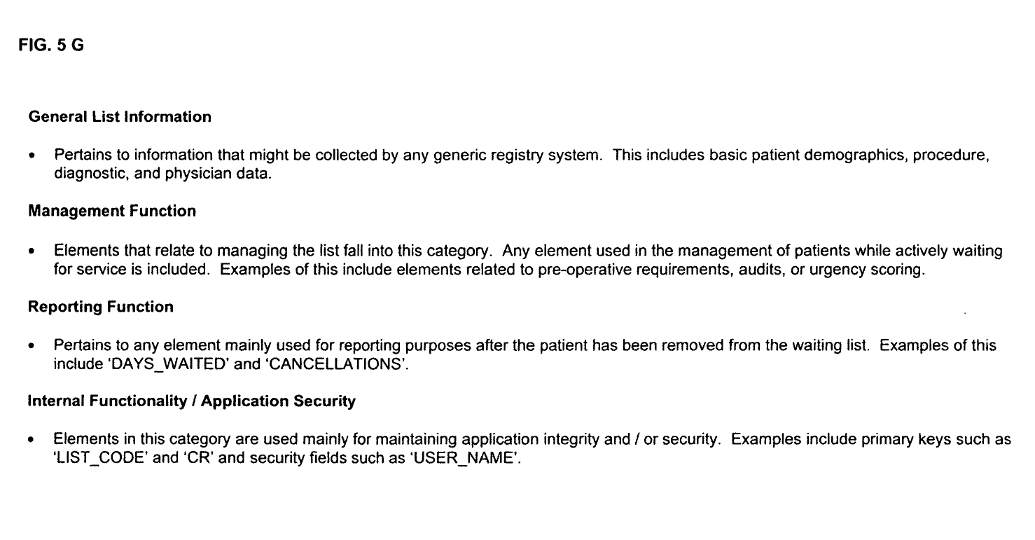

Referring to FIG. 5, a data dictionary provides detailed information for each of the fields in the tables of FIG. 4. The Entity Source heading of the data dictionary indicates the source of the filed contents, for example element CR in table LIST is input or changed by the surgeon (or the surgeon's secretary) through external system S2, and subsequently stored in element CR and looked up from there. Other elements are generated by the management system 0 as set out in FIG. 5F, see for example DATE_LAST_AUDIT in table LIST. Further explanation of calculations is set out herein.

The structure and operation of each of the subsystems 1.0-4.0 will now be described, including interface screens and programming logic, with reference to flow diagrams. Of course, if an alternate system architecture (e.g., not web based) is used, the screens and programming logic will need to be replaced, for example with forms and code modules in a database program.

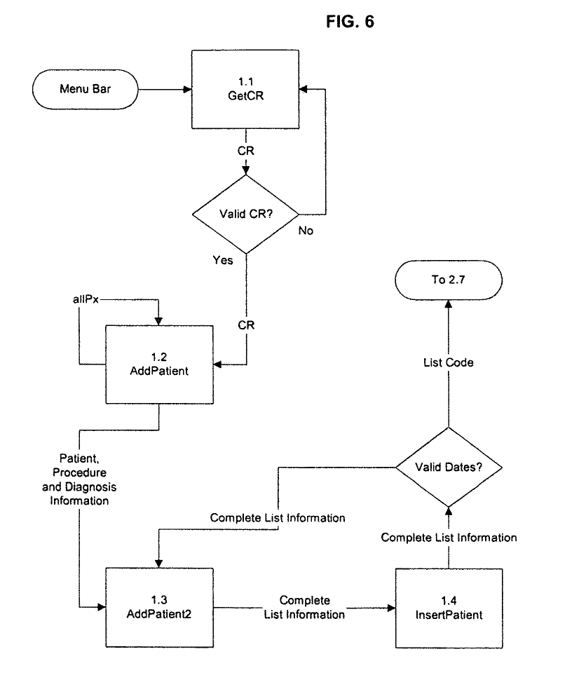

1.0 Data Entry FIG. 6

The data entry subsystem 1.0 (module) allows for the input of basic information relating to a wait list entry (database record). This includes the capture of patient demographic information via an interface to a hospital Central Patient Index (CPI) in this case running on external system S7, procedure specific information, and any notes a user may wish to include. Note that while the demographic information may be stored within the management system 0, some process must be established to relay the hospital CPI to a local database table. This process may involve, but is not limited to, a daily data dump from the CPI, dynamic queries to the CPI through an interface engine populating the local table, manual data entry, or some combination thereof. This module 1.0 may also afford some flexibility to accept patients populated through other incarnations of management system 0 (e.g. a clinic management system 0).

It should also be understood that the relationship between the physical structure of the database D1 is often dependent on existing systems with which it can interface. For example, the database D1 could be distributed in the external systems and the data only retrieved when required for the operation of the modules 1.0-4.0. However, in most cases legacy systems will limit this ability, and require a data dump type procedure as discussed above. Alternatively, users of external systems S1-S7 could directly input data to the database D1 by providing additional data entry screens and replicating the related functions of the external systems S1-S7. This will be a matter of design choice in accordance with the principles described herein.

As seen in FIG. 2, a physician and secretary are involved in the process of collating a patient list entry. The process of how the users may interact with the system 0 varies. Generally speaking, the secretary is responsible for the manual data entry process. However, it is the physician who assigns an urgency score, diagnosis and procedure to the patient. The method by which this is entered into the system 0 is dependent on the nature of the interaction between secretary and physician. Typically, the secretary will receive some form of correspondence/paper based registration indicating the physician's evaluation of the patient.

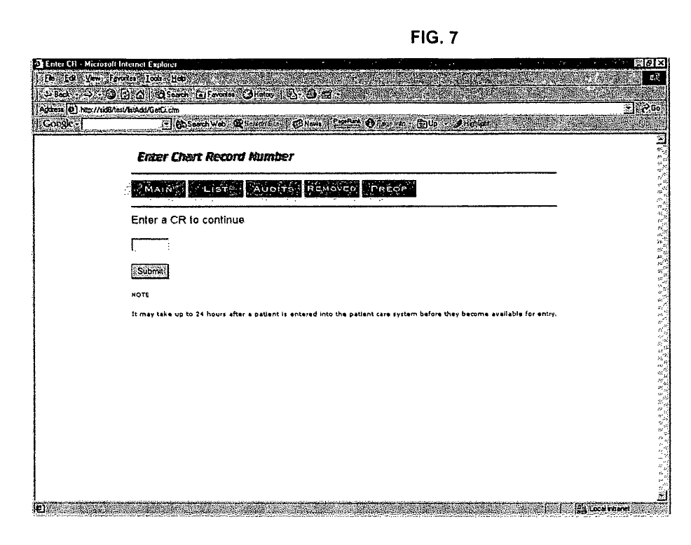

Referring to FIG. 6, three screens capture the required information from the user in an incremental process (Sections 1.1 to 1.3 and FIGS. 7 to 9). Each screen (FIGS. 7 to 9) passes collected data from the previous screen to the next. Section 1.4 (FIG. 1.4) then inserts the compiled wait list entry into the database. The information is displayed on screen to the user incrementally, as it is validated.

1.1 Get Patient Unique Identifier (GetCR.cfm) FIG. 7

Function: This screen allows input of a unique patient identifier for retrieval from the patient database. User clicks submit to process the identifier.

Screen Elements:

Unique Identifier Text Box

Allows the user to key in the unique patient identifier. This identifier matches the identification used in the hospital system, and is not generated by the system 0.

Links: From this page the user can navigate directly to the following pages:

Main.cfm

View_list.cfm

Removedlist.cfm

Preoplist.cfm

Auditpatients.cfm

Addpatient.cfm (on submit)

Programming Logic: none—simple input form

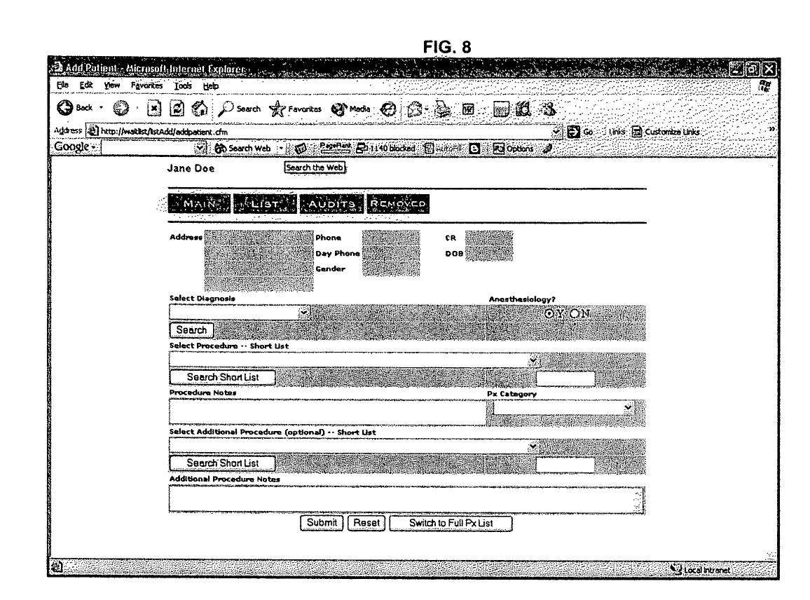

1.2 List Information Collection Screen 1 (addpatient.cfm) FIG. 8

Function: Processes the patient unique identifier and loads patient demographic information. Allows the user to enter diagnosis, procedure, and anaesthesiologist information. Submits data to next patient add screen.

Screen Elements (for Data Entry):

Patient Demographics

Patient name, address, phone number, gender, unique identifier, date of birth

Diagnosis

A drop down box allowing the user to select from a list of diagnoses specific to the service of the active physician's list.

Anesthesiology

Option buttons allowing the selection of ‘Yes’ or ‘No’ for the Anesthesiology indicator.

Procedure

Allows selection of the procedure to be performed from a drop down list (by default, specific to the specialty of the selected physician[s]). This list is derived from the list of procedures found in the ORSOS_PX_CODE table.

Procedure Notes

Allows free text entry of any notes related to the procedure.

Additional Procedure Allows selection of an additional procedure to be performed from a drop down list (by default, specific to the specialty of the selected physician[s]). This list is derived from the list of procedures found in the ORSOS_PX_CODE table.

Additional Procedure Notes

Free text entry of any notes related to the additional procedure.

Links: From this page the user can navigate directly to the following pages:

Main.cfm

View_list.cfm

Removedlist.cfm

Preoplist.cfm

Auditpatients.cfm

Addpatient2.cfm (on submit)

Getcr.cfm (on incorrect identifier)

Addpatient.cfm (loopback on button press)

Programming Logic:

Validation: Validates the existence of patient unique identifier on patient table. Posts a warning message noting if patient is being entered multiple times on the same physician's list. Selection of ‘procedure’ and ‘additional procedure’ fields is enforced as a required field.

Database Queries: Selects relevant patient information based on patient identifier. Query to check for duplicates on list. Separate queries to populate diagnosis and procedure drop down boxes (list of possible selections for the user) specific to physician's area of specialty.

Switch to Full Px List Button: On button press, screen toggles between a view of all procedures, and those procedures specific to the physician's specialty. Physician specific is the default.

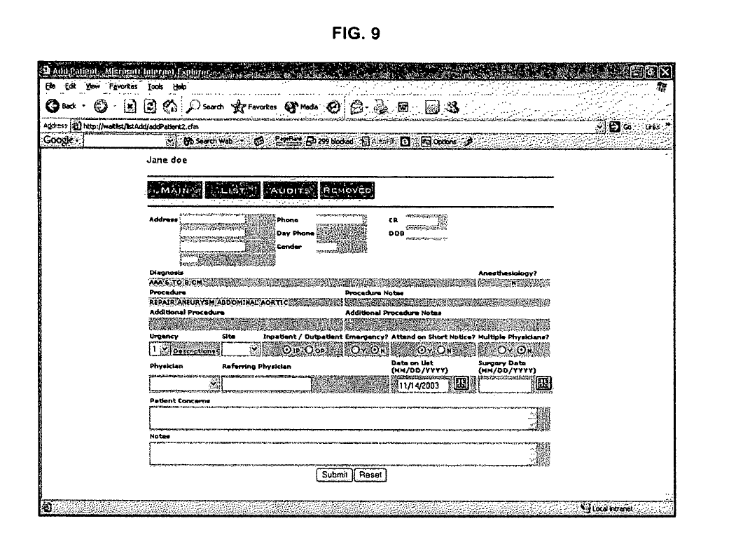

1.3 List Information Collection Screen 2 (addpatient2.cfm) FIG. 9

Function: This screen allows the user to complete the remaining information required to add the patient to the list, receiving previously coded data from addpatient.cfm.

Screen Elements (for Data Entry):

Urgency

Allows the user to select from an urgency scoring code. Each urgency score has an associated target time. In the current embodiment, this score ranges from 1 to 5 (1 being most urgent), and is populated based on values found in the URGENCY table. It is important to note, however, that the actual score can be based on a variety of scoring systems as mentioned previously.

The value assigned to urgency may be based on:

1) The direct clinical judgement of the assigned physician, based on a set of consistent guidelines put forth in the description of each particular score. In this case, the physician directly assigns each urgency score.

2) A set of criteria that the physician sets forth, which may be used as a guideline for the physician's staff, and includes 1). In this case, the physician indirectly assigns each score based on criteria they establish.

3) A formalized urgency scoring system, which may be integrated directly into the system 0. A series of questions would be required of the user, ultimately resulting in the assignment of the urgency score for the list entry.

It is important to note that there is no one-to-one relationship between urgency score and procedure, as even simple procedures may often have a variety of parameters that may affect the severity of the patient's urgency.

Site

The hospital site at which the patient is to receive surgery.

Inpatient/Outpatient Option Buttons

Indicator as to whether patient will be an inpatient or outpatient following surgery.

Attend on Short Notice Option Buttons

Indicator as to whether the patient is able to attend surgery on short notice.

Multiple Physicians

Indicator as to whether multiple physicians will be involved in performing the procedure.

Physician

Physician performing the procedure. Populated by values found in the LOCAL_DOC table and limited to the physician(s) the user has logged in to manage.

Referring Physician

Optional free text field indicating the referring physician.

Date on List

The date the patient was placed on the wait list. Generally, the date the patient was seen in clinic.

Surgery Date

Optional field indicating the current scheduled surgery date, if known.

Patient Concerns

Optional field allowing free text notation of any relevant patient concerns.

Notes

Optional field allowing free text notation of any additional general notes for the patient.

Links: From this page the user can navigate directly to the following pages:

Main.cfm

View_list.cfm

Removedlist.cfm

Preoplist.cfm

Auditpatients.cfm

Addpatient.cfm

Programming Logic:

Validation: Any procedure or additional procedure notes in excess of 200 characters are truncated for data integrity purposes. If any required variables from the previous entry screen are not defined, user is rerouted to the beginning of the add patient process (getcr.cfm). Validation of non-optional fields (indicated above) is enforced. Date fields are validated for format.

Database Queries: Query to obtain a list to populate the urgency drop down list. Queries to indicate the description for selected diagnosis, procedure and additional procedure codes. Query to populate list of physicians performing procedure.

1.4 Insert Patient (insertpatient.cfm)

Function: This page validates and inserts to the database the patient data collected from getcr.cfm, addpatient.cfm, and addpatient2.cfm.

Screen Elements: None—processing page.

Links:

Viewpatient.cfm (automatic redirection)

Addpatient2.cfm (on validation failure)

Programming Logic:

Validation: The current surgery date (if present) is validated against the list date to ensure the dates are sequential. The list date is validated to ensure its presence, and to ensure it does not exceed the current system date. Any failure of validation redirects user back to addpatient2.cfm

Database Queries: A query is run against the doctor table to ensure user has privileges to modify the current physician's list. An insert query loads collected data to the list table.

Assignment of Null Values: All values which have blank entries are assigned NULL values for entry into the database.

Increment Unique List Identifier: Each list entry has a 10 digit numeric ID (LIST_CODE) assigned in sequential order. The server assigns these values through a stored variable. On each list insert request the stored numeric variable is locked to prevent other users from duplicating the value. The variable is then incremented, inserted as LIST_CODE and the lock is released.

2.0 List Management FIG. 10

Referring to FIG. 10, the list management subsystem (module) 2.0 allows for the management of information relating to and including the wait list. This includes the patient demographic information via an interface to a hospital Central Patient Index (CPI), procedure specific information, and any notes the user may wish to include. The list management module also allows for the tentative booking of surgery dates and the creation of dynamic booking forms (OR form) to accompany the aforementioned tentative surgery dates. Note that while the current incarnation of the OR form is produced for the purpose of being faxed to the OR booking system for manual entry it is foreseeable that the OR form will become integrated with the OR booking system and thus allow for surgeries to be booked dynamically. Wait list management is also capable of producing up to date dynamic statistics (QuickStats) for on the fly reporting.

As seen in the FIG. 2, the physician and secretary are involved in the process of managing their wait list. The process of how the users may interact with the system varies.

2.01 Resource Based Management

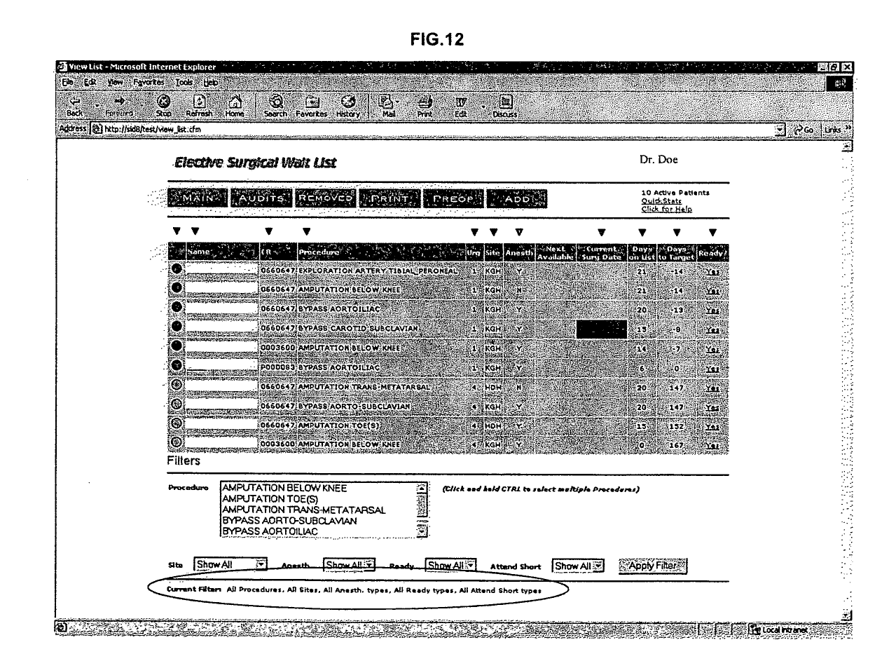

As seen in FIG. 12, a variety of filters exist within the application to further facilitate management of the waiting list. Specifically, users may view the list based on the status of various resources ascertained within the application. For example, if a surgeon must cancel a patient who is currently scheduled for surgery they must fill that surgical slot or risk wasting valuable operating room time. The application allows the user to filter the list of patients to best find patients who meet the desired resource criteria (able to have surgery at a particular site, with a particular kind of anesthetic, able to attend surgery on short notice, etc.).

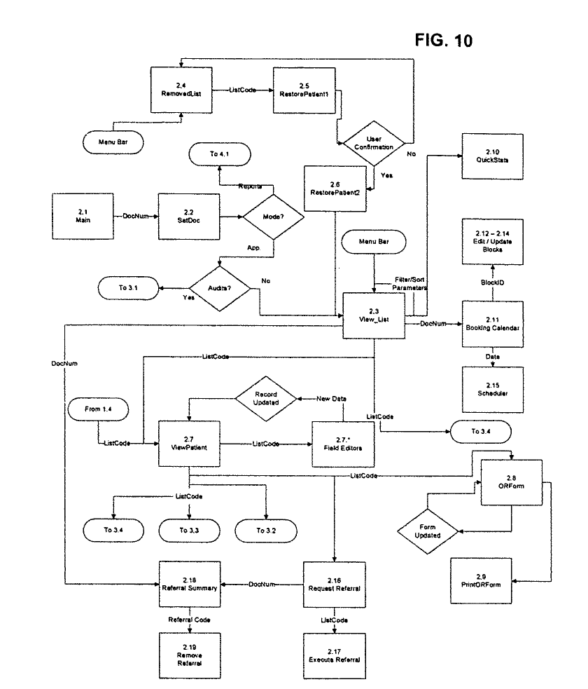

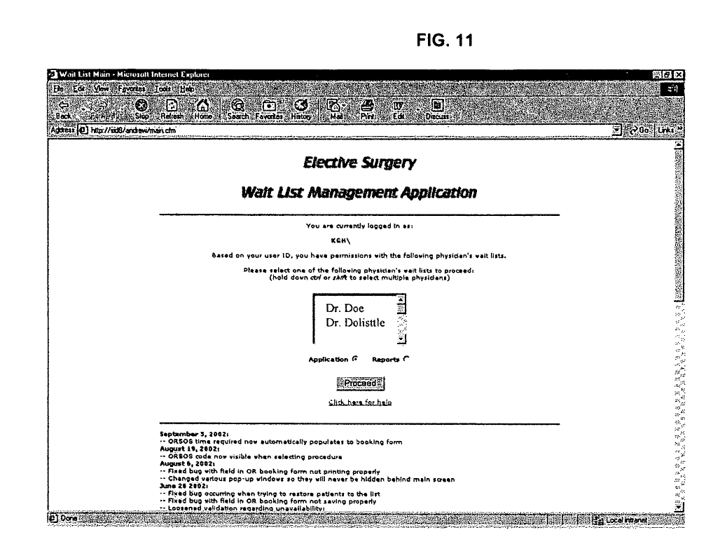

2.1 Wait List Main (main.cfm) FIG. 11

Function: This screen allows the user to select a physician(s) from a list and either view their list or build reports based on the selected physician's list.

Screen Elements: This screen displays a list of physicians the user has permissions with. This list is based on a query to the DOC_SECURITY table to determine the specific physician the user has permissions with, and LOCAL_DOC to generate the physician names.

Links:

Set_doc.cfm (automatic redirection if there are no pending audits)

generalHelp.cfm

Programming Logic:

Validation: Validates to ensure the user has permissions to proceed. Validation used to determine the navigational direction the application should take (view_list.cfm or AuditPatients.cfm).

Database Queries: Query used to populate the physician list with physicians for whom the user has permissions with.

2.2 Set Physician (set_doc.cfm)

Function: Processing screen used to assign the appropriate permissions to the user based on their user ID.

Screen Elements: None—Processing screen

Links:

view_list.cfm (automatic redirection if there are no pending audits)

AuditPatients.cfm (automatic redirection if there are pending audits)

Programming Logic:

Validation: Validates to ensure the user has permissions to proceed. Validation used to determine the navigational direction the application should take (view_list.cfm or AuditPatients.cfm).

Sets client side variables integral to the chosen security model. Based on the permissions of the user, the variables form part of a query, which is appended to each subsequent query in the application. This appended query information will allow the user only to access physicians for whom they have rights. This client variable is stored in the server registry or database to prevent tampering by malicious users.

Database Queries: Query used to ensure the user has permissions to proceed. Query used to check for existing audits.

2.3 View List (view_list.cfm) FIGS. 12-14

Function: The main list screen is the primary way for the user to look at patients waiting for service. From this screen the user can access the main functions of the system 0.

Screen Conventions:

Sort Arrows

Click on the arrows to sort by that column. First click sorts the values in the column by ascending order. Second click sorts the values in descending order. By default the list is sorted by “Days to Target”. Any other sort will also result in a secondary sort by “Days to Target”.

Color Coding System

The color coding system lets the user know at a glance how close a patient is to their target. Green indicates a patient has more than 14 days to target. Patients who are within 1 to 14 days of target are coded yellow. Patients on or over target are coded red. The specific number of days set out above has been found to be useful for the circumstances of the preferred embodiment; however, it is recognized that other numbers of days may be better suited to particular installations. Again, this is a matter of design choice in accordance with the principles described herein. For a description of how target times are obtained for the patient, see ‘Days to Target’ under ‘Screen Elements’ below.

Screen Elements:

Patient Demographics

Patient name, patient unique identifier.

Procedure

The procedure to be performed on the patient. See Screen Elements—Procedure in 1.2 for details.

Urgency

The urgency is assigned to the patient. See Screen Elements—Urgency in 1.3 for details.

Physician

The physician performing the procedure. Note that this column will only be visible on the main list screen if more than one physician is active on the wait list. See Screen Elements—Physician in 1.3 for details.

Site

The hospital site where the procedure can/will occur. Note that this column will only be visible on the main list view if multiple sites are present on the wait list. See Screen Elements—Site in 1.3 for details.

Anesth

Indicator as to whether an Anesthesiologist is required for the procedure. See Screen Elements—Anesth in 1.2 for details.

Target Date

Indicates the date by which surgery should be performed, if possible. Target date is determined by what urgency is assigned to the patient. Every urgency score has an associated target time. Based on the date the patient is placed on the list, and the urgency with associated target time, a target date for the patient is calculated dynamically.

Next Available

The next date the patient is available for surgery, if currently unavailable. This is calculated based on a query to the UNAVAILABLE_DATES table. If a given patient is currently unavailable, the application calculates the next available date for surgery.

Current Surg Date

The current surgery date assigned to the patient, if any.

Days on List

Number of days the patient has been on the list. This is calculated dynamically by the system 0 by subtracting the LIST_DATE element from the current system date.

Days to Target

Number of days to the patient's target date. A negative number indicates the patient is currently over target. This is dynamically calculated by subtracting the Target Date (see above) from the current system date. This calculated element is the main system by which patients are ranked on the list.

Ready?

Indicator as to whether the patient is ready for surgery. If the patient has any outstanding preoperative requirements, this field will read “No”. The user may click on the “Yes” or “No” to access the preoperative requirements (from the main list view). This screen element is based on a query to the PREOP_REQUIREMENTS table.

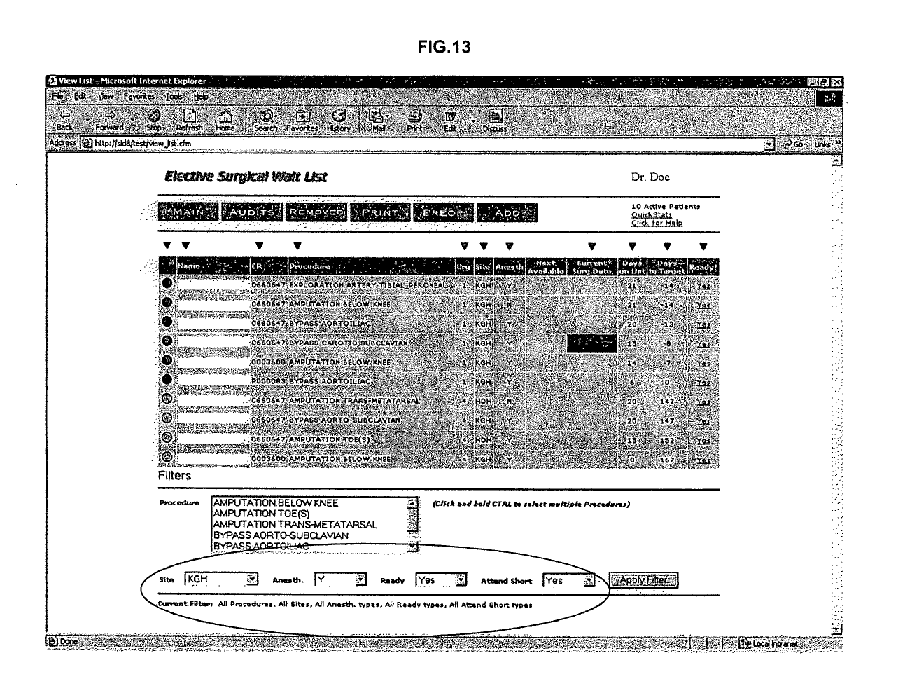

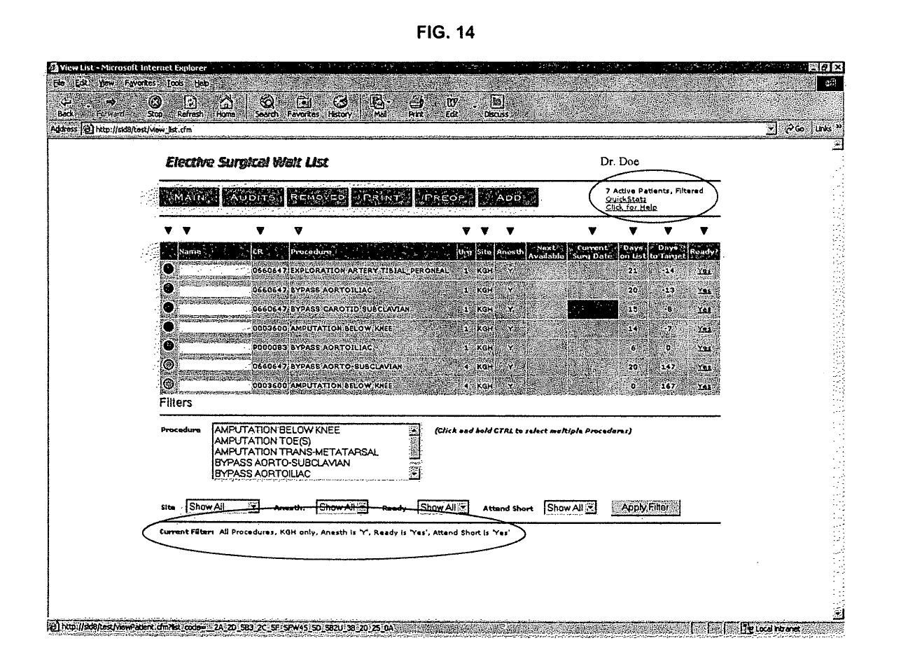

Filters: Allows the user to view the list with only records pertaining to the filter criteria showing. These filters are resource based, and allow users to manage the list based on the patients who match certain resource criteria. The user may filter the list on the following criteria: procedure, site, anesth, ready and attend short (If there are patients that are ready to attend surgery on short notice. Useful for filling cancelled surgery slots). These filters relate to list resource management, and allow users to quickly make decisions regarding the allocation of surgical time. FIG. 12 represents list without any filters present. FIG. 13 illustrates a user selecting particular filters. FIG. 14 illustrates a list, filtered on the selected criteria.

Links:

main.cfm

AuditPatients.cfm

removedList.cfm

printList.cfm

preopList.cfm

GetCr.cfm

viewPatient.cfm (when the user clicks on a patient name)

QuickStats.cfm

view_list_help.cfm

preopReq1.cfm (when the user clicks on “Yes” or “No” in the “Ready?” column)

view_list.cfm (loop back on sort, and on apply filter)

Programming Logic:

Validation: Validation to determine the order in which the list should be printed. Validations to assign the appropriate color-code to each record on the list. Validation to ensure that if a surgery date has been cancelled it is displayed on the list using a red font color and a red strike through it. Ensures that if there are any outstanding preoperative requirements for a patient their ready status is displayed as “N”.

Database Queries: Query used to fill the procedure drop down list. Query used to retrieve the list information for display. Query to check for the presence of multiple sites and multiple doctors for sorting and list display purposes.

Sorting: The list can be sorted on all but one column—the “Next Available” column. In order to sort on a specific column, the user simply clicks the desired sort arrow, and the screen will be redisplayed with the selected arrow changed from blue to red. If the user then wants to sort that same column in ascending or descending order, they would simply click that same arrow again. Doing so would redisplay the screen, with the column sorted in the appropriate order and the sort arrow pointing in the new sort direction (up for ascending, down for descending).

Help Screen: The help screen is displayed in a pop-up window and explains the basic functionality of the screen, as well as definitions of various columns.

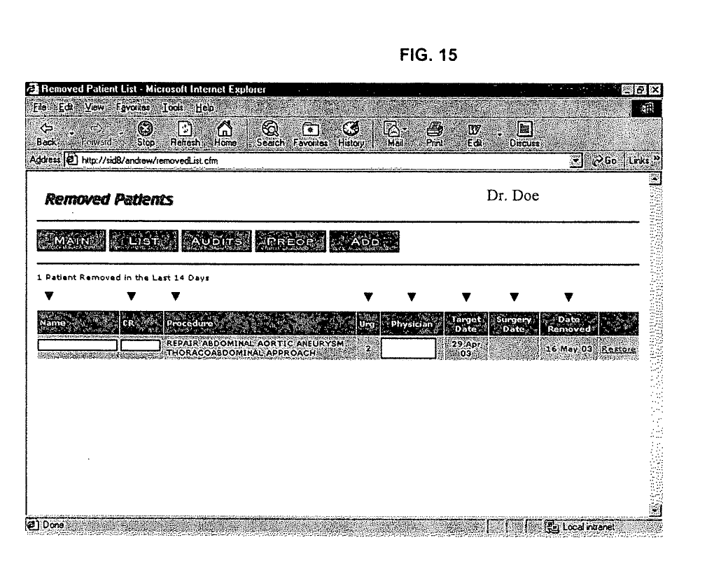

2.4 Removed Patient List (removedList.cfm) FIG. 15

Function: This screen displays a list of patients that have been removed from the list within the last fourteen days.

Screen Elements:

Sort Arrows

Click on the arrows to sort by that column. First click sorts the values in the column by ascending order. Second click sorts the values in descending order. By default the list is sorted by “Date Removed”.

List Headings and Descriptions:

Patient Demographics

Patient name, unique identifier

Procedure

The procedure to be performed on the patient. See Screen Elements—Procedure in 1.2 for details.

Urgency

The urgency is assigned to the patient on a scale of 1 to 5 (1 being most urgent). The urgency of the patient determines the target date. See Screen Elements—Urgency in 1.3 for details.

Physician

The physician performing the procedure. See Screen Elements—Physician in 1.3 for details.

Target Date

Indicates the date by which surgery should be performed, if possible. See Screen Elements—Target Date in 2.3 for details.

Surgery Date

The current surgery date assigned to the patient, if any.

Date Removed

Date the patient was removed from the list.

Restore

The user clicks on this link to restore the patient back to the list.

Links:

main.cfm

view_list.cfm

AuditPatients.cfm

preopList.cfm

GetCr.cfm

restorePatient1.cfm

removedList.cfm (loop back on sort, and on apply filter)

Programming Logic:

Validation: Displays a message to the user if there have been no records removed within the last 14 days.

Database Queries: Query used to retrieve the removed list information

Sorting: The list can be sorted on all but one column—the “Restore” column. In order to sort on a specific column, the user simply clicks the desired sort arrow, and the screen will be redisplayed with the selected arrow changed from blue to red. If the user then wants to sort that same column in ascending or descending order, they would simply click that same arrow again. Doing so would redisplay the screen, with the column sorted in the appropriate order and the sort arrow pointing in the new sort direction (up for ascending, down for descending).

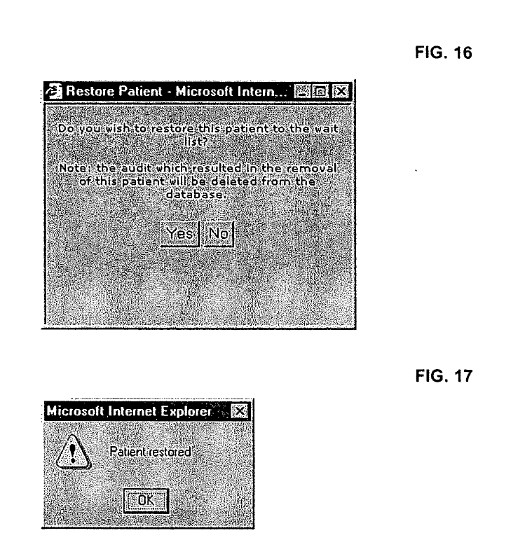

2.5 Restore Patient (restorePatient1.cfm) FIG. 16

Function: Confirmation screen allowing the user to complete the process of restoring a patient.

Screen Elements: “Yes”/“No” buttons—depending on the user's selection this screen directs the user back to the “View List” screen or to the “Removed Patient List” screen.

Links:

view_list.cfm (on “Yes”)

removedList.cfm (on “No”)

Programming Logic:

Validation: Validates to ensure that a list code has been passed to the screen indicating which record to restore.

Database Queries: None

2.6 Restore Patient-Processing Screen (restorePatient2.cfm) FIG. 17

Function: Confirmation screen informing the user that the patient was restored.

Screen Elements: “OK” button—redirects the user back to the “View List” screen

Links:

view_list.cfm (on “OK”)

Programming Logic:

Validation: Validates to ensure that a list code has been passed to the screen indicating which record to restore. Validates to determine if the removal of the patient was the result of an audit, if so, then the application deletes said audit prior to restoring the patient.

Database Queries: Query used to update the “List” table with the restored data. Queries used to determine how the patient was removed in order to delete the corresponding audit.

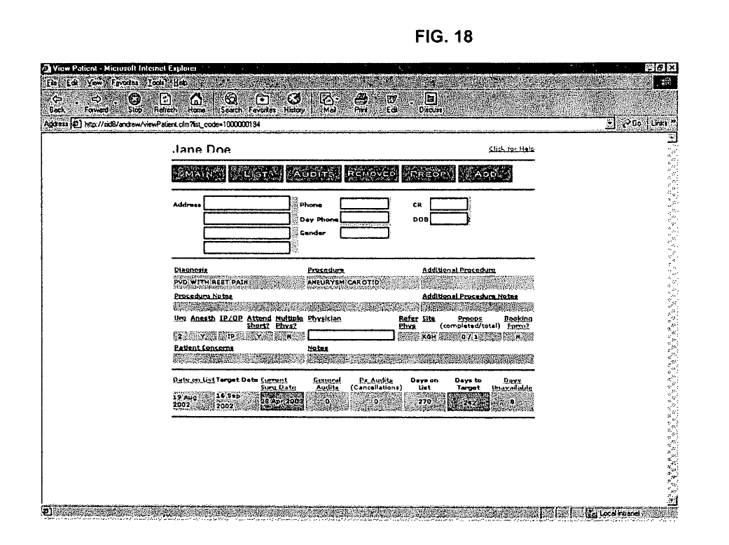

2.7 View Patient (viewPatient.cfm) FIG. 18

Function: The View Patient screen allows the user to view the particulars of a patient on the wait list. This is the first screen the user will see once a patient is added to the list. From here the user can access audits, preoperative requirements, the OR booking form, and unavailable dates. The user may also edit most of the particulars of a patient from here. Note: to make changes to a patient's address, phone number, etc. the user must access that patient in PCS. Changes made in PCS will be reflected in the application within 24 hours.

Screen Elements:

List Headings and Descriptions:

Diagnosis*

The diagnosis assigned to the patient.

Procedure*

The procedure to be performed on the patient.

Additional Px*

Any additional procedure to be performed. Optional.

Urgency*

The assigned urgency of the patient. The urgency of the patient determines the target date.

Anesth*

Indicator as to whether an Anesthesiologist is required for the procedure.

IP/OP*

Indicator as to whether the patient is to be an inpatient or an outpatient

Attend Short?*

Indicator as to whether the patient can attend surgery on short notice.

Multiple Phys?*

Indicator as to whether multiple physicians are involved in the surgery.

Physician*

The physician performing the procedure. Note that this column will only be visible on the main list screen if more than one physician is active on the wait list.

Refer Phys*

Referring physician. Optional field.

Site*

The hospital site where the procedure can/will occur. Note that this column will only be visible on the main list view if multiple sites are present on the wait list.

Ready?

Indicator as to whether the patient is ready for surgery. If the patient has any outstanding preoperative requirements, this field will read “No”. The user may click on the “Yes” or “No” to access the preoperative requirements (from the main list view). The user would click on the heading from the patient view to access preoperative requirements.

Booking Form

Indicator as to whether a booking form has been saved for this patient. Clicking on the heading will take the user to the booking form screen. Calculated based on a query to the OR_BOOKING table.

Patient Concerns*

A notes field indicating any concerns the patient may have identified. Optional.

Notes*

Any general notes about the patient. Optional.

Date on List*

The date the patient was placed on the wait list. In conjunction with the urgency, determines the target date for the patient

Target Date

Indicates the date by which surgery should be performed, if possible. See Screen Elements—Target Date in 2.3 for details.

Current Surg Date

The current surgery date assigned to the patient, if any.

Last General Audit

Displays the last date the patient received a general audit. General audits occur when a patient has been on the list for more than 6 months, or when a patient is removed from the list for reasons other than surgery being performed. Clicking on the heading takes the user to the general audit screen. Value calculated based on a query to the TIMED_AUDIT table.

Last Px Audit

Displays the last date the patient received a procedure audit. Procedure audits occur after a patient is scheduled for surgery, whether the patient received surgery or not. Clicking on the heading takes the user to the procedure audit screen. Value calculated based on a query to the PX_AUDIT table.

Days on List

Number of days the patient has been on the wait list. See Screen Elements—Days on List in 2.3 for details.

Days to Target

Number of days to the patient's target date. See Screen Elements—Days to Target in 2.3 for details.

Days Unavailable

Displays the total number of days the patient has declared itself unavailable for surgery. Clicking on the heading takes the user to the unavailable dates screen. Based on a query to the UNAVAILABLE_DATES table.

Indicates that additional detail on these screen elements may be found under Screen Elements in 1.2 and 1.3

Links:

main.cfm

view_list.cfm

AuditPatients.cfm

preopList.cfm

removedList.cfm

GetCr.cfm

viewpatient_help.cfm

editDx1.cfm (2.7.1)

editPx1.cfm (2.7.2)

editPxNotes1.cfm (2.7.3)

editAddPx1.cfm (2.7.4)

editAddPxNotes1.cfm (2.7.5)

editurgency1.cfm (2.7.6)

editAnesth1.cfm (2.7.7)

editIPOP1.cfm (2.7.8)

editAttend1.cfm (2.7.9)

editMultiple1.cfm (2.7.10)

editDoc1.cfm (2.7.11)

editRefer1.cfm (2.7.12)

editSite1.cfm (2.7.13)

preopreq1.cfm

ORform.cfm

editConcerns1.cfm (2.7.14)

editNotes1.cfm (2.7.15)

editListDate1.cfm (2.7.16)

editSurgDate1.cfm (2.7.17)

timedAuditMain.cfm

pxAuditMain.cfm

editUnav.cfm (2.7.18)

Note: Modules 2.7.1 through 2.7.18 allow the user to edit patient information using simple retrieval and update queries as well as some low level validation.

Programming Logic:

Validation: Validates that the user has the permissions necessary to view the selected patient. Ensures that the correct patient information is being displayed based on the validation of the results returned by the queries listed below. Validates the surgery date to determine the display color. Validates the number of days over target to determine the display color.

Database Queries: Queries used to retrieve patient information.

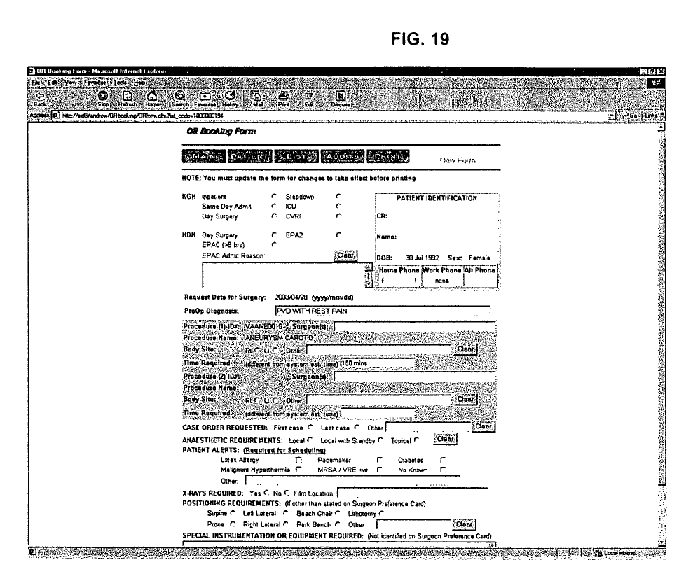

2.8 OR Booking Form (ORform.cfm) FIG. 19

Function: The OR Booking Form is populated with patient information as soon as a patient is added to the list. The form is updated whenever patient information is changed. The form allows the user to fill in any deficient information as well edit some of the information that has already been populated. Once the information has been entered the user would print the form and fax it to the OR.

Note: It is foreseeable that the faxing of the OR Booking Form will be replaced with a direct link into the OR booking system, thus allowing the direct booking of surgery by the application.

Screen Elements:

OR Form

The OR Booking Form contains the information necessary for booking a surgery.

Links:

main.cfm

viewPatient.cfm

view_list.cfm

AuditPatients.cfm

printORform.cfm

ORform.cfm (on “Reset Form” and “Update Form”)

Programming Logic:

Validation: Validates to determine how the information should be displayed as well as which information to display.

Database Queries: Queries used to retrieve patient information.

2.9 Print OR Form (printORform.cfm)

Function: This screen allows the user to print the OR Booking Form they have selected for viewing/updating.

Screen Elements: None—printable form

Links: None—printable form

Programming Logic:

Validation: Validates to determine how the information should be displayed as well as which information to display.

Database Queries: Queries used to retrieve patient information.

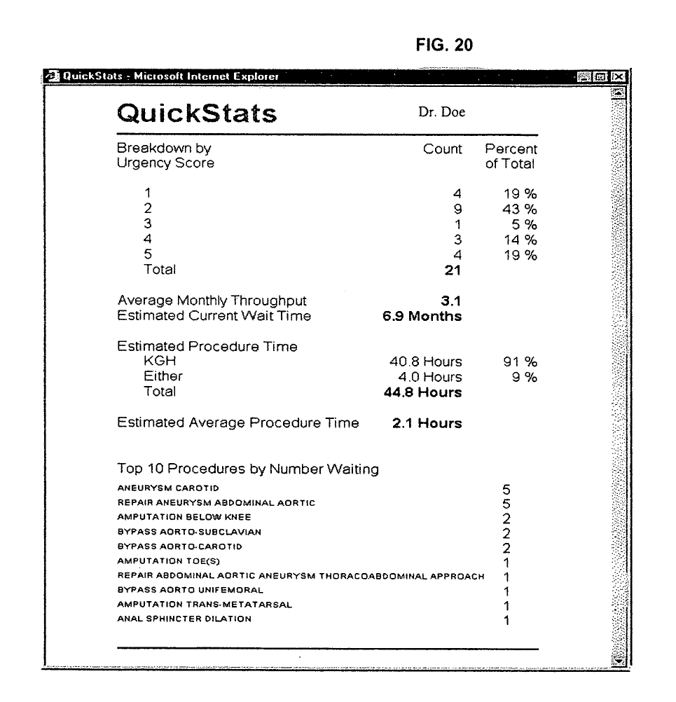

2.10 QuickStats (QuickStats.cfm) FIG. 20

Function: This screen allows the user to view statistics ranging from “Break Down by Urgency Score” to “Top 10 Procedures by Number Waiting”.

Screen Elements:

Breakdown by Urgency Score

Calculates the number of patients on the list matching each urgency score, and the corresponding percentage of the total.

Average Monthly Throughput

Calculates the Average number of patients who were removed from the list on a monthly basis.

Estimated Current Wait Time

Based on a calculation on throughput and current number of patients waiting. Throughput is divided from the total.

Estimated Procedure Time

Based on estimates for each procedure found in the ORSOS_PX table, calculates the estimated total amount of procedure time required by site.

Top 10 Procedures by Number Waiting

Calculates the number of patients waiting for the top 10 procedures.

Links: None—statistics window

Programming Logic:

Validation: Validates the data before the necessary calculations occur to avoid division by zero as well as to ensure the data is present.

Database Queries: Queries used to retrieve data for calculating the following statistics: breakdown by urgency score, average monthly throughput, estimated current wait time, estimated procedure time by location, estimated average procedure time and top 10 procedures by number waiting.

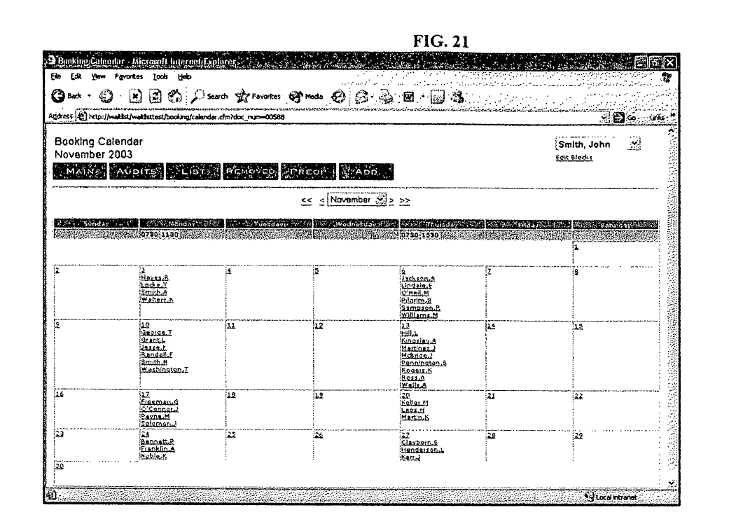

2.11 Booking Calendar (calendar.cfm) FIG. 21

Function: This screen displays a calendar oriented view of patients scheduled for surgery, as well as blocks of time available to the surgeon's office. Users may click and select individual days to “drill down” to a list of patients scheduled for that particular day.

Screen Elements:

Calendar

The calendar contains the days of the month in question, as well as a list of patients scheduled for that day. The day may be selected by clicking on the day of the month hyperlink. A detailed view of the patient may be selected by clicking on the patient name.

Surgical Blocks

The regular surgical blocks for the surgeon in question are listed at the top of the calendar.

Calendar Navigation

Above the calendar, the user may navigate between months using either a drop down list, or by the use of arrow buttons.

Links:

main.cfm

auditpatients.cfm

view_list.cfm

removedlist.cfm

preoplist.cfm

getcr.cfm

viewpatient.cfm (when the user clicks on a patient name on the calendar)

editblocks.cfm

Programming Logic:

Database Queries: Query obtains the list of scheduled surgical blocks for the physician in question. Query obtains list of patients who have scheduled surgery dates.

Calendar Output: Programming logic obtains a list of days in the month, and outputs each day on the correct day of the week. Scheduled patients are output on the appropriate day.

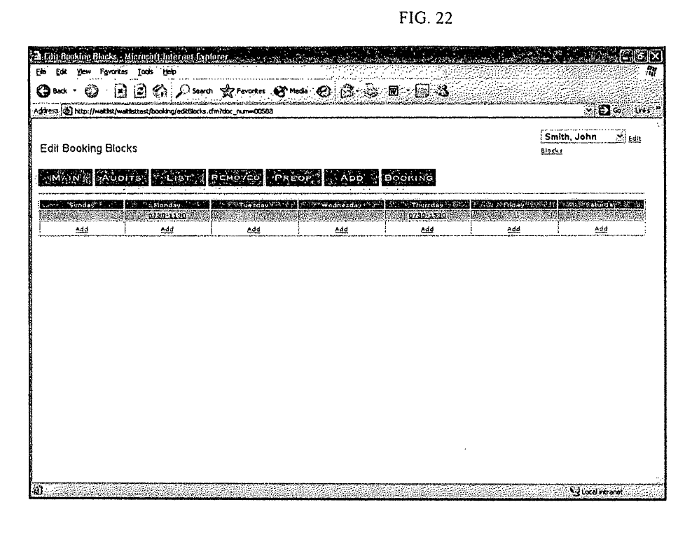

2.12 Edit Surgery Blocks (Editblocks.cfm) FIG. 22

Function: This screen allows the user to update/add/edit blocks of surgery time available to the surgeon on an ongoing basis.

Screen Elements:

Days of week Calendar

Indicates the days of week, with the available surgical blocks listed underneath. Times may be edited by clicking on the times hyperlink. Users may add additional time ranges by clicking the “add” hyperlink.

Links:

main.cfm

auditpatients.cfm

view_list.cfm

removedlist.cfm

preoplist.cfm

getcr.cfm

calendar.cfm

editblocks.cfm

Programming Logic:

Database Queries: Query to determine surgery blocks for the physician in question. Query to determine the active physician.

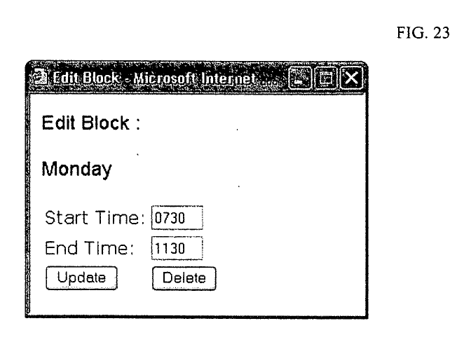

2.13 Edit Surgery Block (Editblock.cfm) FIG. 23

Function: Allows user to add or modify an existing scheduled surgery block for a given physician.

Screen Elements:

Start Time

The start time for the surgery block

End Time

The end time for the surgery block

Update button (only present on updates)

Update the information on the screen

Delete button (only present on updates)

Delete the selected surgery block

Add button (only present on additions)

Add the current surgery block

Links:

editblocks.cfm

doeditblock.cfm

Programming logic:

Validation: Validation to ensure listed block times are valid 24 hour times.

Database Queries: If the selection is being edited, query selects the appropriate surgery block for edit/delete. Query selects the name of the physician in question.

Buttons: Logic present to determine whether user is editing an existing surgical block as opposed to adding a new block. Appropriate buttons are displayed based on decision.

2.14 Perform Block Change (doeditblock.cfm)

Function: Executes a surgery block edit/addition.

Screen Elements: None—processing screen

Links:

editblocks.cfmn

Programming Logic:

Database Queries: Query to ascertain updated/added time ranges do not overlap with existing times. Query to obtain the next block index (key) for record. Query to add a new block to the database. Query to edit an existing block in the database. Query to delete a block from the database.

Validation: validation occurs to ensure no overlap of block times.

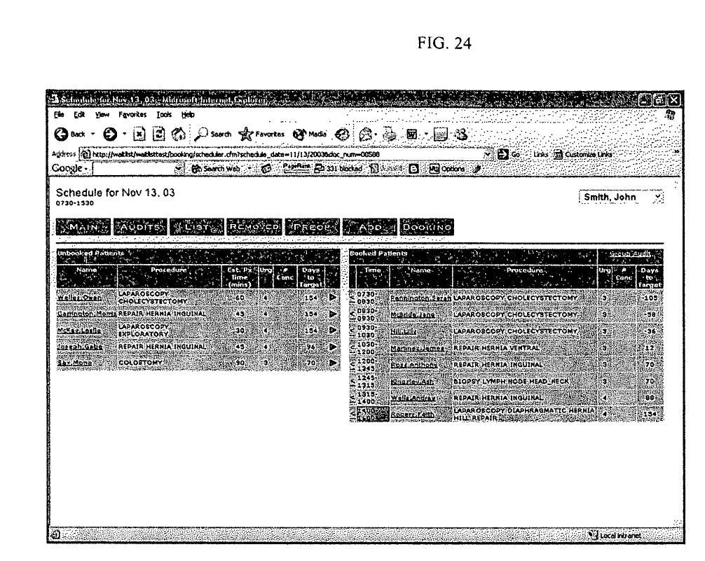

2.15 Date Scheduler (scheduler.cfm) FIG. 24

Function: allows the user to select and assign patients specific times for surgery on a given date.

Screen Elements (note that unbooked patients appear on the left side of the screen, booked patients on the right):

Name (Unbooked Patients, Booked Patients)

Patient Name

Procedure (Unbooked Patients, Booked Patients)

The procedure to be performed on the patient. See Screen Elements—Procedure in 1.2 for details

Est. Px Time

The estimated time for the procedure in minutes

Urg (Unbooked Patients, Booked Patients)

The urgency assigned to the patient. See Screen Elements—Urgency in 1.3 for details.

# Canc (Unbooked Patients, Booked Patients)

The number of times the patient's surgery has been cancelled

Days to Target (Unbooked Patients, Booked Patients)

Number of days to the patient's target date. See Screen Elements—Days to Target in 2.3 for details

Time

The tentatively slotted surgery time allocated to the patient.

Links:

main.cfm

auditpatients.cfm

view_list.cfm

removedlist.cfm

preoplist.cfm

getcr.cfm

viewpatient.cfm (when the user clicks on a patient name)

calendar.cfm

groupAuditMain.cfm

Programming Logic:

Database Queries: Query to obtain the surgery blocks for the current surgery date and physician. Query to obtain the latest end-time. Query to obtain the estimated procedure time for a given patient. Queries to obtain list of patients, both unscheduled and scheduled. Query to set the updated procedure time for a patient.

Scheduling: Patients may be selected or removed from a time slot by clicking on arrows adjacent to their names. When a patient is scheduled into a slot, the application calculates the necessary surgery time and displays the booked time range as an appropriate value. Logic is executed to determine the next available time on the scheduled date. If no regularly scheduled surgery is available, the start time defaults to 9 am. When patients are removed from the scheduled surgery slot, logic is executed to shift all patients accordingly within the surgery slot. When patients are scheduled, and the estimated time puts the case outside the available surgery block, the case is highlighted red.

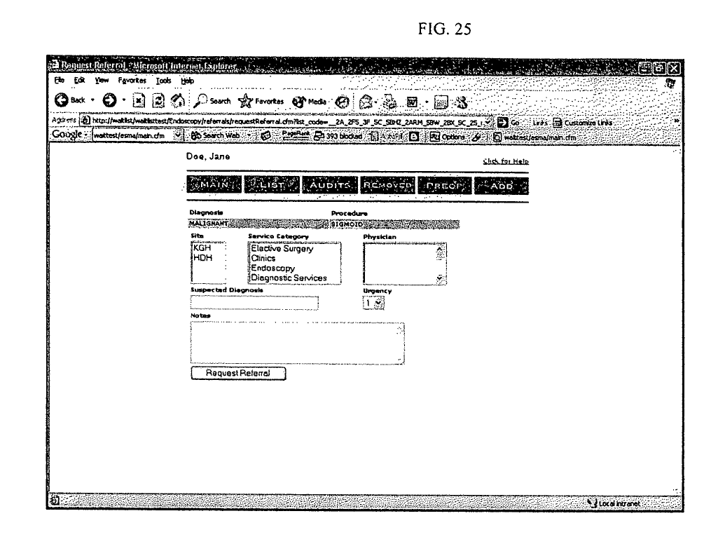

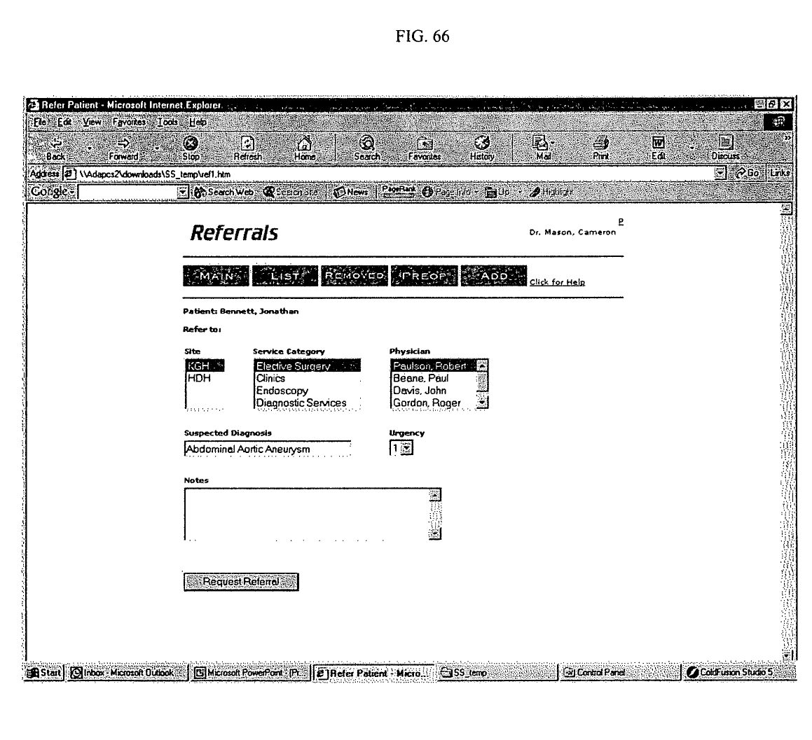

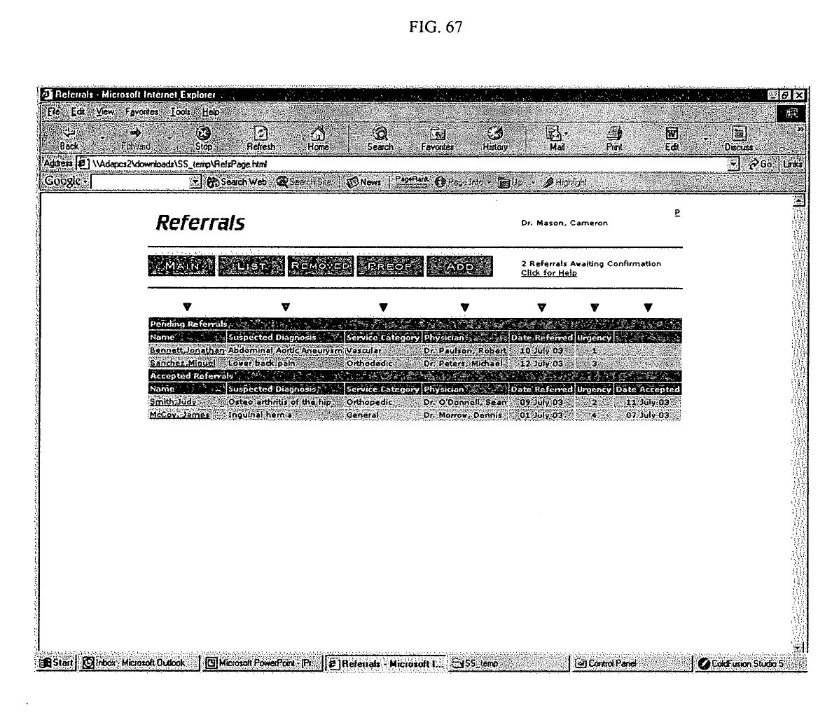

2.16 Request Referral (requestreferral.cfm) (see also discussion of FIGS. 66 and 67 later below) FIG. 25

Function: Collects information for a referral request from the user.

Screen Elements:

Diagnosis

The diagnosis currently assigned to the patient.

Procedure

The procedure to be performed on the patient.

Site

The site the patient is being referred to.

Service Category

The service category the patient is being referred to.

Physician

The physician the patient is being referred to.

Suspected Diagnosis

The suspected diagnosis for which the patient is being referred.

Urgency

The urgency score relating to the referral.

Notes

Any additional notes relating to the referral.

Links:

main.cfm

auditpatients.cfm

view_list.cfm

removedlist.cfm

preoplist.cfm

getcr.cfm

calendar.cfm

dorefer.cfm

Programming Logic:

Database Queries: Query to obtain current list data. Query to obtain patient demographic information. Queries to populate drop down list values for site, service category, physician, urgency.

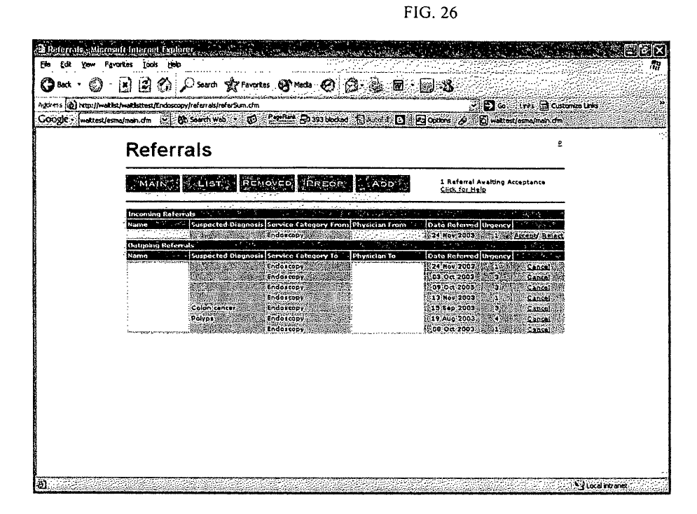

2.17 Execute Referral (dorefer.cfm) FIG. 26

Function: Execute the required validation and database queries required for a referral.

Screen Elements: None—processing page.

Links:

refersum.cfm

Programming Logic:

Database Queries: Query to determine the next available primary key for referral code. Query to insert referral data to the database.

Validation: Validation to ensure ‘procedure’ and ‘notes’ do not exceed maximum length.

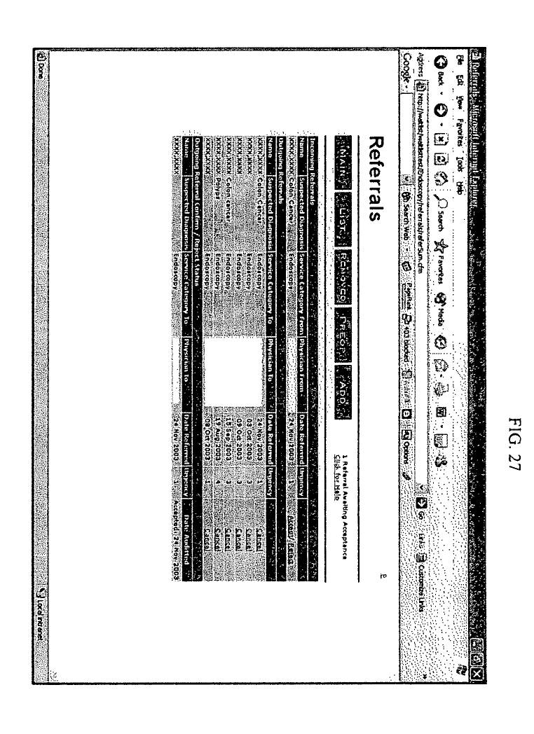

2.18 Referrals Summary (refersum.cfm) FIG. 27

Function: Provide user with list of incoming and outgoing referrals, as well as tracking the status of refused or accepted referrals. Allows user to accept or reject incoming referrals. Allows user to cancel outgoing referrals.

Screen Elements:

Name

The patient name.

Suspected diagnosis

The suspected diagnosis for which the patient has been referred

Service Category From/To

The service category patient has been referred from/to (dependent on whether referral is incoming or outgoing.

Physician From/To

The physician who referral was made to/is incoming from.

Date Referred

The date on which the patient was referred.

Urgency

The urgency score of the referral. This is distinct from the urgency score of the patient while waiting for service.

Date Auditted

In this context, the date on which the patient was accepted or rejected for referral.

Links:

main.cfm

auditpatients.cfm

view_list.cfm

removedlist.cfm

preoplist.cfm

getcr.cfm

removeref.cfm

Programming Logic:

Database Queries: Query to obtain incoming referrals. Query to obtain outgoing referrals. Query to obtain list of confirmed referrals in the last 14 days.

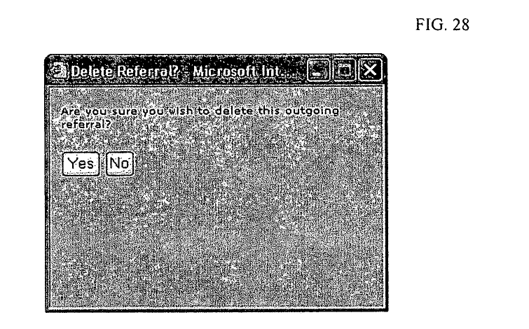

2.19 Remove Referral (removeref.cfm) FIG. 28

Function: Confirmation and action screen for user to delete a sent referral before it has been accepted/rejected.

Screen Elements:

Confirmation Dialog Box

Allows the user to confirm the removal of the pending referral

Links:

refersum.cfm

Programming Logic:

Database Queries: Query to delete referral from database

2.20 Reject Referral (reject.cfm)

Function: Rejects an incoming patient referral.

Screen Elements: none—processing page.

Links:

refersum.cfm

Programming Logic:

Database Query: Query to update the referral with date of audit and rejection status.

3.0 Audits

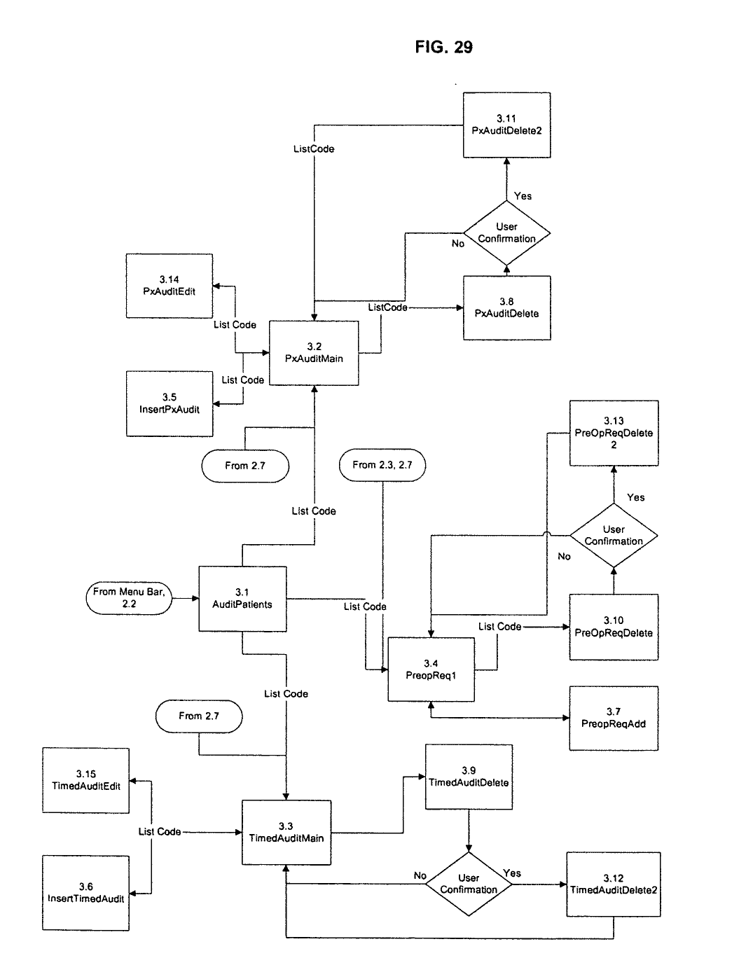

Referring to FIG. 29, the data present in management system 0 is only as accurate as the method of tracking it. As such, regular prompts and reminders are necessary for the user to track the progress of patients waiting for service. The Audits module of management system 0 is triggered by a series of flags that the user sets. These audits serve to allow users to monitor patient status.

There are 3 types of patient audits: general, procedure and preoperative requirement:

A general audit is triggered automatically after a fixed period of time, but may be initiated at any time by the user. The audit prompts the user to indicate if the patient still wishes service, and should they require removal from the list prompts the user to indicate the reason for removal. This process is enforced to ensure that patients who have waited long periods of time for service have their status validated. Un-validated lists may often contain a large number of patients who are no longer able to receive surgery for a variety of reasons (moved away, died, received surgery elsewhere, etc.).

Procedure audits are prompted for after a scheduled surgery date for a patient has transpired. In the current embodiment, users are required to confirm whether surgery was performed. In the event of cancellation, the user is required to indicate a reason. Other embodiments of the system 0 may include a module to automatically interface with other hospital systems to determine whether surgery was performed.

Preoperative requirement audits occur after a scheduled date for a requirement has transpired.

The users are required to confirm completion of the requirement. Doing so will update the patient readiness status to ‘yes’ if all requirements are completed. To complete a preoperative requirement audit, the user simply enters a completion date from the appropriate screen. Other embodiments of the system 0 may include a module to automatically interface with other hospital systems to determine whether the preoperative requirement was performed.

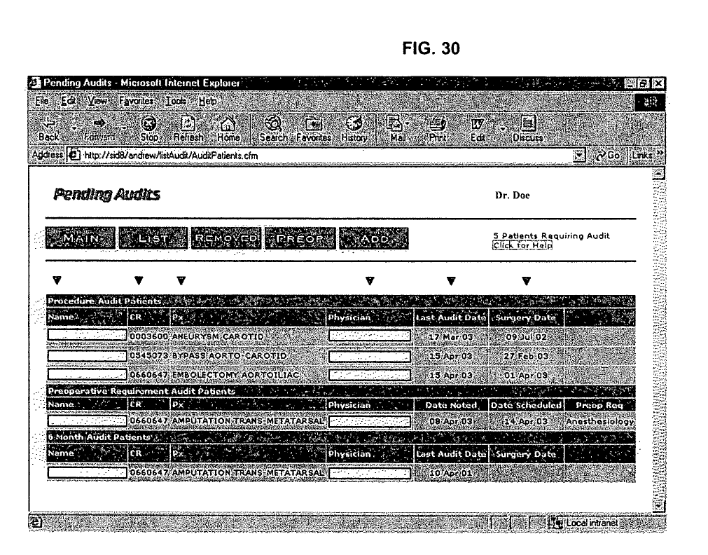

3.1 Pending Audits (AuditPatients.cfm) FIG. 30

Function: This screen allows the user to review patients with outstanding audits/preoperative requirements. Patients will appear on this screen in one of 3 scenarios:

The patient was scheduled to receive surgery on or prior to today's date

The patient had a preoperative requirement scheduled on or prior to today's date

The patient has been on the wait list for 6 months, or has gone 6 months without having an audit

Screen Elements:

Patient Demographics

Patient name, unique identifier

Procedure

The procedure to be performed on the patient. See Screen Elements—Procedure in 1.2 for details.

Physician

The physician performing the procedure. Note that this column will only be visible on the main list screen if more than one physician is active on the wait list. See Screen Elements—Physician in 1.3 for details.

Last Audit Date

The last date a patient received a procedure or general audit. If a patient has received neither, this value represents the date the patient was added to the list. Used to track when patients are due for a general audit (every 6 months).

Current Surg Date

The current surgery date assigned to the patient, if any.

Date Noted

The date the preoperative requirement was first identified as being necessary by the physician.

Date Scheduled

The date the preoperative requirement was scheduled for.

Preop Req

Description of the preoperative requirement.

Links:

main.cfm

view_list.cfm

removedList.cfm

preopList.cfm

getcr.cfm

auditpatients_help.cfm

pxAuditMain.cfm (when the user clicks on the patient name in Procedure Audit Patients section)

preopReq1.cfm (when the user clicks on the patient name in Preoperative Requirement Audit Patients section)

timedAuditMain.cfm (when user clicks on patient name in the 6 Month Audit Patients section)

Programming Logic:

Validation: Validates that there are actually records to be displayed, if there is not then the appropriate empty list message is displayed to the user. This screen also validates that the correct ordering sequence gets set so the user receives the desired results.

Database Queries: There are four database queries that occur in order to display the information on this screen. Three of the queries get the patient data as it relates to the three different types of Audits. The final query verifies permissions for viewing the screen are limited to the physicians the user should have access to.

Sorting: The audit records on this screen can be sorted on all but one column—the preoperative requirement column. In order to sort on a specific column, the user simply clicks the desired sort arrow, and the screen will be redisplayed with the selected arrow changed from blue to red. If the user then wants to sort that same column in ascending or descending order, they would simply click that same arrow again. Doing so would redisplay the screen, with the column sorted in the appropriate order and the sort arrow pointing in the new sort direction (up for ascending, down for descending).

Help Screen: The help screen is displayed in a pop-up window and explains the basic functionality of the screen, as well as definitions of various columns.

Number Of Patients Requiring Audit Counter: displays to the user the number of patients that require audits for the selected physician(s). Program logic adjusts grammar according to number of patients (“patients” vs. “patient”).

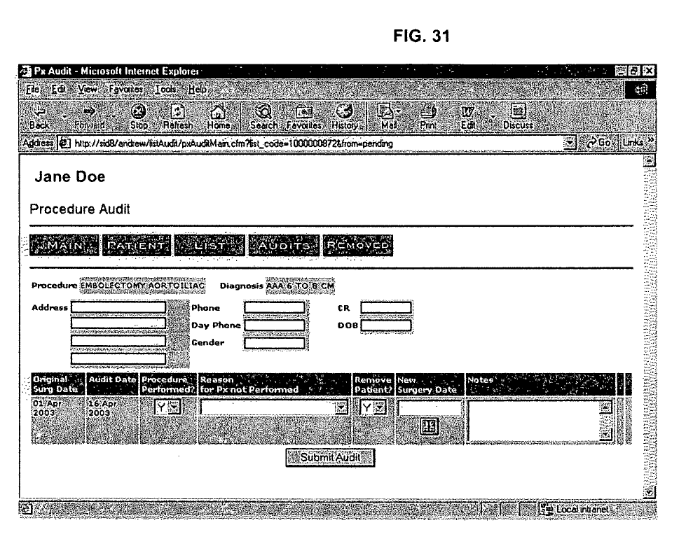

3.2 Procedure Audit (pxAuditMain.cfm) FIG. 31

Function: The Procedure Audit screen allows the user to submit a procedure audit. In order to do so, the user must indicate whether the procedure has occurred, whether or not the patient is to be removed from the list and a new surgery date if one is known. If the procedure was not performed then the user must indicate a reason why from a drop down list.

Screen Elements:

Patient Demographics

Patient name, address, phone number, gender, unique identifier, date of birth

Procedure

The procedure to be performed on the patient. See Screen Elements—Procedure in 1.2 for details.

Diagnosis

The diagnosis for the patient. See Screen Elements—Diagnosis in 1.2 for details.

Original Surg Date

The original surgery date assigned to the patient. This is based on the value found in CUR_SURG_DATE in the LIST table.

Audit Date

Represents the date the user performed the audit of the patient.

Procedure Performed?

This is a drop down list of ‘Y’ and ‘N’, used to indicate whether or not the procedure has been performed.

Reason for Px not performed

A drop down list containing possible descriptions as to why the procedure was not performed. Values in the list correspond to the PX_REASON table.

Remove Patient?

This is a drop down list of ‘Y’ and ‘N’, used to indicate whether or not the patient is to be removed from the list.

New Surgery Date

The new surgery date assigned to the patient. Used only if the original surgery is cancelled.

Notes

Any user-related notes pertaining to the particular general audit to be entered here. Optional.

Links:

main.cfm

viewPatient.cfm

view_list.cfm

AuditPatients.cfm

removedList.cfm

pxAuditDelete.cfm (on Delete)

pxAuditEdit.cfm (on Edit)

insertPxAudit.cfm (on submit)

pxAuditMain.cfm (loop back on submit)

Programming Logic:

Validation: On load, the redirection of the user is validated and assigned (destination when user submits audit, dependent on how the audit was initiated). This screen then validates to ensure that there is a current surgery date. If one is not detected, the user is prevented from performing an audit.

The following validation occurs after the “submit audit” button is clicked:

If ‘Y’ is selected as ‘Procedure performed?’ the application ensures no value from the ‘reason’ drop down box is selected. If ‘N’ is selected as ‘Procedure performed?’ the application then validates the user has selected a value from the ‘Reason’ field. Any failure displays the corresponding error message. If a new surgery date has been assigned to the patient, and the user then tries to remove the patient from the list the appropriate error message is displayed.

Users may also edit or delete existing audits from this screen. Validation occurs to determine if the user has chosen to edit an existing audit. If so, only the single audit is visible to the user to edit. If the patient being viewed has any outstanding preoperative requirement audits, then the number of outstanding audits is displayed to the user.

Database Queries: Query to get the patient information to be displayed for the occurring audit. Query to get the patient information to be displayed for audits that have already occurred for that patient, if applicable. Query to get the current surgery date for validation purposes. Query to populate the ‘Reason for Px not Performed’ drop down list. Query to count the number of incomplete preoperative requirement audits for the current patient. Query to display only the audit selected for editing.

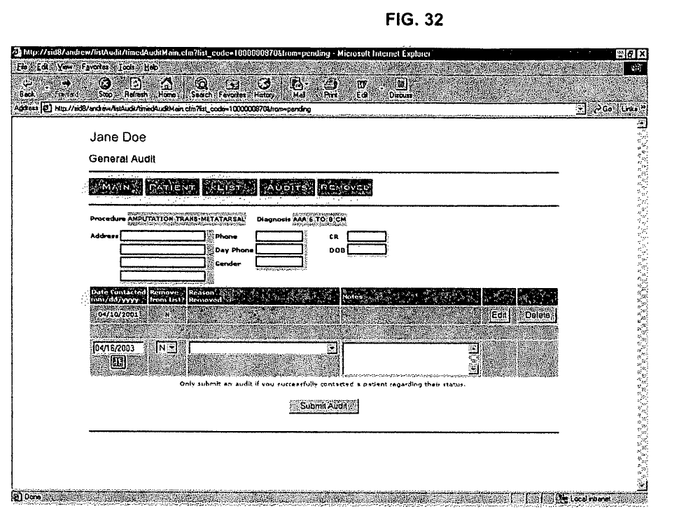

3.3 General Audit (timedAuditMain.cfm) FIG. 32

Function: The General Audit screen allows the user to indicate to the system that a general audit has been performed. In order to do so, the user must indicate whether or not the patient is to be removed from the list. If the patient is being removed from the list the user must select a reason as to why the patient is being removed using a drop down list.

Screen Elements:

Patient Demographics

Patient name, address, phone number, gender, unique identifier, date of birth

Procedure

The procedure to be performed on the patient. See Screen Elements—Procedure in 1.2 for details.

Diagnosis

The diagnosis of the patient. See Screen Elements—Diagnosis in 1.2 for details.

Date Contacted mm/dd/yyyy

The date the patient was contacted regarding their current status.

Remove From List?

This is a drop down list of ‘Y’ and ‘N’, used to indicate whether or not the patient is to be removed from the list.

Reason Removed

The reason why the patient is being removed. Selected only when the patient is being removed from the list. The values on the list are derived from the TIMED_REASON table.

Notes

Any user-related notes pertaining to the particular general audit to be entered here. Optional.

Links:

main.cfm

viewPatient.cfm

view_list.cfm

AuditPatients.cfm

removedList.cfm

timedAuditDelete.cfm (on Delete)

timedAuditEdit.cfm (on Edit)

insertTimedAudit.cfm (on submit)

timedAuditMain.cfm (loop back on submit)

Programming Logic:

Validation: When the user clicks the “Submit Audit” button the following validation occurs. If the user has selected ‘Y’ from the ‘Remove From List’ drop down list the application validates to ensure that a reason for the patient being removed has been selected. If ‘N’ is selected from the ‘Remove From List’ drop down list the application validates to ensure that there is no reason selected from the “Reason Removed” drop down list. If any of the above criteria is not met the appropriate error message is displayed.

If an audit exists for this patient the user may edit or delete the audit from this screen. An existing audit would be displayed above the audit that is being submitted. Therefore the application needs to ensure that if the user has chosen to edit a previous audit that only the information for that audit gets displayed.

Database Queries: Queries to retrieve the patient information for display. Query to populate the ‘Reason Removed’ drop down list. Query to display patient audit(s) that have already occurred for that patient, if applicable.

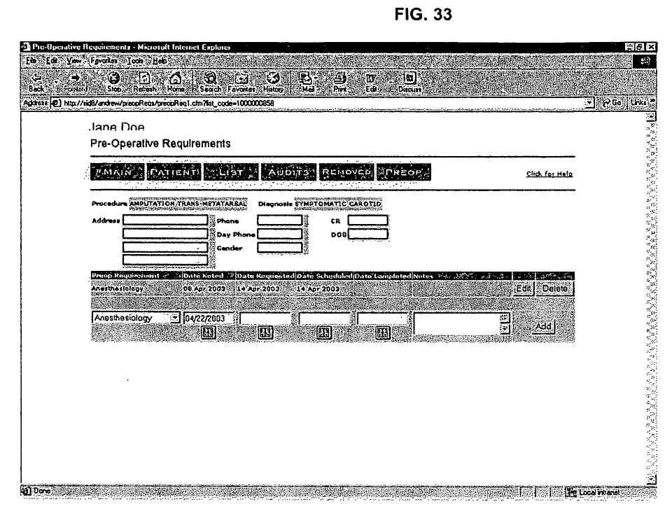

3.4 Pre-Operative Requirements (preopReq1.cfm) FIG. 33

Function: This screen displays all preoperative requirements for the patient—both complete and incomplete—appear on this screen. It also allows for the user to add a preoperative requirement, edit a preoperative requirement and remove an erroneous entry.

Screen Elements:

Patient Demographics

Patient name, address, phone number, gender, unique identifier, date of birth

Procedure

The procedure to be performed on the patient. See Screen Elements—Procedure in 1.2 for details.

Diagnosis

The diagnosis of the patient. See Screen Elements—Diagnosis in 1.2 for details.

Preop Requirement

Description of the preoperative requirement. The values on the list are derived from the PREOP_LIST table.

Date Noted

The date the preoperative requirement was first identified as being necessary by the physician.

Date Requested

The date the preoperative requirement was actually requested. e.g. Cardiology consult—the day Cardiology was contacted to request the consult. May differ from the date noted.

Date Scheduled

The date the preoperative requirement was scheduled for.

Date Completed

The date the preop requirement was completed. Should match the date scheduled. Upon entering a completion date, the requirement will no longer appear on the preoperative requirements list, but will remain on this review screen.

Notes

Any user-related notes pertaining to the particular preoperative requirement may be entered here. Optional.

Links:

main.cfm

viewPatient.cfm

view_list.cfm

AuditPatients.cfm

removedList.cfm

preopReqDelete.cfm (on Delete)

preopReqEdit.cfm (on Edit)

preopReqAdd.cfm (on Add)

preopList.cfm

preopReq_help.cfm

Programming Logic:

Validation: Once the “Add” button is clicked the application validates that a date noted has been selected and that it is not greater then the date scheduled. If any failure occurs, the corresponding error message is displayed

Database Queries: Query to retrieve the patient information for display. Query to retrieve information regarding past audits pertaining to the patient in question, if applicable. Query to populate the “Preop Requirement” drop down list.

Help Screen: The help screen is displayed in a pop-up window and explains the basic functionality of the screen, as well as definitions of various columns.

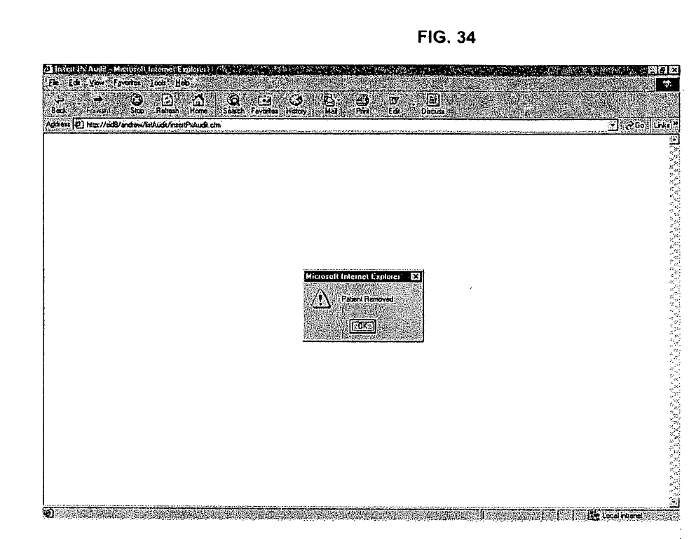

3.5 Insert Procedure Audit (insertPxAudit.cfm) FIG. 34

Function: This screen displays a confirmation message to the user confirming that a patient has been removed from the list.

Screen Elements: “OK” button—sends the user back to the Pending Audits screen.

Links:

viewList.cfm (automatic redirection, both on validation failure and a successful addition)

Programming Logic:

Validation: Validates the data used to update the “LIST” table. Ensures that there is a pre-operative requirement assigned to the patient for the purpose of calculating the pre-operative days waited. Validates the surgery date and the rebook date to ensure they are not blank. If the aforementioned fields are blank they are set to the database value known as “NULL”. Once the above validation has occurred the application updates the surgery date based on the value in the rebook date field. Validates the procedure audit index to determine if the operation is an insert or an update. Validates the rebook date to ensure it does not conflict with scheduled unavailability. The redirection of the user is validated and assigned (destination when the user completes the audit, dependent on how the audit was initiated).

Calculations: If a patient is being removed from the list the screen calculates the total number of unavailable days, total number of days on the list, total number of adjusted days on the list, total number of contiguous pre-operative days waited and the total number of cancellations for the patient being audited.

Database Queries: Query used to determine the patient's availability for surgery. Depending on whether an audit is being modified or a new one is being created an insert or update will be made to the procedure audit table with the new values. If the patient is being removed the main list table is updated with the calculated values mentioned above.

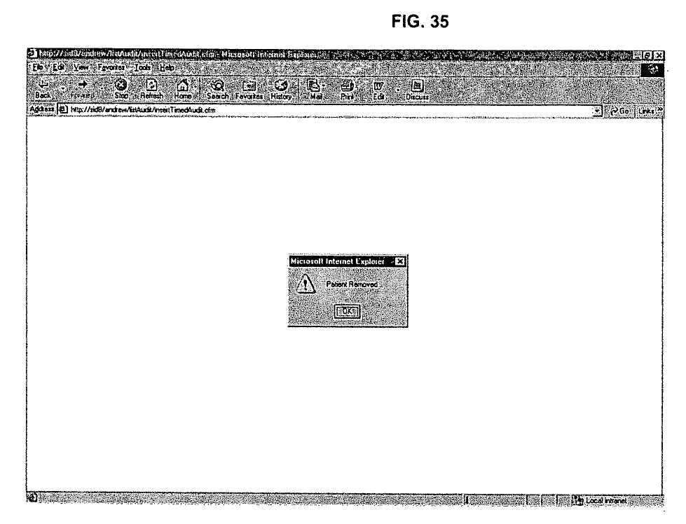

3.6 Insert General Audit (insertTimedAudit.cfm) FIG. 35

Function: This screen displays a confirmation message to the user confirming that a patient has been removed from the list.

Screen Elements: “OK” button—sends the user back to the Pending Audits screen.

Links:

viewList.cfm (automatic redirection, both on validation failure and a successful addition)

Programming Logic:

Validation: Uses ‘datecompare’ function to determine if a general audit exists for a date beyond the removal date. If this is true then an error message is displayed to the user.

Database Queries: Queries that update the table with the audit that has been performed.

3.7 Add Pre-Operative Requirements (preopReqAdd.cfm)

Function: This screen validates the preoperative requirement data from preopReq1.cfm and inserts it into the database.

Screen Elements: None—processing screen.

Links:

preopReq1.cfm (automatic redirection, both on validation failure and a successful addition)

Programming Logic:

Validation: The date noted (if present) is validated against the date requested to ensure that the dates are sequential. If the user selects a ‘Date Scheduled’, the application validates that there is a date requested. If ‘Date Requested’ is present the two dates are validated to ensure that the date requested does not exceed the date scheduled. Validates that the date scheduled is not in conflict with the patient's availability. Any failure displays the corresponding error message, and redirects the user back to preopReq1.cfm.

Database Queries: Query to ensure that the date scheduled does not conflict with patient availability. Query to update the information to be displayed on the preopReq1.cfm after the update is complete. Query to assign an index to the preoperative requirement that is being added. Query to update the preoperative requirement data in the table.

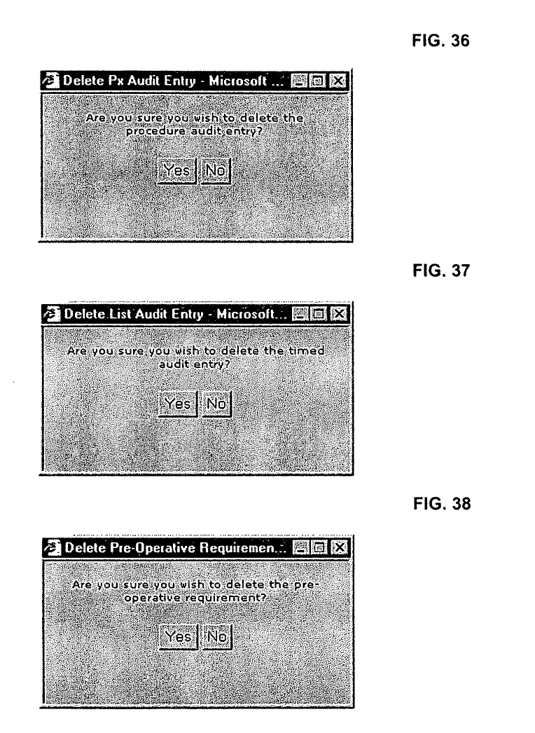

3.8 Delete Procedure Audit (pxAuditDelete.cfm) FIG. 36

Function: If the user clicks “No” the application redirects the user back to pxAuditMain.cfm with no action having taken place. If the user clicks “Yes” the application performs the deletion of the audit and redirects the user back to pxAuditMain.cfm.

Screen Elements: “Yes”/“No” buttons—redirect the user back to the Procedure Audits screen.

Links:

pxAuditMain.cfm (automatic redirection on validation failure)

pxAuditDelete2.cfm (automatic redirection on validation success)

Programming Logic:

Validation: Insures that the user wants to delete the audit.

Database Queries: None

3.9 Delete General Audit (timedAuditDelete.cfm) FIG. 37

Function: If the user clicks “No” the application redirects the user back to timedAuditMain.cfm with no action having taken place. If the user clicks “Yes” the application performs the deletion of the audit and redirects the user back to timedAuditMain.cfm.

Screen Elements: “Yes”/“No” buttons—redirect the user back to the General Audit screen.

Links:

timedAuditMain.cfm (automatic redirection on validation failure)

timedAuditDelete2.cfm (automatic redirection on validation success)

Programming Logic:

Validation: Insures that the user wants to delete the audit.

Database Queries: None

3.10 Delete Pre-Operative Requirement (preopReqDelete.cfm) FIG. 38

Function: If the user clicks “No” the application redirects the user back to preopReq1.cfm with no action having taken place. If the user clicks “Yes” the application performs the deletion of the audit and directs the user to preopReq1.cfm.

Screen Elements: “Yes”/“No” buttons—direct the user to the Pre-Operative Requirements screen.

Links:

preopReq1.cfm (automatic redirection on validation failure)

preopReqDelete2.cfm (automatic redirection on validation success)

Programming Logic:

Validation: Insures that the user wants to delete the audit.

Database Queries: None

3.11 Delete Procedure Audit—Processing Screen (pxAuditDelete2.cfm)

Function: This screen allows the application to complete the deletion of the procedure audit, receiving previously assigned variables from pxAuditDelete.cfm.

Screen Elements: None—processing screen.

Links:

pxAuditMain.cfm (automatic redirection)

Programming Logic:

Validation: Validates that the user has the correct permissions for the entry they wish to delete. The application checks the current surgery date against the rebook date and if the two are equal the application reverts back to the original surgery date. Any failure displays the corresponding error message and redirects the user back to pxAuditMain.cfm.

Database Queries: Query used to ensure that the user has the correct permissions for the entry they wish to delete. Query used to check the current surgery date against the rebook date. Query to assign an index to the preoperative requirement that is being deleted for tracking purposes. Query used to track the changes for the entry the user is deleting. Query used to revert to the original surgery date. Query to remove the entry from the audit table.

3.12 Delete General Audit-Processing Screen (timedAuditDelete2.cfm)

Function: This screen allows the application to complete the deletion of the general audit, receiving previously assigned variables from timedAuditDelete.cfm.

Screen Elements: None—processing screen.

Links:

timedAuditMain.cfm (automatic redirection)

Programming Logic:

Validation: Validates that the user has the correct permissions for the entry they wish to delete. Any failure displays the corresponding error message and redirects the user back to timedAuditMain.cfm.

Database Queries: Query used to ensure that the user has the correct permissions for the entry they wish to delete. Query to remove the entry from the audit table.

3.13 Delete Pre-Operative Requirement Audit-Processing Screen (preopReqDelete2.cfm)

Function: This screen allows the application to complete the deletion of the pre-operative requirement audit, receiving previously assigned variables from preopReqDelete.cfm.

Screen Elements: None—processing screen.

Links:

preopReq1.cfm (automatic redirection)

Programming Logic:

Validation: Validates that the user has the correct permissions for the entry they wish to delete. Any failure displays the corresponding error message, and redirects the user back to preopReq1.cfm.

Database Queries: Query used to validate that the user has the correct permissions for the entry they wish to delete. Query that removes the entry from the audit table.

3.14 Edit Procedure Audit (pxAuditEdit.cfm)

Function: This screen acts as a template for both, pxAuditMain.cfm and pxAuditAdd.cfm.

Screen Elements: PxAuditEdit.cfm appears in both pxAuditMain.cfm and pxAuditAdd.cfm and has therefore been previously documented in those sections of this document.

Links: None—template used for processing

Programming Logic:

Validation: Validation used to assign values to the procedure reason code and its corresponding description.

Database Queries: None—template used for processing

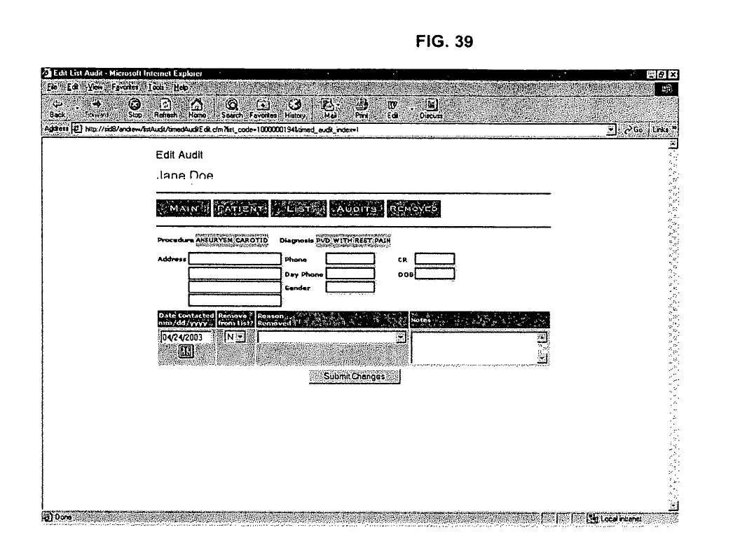

3.15 Edit General Audit (timedAuditEdit.cfm) FIG. 39

Function: Displays the general audit for the selected patient in order to allow the user to edit that audit.

Screen Elements:

Patient Demographics

Patient name, address, phone number, gender, unique identifier, date of birth

Procedure

The procedure to be performed on the patient. See Screen Elements—Procedure in 1.2 for details.

Diagnosis

The diagnosis of the patient. See Screen Elements—Diagnosis in 1.2 for details.

Date Contacted

The date the patient was contacted. Upon entering a contact date, the audit will no longer appear on the general audit list.

Remove From List?

This is a drop down list of ‘Y’ and ‘N’, used to indicate whether or not the patient is to be removed from the list.

Reason Removed

The reason why the patient is being removed. Selected only when the patient is being removed from the list.

Notes

Any user-related notes pertaining to the particular general audit may be entered here. Optional.

Links:

main.cfm

viewPatient.cfm

view_list.cfm

AuditPatients.cfm

removedList.cfm

timedAuditMain.cfm (on Submit)

Programming Logic:

Validation: On load, the redirection of the user is validated and assigned (destination when user submits audit changes, dependent on how the change was initiated).

The following validation occurs after the “submit audit” button is clicked:

If ‘Y’ is selected as ‘Remove From List?’ the application ensures that a value from the ‘Reason Removed’ drop down list is also selected. If ‘N’ is selected as ‘Remove From List?’ the application then validates the user has not selected a value from the ‘Reason Removed’ drop down list. Any failure displays the corresponding error message. Any failure displays the corresponding error message and redirects the user back to this screen.

Database Queries: Queries that get the patient information to be displayed for the audit in question. Query used to populate the ‘Reason Removed’ drop down list with possible reasons for why a patient may need to be removed. Query that retrieves the patient information to be displayed for the audit in question.

3.16 Check Pre-Operative Readiness (preopUpdateReady.cfm)

Function: This screen acts as a template for both preopReqAdd.cfmn and preopDelete2.cfm.

Screen Elements: None—template used for processing

Links: None—template used for processing

Programming Logic:

Validation/Assignments: On load, the readiness of the patient is validated and assigned.

Database Queries: Query used to establish the readiness of the patient in question if they have any outstanding pre-operative requirements. Query used to establish the readiness of the patient in question if they do not have any outstanding pre-operative requirements. Query to update the readiness of the patient based on the aforementioned validation.

3.17 Get Last Audit Date (getLastAuditDate.cfm)

Function: This screen acts as a template for both pxAuditDelete2.cfm and timedAuditDelete2.cfm.

Screen Elements: None—template used for processing

Links: None—template used for processing

Programming Logic:

Validation/Assignments: If a ‘last audit date’ is not present the application assigns the ‘list date’ to the ‘last audit date’. If the above assignment does not apply the application compares the two dates (‘list date’ and ‘last audit date’) and takes the larger of the two as the last audit date.

Database Queries: Queries that retrieve the last general audit date and the last procedure audit date of the patient in question. Queries that update the last audit date based on the aforementioned validation/assignments.

4.0 Reporting

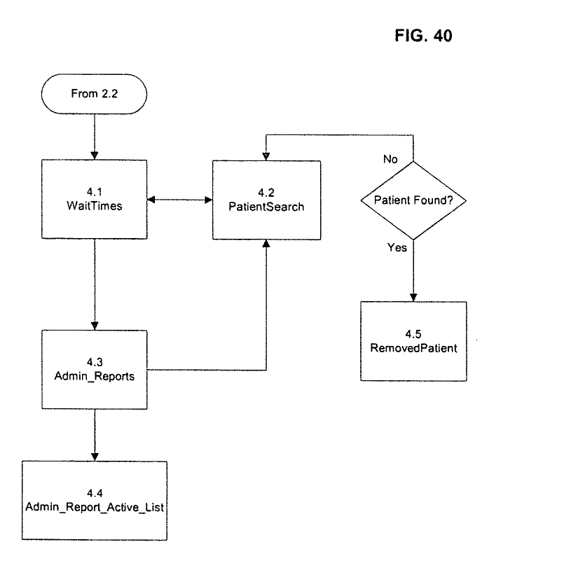

Referring to FIG. 40, the reporting subsystem (module) 4.0 allows for the reporting of specific information relating to patient wait times. Reports currently being produced by the reporting module are “Elective Surgical Wait Times Completed Cases by Procedure” and “Active List Status by Physician”. These reports are pertinent to hospital administrators for the purpose of analyzing the use of hospital resources, the efficiency of physicians and the overall quality of health care given to patients. Note that while the module currently only produces the aforementioned reports the module could produce any report that is related to patient care and the length of time a patient is on a wait list for service based on the data stored in and accessible to the management system 0.

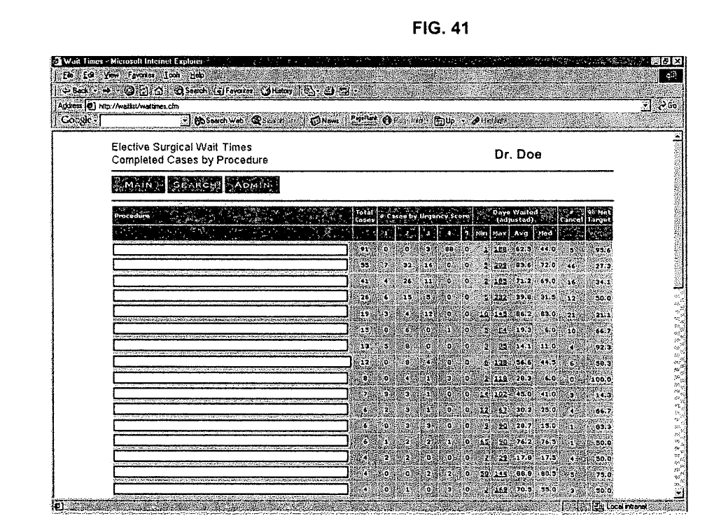

4.1 Wait Times (waittimes.cfm) FIG. 41

Function: This screen displays a report that lists elective surgical wait times for completed cases ordered by procedure.

Screen Elements:

Procedure

The completed procedure. See Screen Elements—Procedure in 1.2 for details.

Total Cases

Calculated value of the number of cases that required the corresponding procedure

# Cases by Urgency Score

The number of cases broken down by individual urgency score for the corresponding procedure.

Days Waited (Adjusted)

The number of days a patient waited for surgery after factoring in the number of unavailable days. This is broken down into: Min—minimum number of days waited, Max—maximum number of days waited, Avg.—average number of days waited, Med.—the number of days waited representing the median for the group.

# Cancel

The calculated number of cancellations for the corresponding procedure

% Met Target

The percentage of cases that were completed by their target date. For details on target times, see section 2.3.

Start Date Filter

Date picker used to set a starting date for the report

Physician Filter

Drop down list used to view results for a specific physician

Anesthetic Filter

Drop down list used to view results for procedures that used anesthetic

IP/OP Filter

Drop down list used to view results for inpatients (IP) or outpatients (OP) specifically

End Date Filter

Date picker used to set an end date for the report

Links:

main.cfm

patientSearch.cfm

admin_reports.cfm

waitTimesPx.cfm (when the user clicks on a “procedure name”, “min” or “max”)

Programming Logic:

Validation: Validates the filter(s) set by the user to ensure that only the information selected for viewing is displayed. Ensures that if the user has administrative rights the “admin” button will appear on the screen. Uses a series of validation to calculate the median and median total (used in the grand total section of the report).

Database Queries: Query that drives the output for the template. Query that calculates the min, max, and avg. number of cases. Query that retrieves the number of completed cases per procedure. Query that gets a record set for the purpose of calculating median total. Query used to populate the physician filter drop down list. Query used to determine whether the “admin” button should appear on the screen. Query used to calculate the percentage of cases that met their target per procedure. Query that gets urgency score totals per procedure. Queries used to calculate grand totals for; min, max, avg, med, total cases, urgency scores, completed cases, and number of cancellations and percentage that met their target.

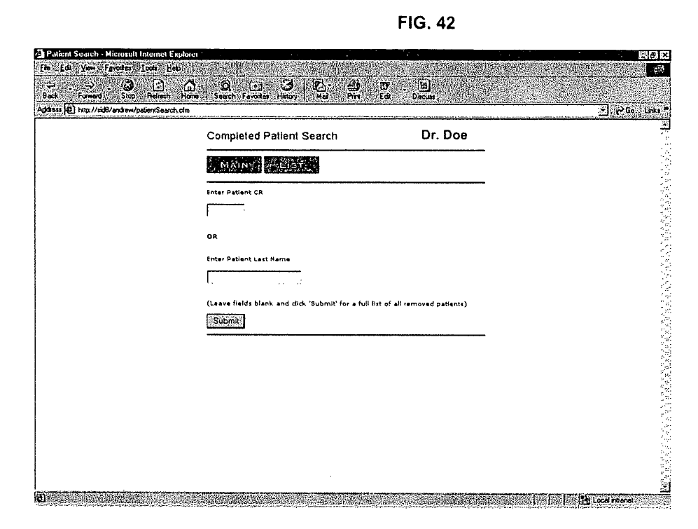

4.2 Patient Search (patientSearch.cfm) FIG. 42

Function: This screen allows the user to search the database for patients that have had their procedure performed and are therefore listed as “completed”.

Screen Elements:

CR and Last Name Text Boxes

User enters CR number or Last Name here as the search criteria (can leave blank for a complete list of all of the patients who have been completed)

Submit

Used to initiate the search by the user

Links:

main.cfm

waittimes.cfm

patientSearch.cfm (loop back on “Submit” and on “Search Again”)

removedPatient.cfm (only after a search has been completed and the user clicks “Select” while having a patient's name highlighted)

Programming Logic:

Validation: Series of validation used to determine which criteria (CR Last Name) the application has to search on. If no patients are found in the search a message is displayed.

Database Queries: Query used to retrieve the patients that match the search criteria.

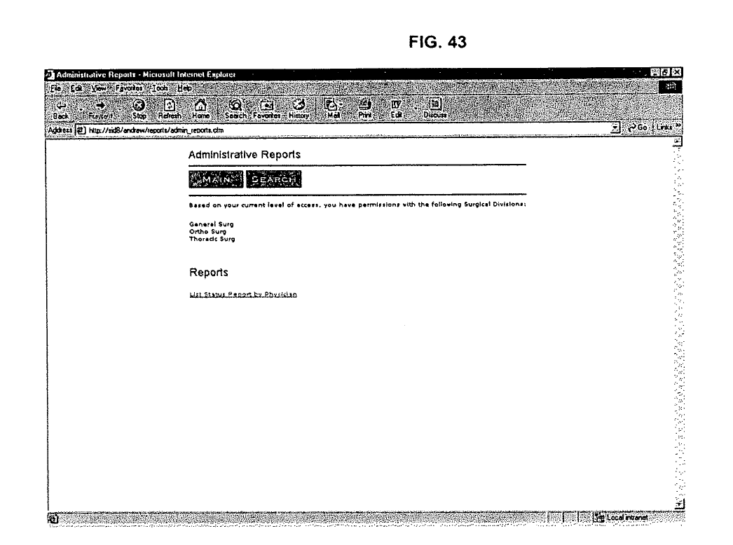

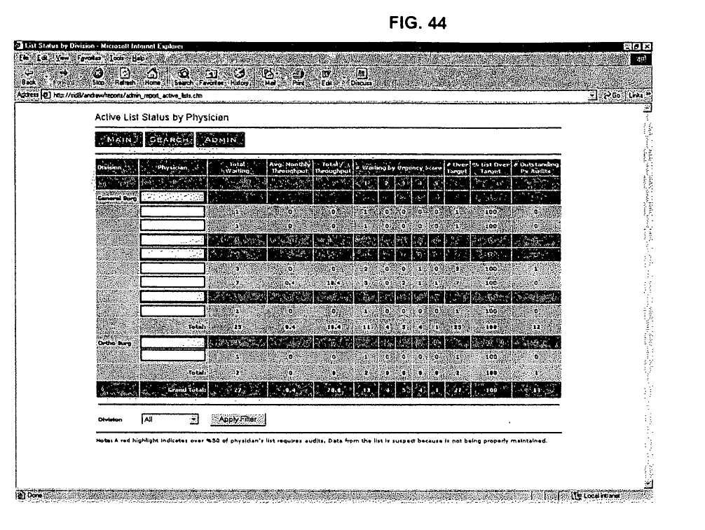

4.3 Administrative Reports (admin_reports.cfm) FIG. 43

Function: This screen allows the user to select an administrative report for viewing.

Screen Elements: None—navigational screen

Links:

main.cfm

patientSearch.cfm

admin_report_active_lists.cfm (when the “List Status Report by Physician” link is clicked)

Programming Logic:

Validation: Validates that the user has the permission/rights to access the administrative reports.

Database Queries: Query used to enforce the security of report viewing to allow only those users who have permissions to view the administrative reports. The aforementioned query also lists the surgical divisions (for which the user has permissions with) on the screen.

4.4 List Status by Division (admin_report_active_lists.cfm) FIG. 44

Function: This screen displays a report detailing information regarding lists that are being maintained by different physicians. Information such as: total number of patients waiting, avg. monthly throughput, total/throughput, number of patients waiting by urgency score, number of patients over their target, the percentage of their list that is over target and the number of outstanding procedure audits. The aforementioned information is displayed on the physician level, division level as well as the overall level (grand totals).

Screen Elements:

Division

The medical division(s) represented in the table

Physician

The name of the physician

Total Waiting

Number of cases waiting on the lists

Avg. Monthly Throughput

The average number of cases performed per month.

# Cases by Urgency Score

The number of outstanding cases broken down by urgency score.

# Over Target

The number of current cases that have surpassed their target wait time. For information on target times, see section 2.3.

% List Over Target

The percentage of current cases that have surpassed their target wait time. For information on target times, see section 2.3.

Division Filter

Drop down list used to view results for a specific surgical division.

# Outstanding Px Audits

The number of current outstanding procedure audits on the physician's list.

Links:

main.cfm

patientSearch.cfm

admin_reports.cfm

admin_report_active_lists.cfm (loop back on “apply filter” with desired results being displayed)

Programming Logic:

Validation: Ensures that if a filter has been applied by the user that only the desired results are displayed. Validates each time through the main loop to ensure that if a new division is encountered the sub-totals for the previous division get displayed before the new division is displayed. Validation to avoid division by zero. Validation used to display a red background for each physician that has a list with greater than fifty percent of his/her patients still waiting to be audited. The application also ensures that if a new division has not been encountered within the loop the “Division” column is not constantly being updated with the same division name. Validation used to ensure that the grand total line is displayed only when the “Division” filter is set to “All”.

Database Queries: Query used to count the number of patients waiting on each list. Query used to populate the “Division” filter drop down list. Queries to count the number of patients waiting by urgency score. Queries ran against the aforementioned queries to attain the number of patients waiting by urgency score per physician. Query used to calculate the number of throughput dates. Query used to calculate the number of patients that have surpassed their target wait time.

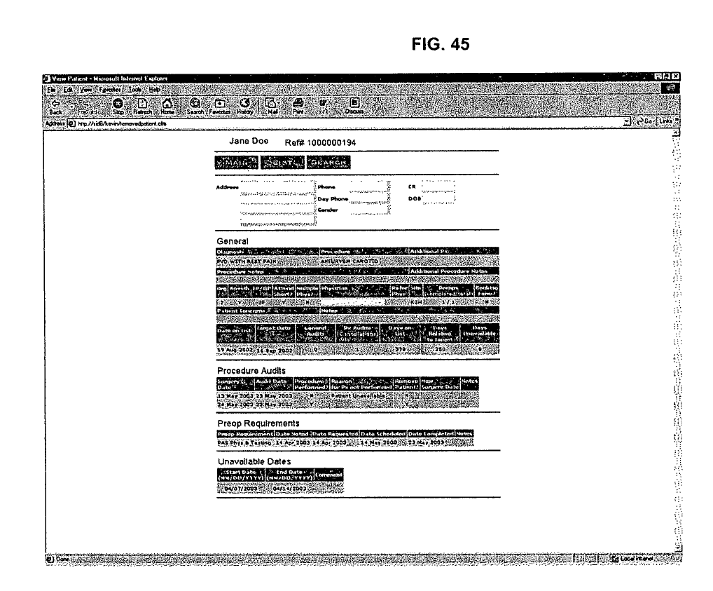

4.5 View Removed Patient (removedpatient.cfm) FIG. 45

Function: This screen allows the user to view patient demographics, procedure information, and audits for a patient who has been removed from the wait list.

Screen Elements: The screen is divided into three main sections, each of which displays elements that have been explained elsewhere in this document.

General:

This section displays information pertaining to the procedure. It contains all of the elements of ViewPatient (2.7), but does not allow the data to be edited by the user.

Audits:

This section displays information pertaining to any audits which have been performed on this list entry. This includes Procedure Audits (FIG. 31), General Audits (FIG. 32), and Preoperative Requirements (FIG. 33). The data cannot be edited.

Unavailable Dates:

This section lists date ranges during which the patient was unavailable. These date ranges cannot be edited.

Links:

main.cfm

waittimes.cfm

patientsearch.cfm

Programming Logic:

Validation: Ensures that a valid list code has been supplied.

Database Queries: Query used to retrieve patient demographic information. Query used to retrieve list information. Query used to determine total days the patient was unavailable. Query used to check if the patient is on any other doctors' wait lists. Query used to retrieve procedure audits for the patient. Query used to retrieve general audits. Query used to retrieve preoperative requirements.

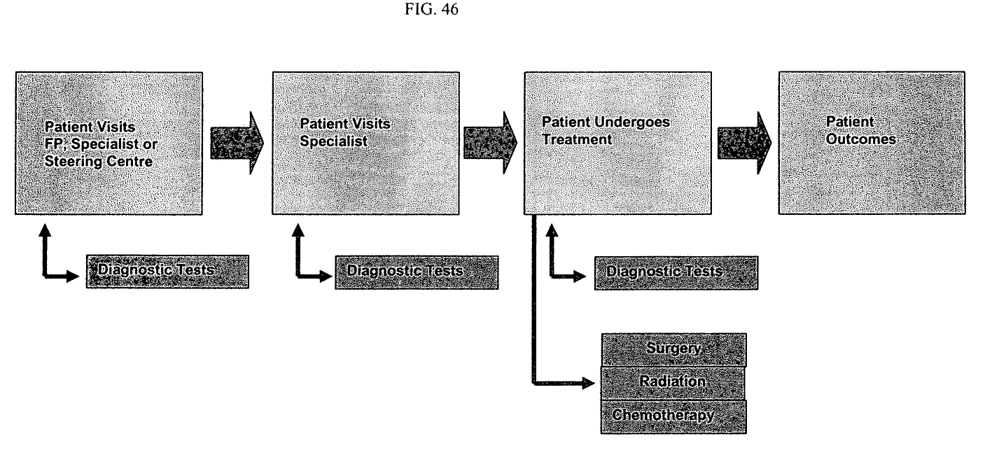

Referring to FIG. 46, the management system 0 is utilized throughout the patient care process. This includes use at the time of patient visits to an initial case site for referral, be it a family practitioner, specialist or steering centre. This can be followed by use at a specialist patient visit, when the patient undergoes treatment, and after treatment. The management system 0 takes into account diagnostic tests at each step, and such treatments as surgery, radiation, chemotherapy and other.

The management system 0 is a web-based software tool for managing patients waiting for medical services and tracking patient waiting. This web-based software product assists physicians in the referral and management of patients awaiting surgery, endoscopy, and other diagnostic and therapeutic services, regardless of their disease state. The management system 0 tracks patients' paths across the wait continuum and provides information that reduces the time commitment of providers and increases the efficiency of hospital services.

A critical determinant for success of systems that integrate into the daily work activities of physicians and other healthcare workers is the degree to which the systems improve the quality of users' work and reduce the effort required. The management system 0 reflects the ways in which information technology can improve users' lives and be a benefit and not a burden. The enthusiastic adoption of the tool by physicians and other healthcare staff ensures that there will be timely, accurate wait time information upon which to make management decisions.

The management system 0 is web-based enterprise software that assists physicians in managing patients awaiting consultation, diagnostic tests, surgery, and other procedures. The management system 0 operates successfully in a secure fashion in a healthcare environment using patient-level data for the management of patients in real time. It provides healthcare providers and managers with accurate and concurrent data on the status of their patients and a clear view of currently unmet needs.

The management system 0 recognizes that many waiting list registries fall short of expectations because the data received by them was untimely, inaccurate or invalid. The major reasons for these failings is that the data is not captured during the process of patient care, but as an administrative add-on and that the tool used to capture the data was not integral to the patient care process itself. Thus the management system 0 provides a tool to be used as part of the process of care.

The management system 0 and the tool for data capture assist in the health care processes, and are built around these processes. The entered data is used by providers to manage patients during the waiting period, thus ensuring the timeliness, reliability and validity of the data. The management system 0 provides tools that actively assist in the management of patients waiting for service. The management system 0 is constructed so as to accommodate the referral process thus capturing waiting at the point of referral.

The management system 0 facilitates patient care management by having a structure that accommodates the differing needs and priorities of different patients. The management system 0 has a structure with sufficient flexibility to assist in the management of patients waiting for a wide variety of health care services. The management system 0 is able to comply with security standards required for healthcare data systems. The management system 0 has audit functions to ensure the integrity of both the health care process for individual patients and of the data elements themselves.

The management system 0 has a data structure that supports the broadest options for reporting. The management system 0 is able to interface appropriately with other hospital systems. The management system 0 is user friendly, simple, intuitive, portable and scalable. The management system 0 is widely accessible to many users at multiple locations

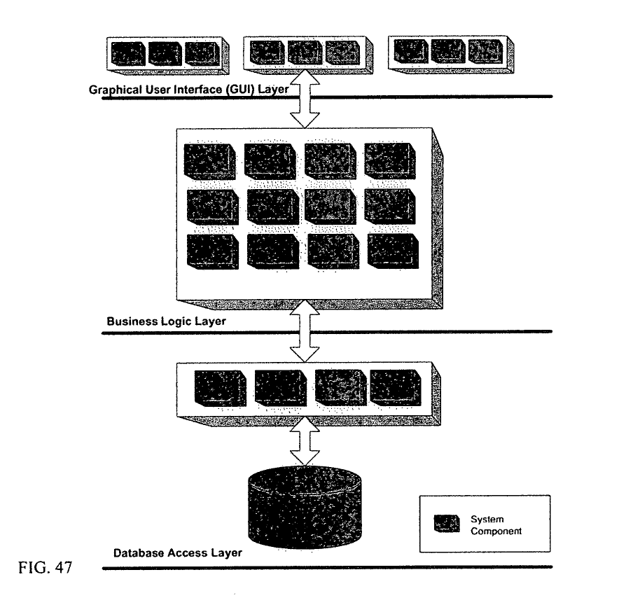

Referring to FIG. 47, the management system 0 has a database layer, GUI, and business logic layer.

Database

The database is relational and constructed to permit reflection of varying patient, provider and encounter requirements. The relational data base structure allows for the broadest possible reporting options using standard query tools. Table content mirrors the care process needs and relevant tables in other hospital systems as required and is constructed to accommodate the broadest possible use.

Graphical User Interface (GUI)

The interface screens are intuitive, extremely user-friendly and efficient. Each user screen has a relevant help page available at a button click. Web-based reports are designed and available to reflect the identified needs of the users. These reports are dynamic in that their specific content can be modified to meet the needs of the specific user. Further web-based reports are easily added as the need and content are identified. The web-based user interface is designed to be intuitive and reflects the needs and data flows as identified by the users.

Business Logic

Business logic reflects the processes of care. Business logic reflects healthcare decision making. The business logic accommodates the referral process. The business logic maximizes data quality and integrity through validation processes. The business logic supports the audit process, ensuring list validity.

Infrastructure

The management system 0 is web-based and interfaced with other hospital data systems to eliminate re-entry of demographic and other data. The web-enabled system allows user access from multiple sites as governed by security access protocols. The web-enabled system supports remote access. System security leverages hospital network security processes and allows for monitoring and auditing by both clinical and administrative leadership.

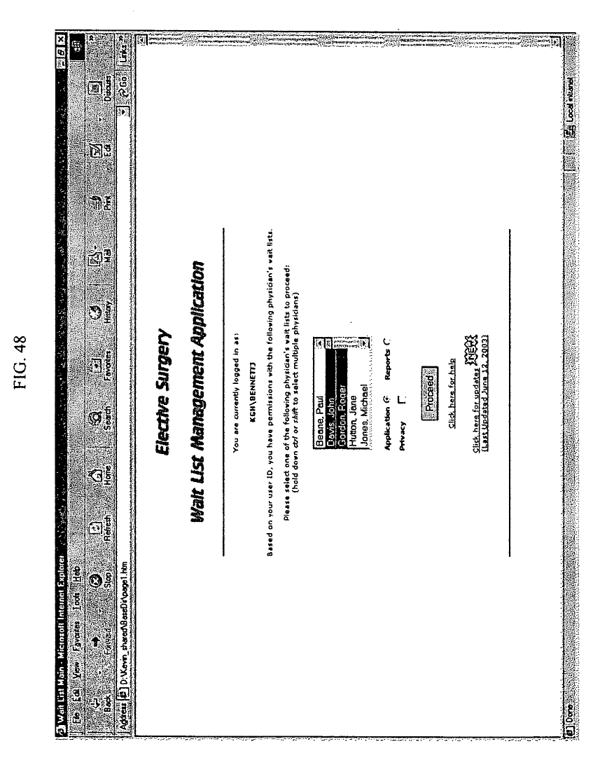

The following points list many of the key functionalities of the system. These functionalities can be seen in the screen shots in FIGS. 48 through 54.

Log-On and Security (FIG. 48)

Log-on is via Windows NT security protocols but other security protocols could be substituted. Individual user access is determined by their security privileges. A single user can have privileges for multiple lists, facilitating shared practice and service level management of resources. The management system 0 can accommodate read only privileges. The management system 0 accommodates read only privileges with all patient identification masked. The management system 0 accommodates the full tracking of changes to pre-specified fields.

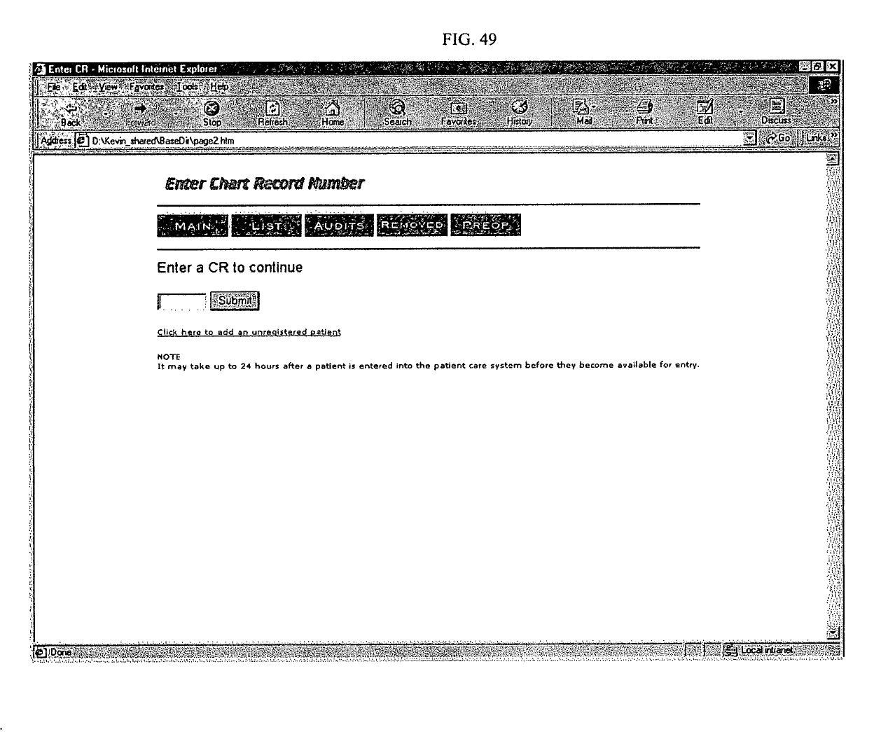

Record Building (FIG. 49-51)

Users are able to add or remove a patient from the wait list. Basic patient data is normally entered using the hospital registration number (FIG. 49). Core demographic data is then imported from the hospital registration system. This data is updated daily.

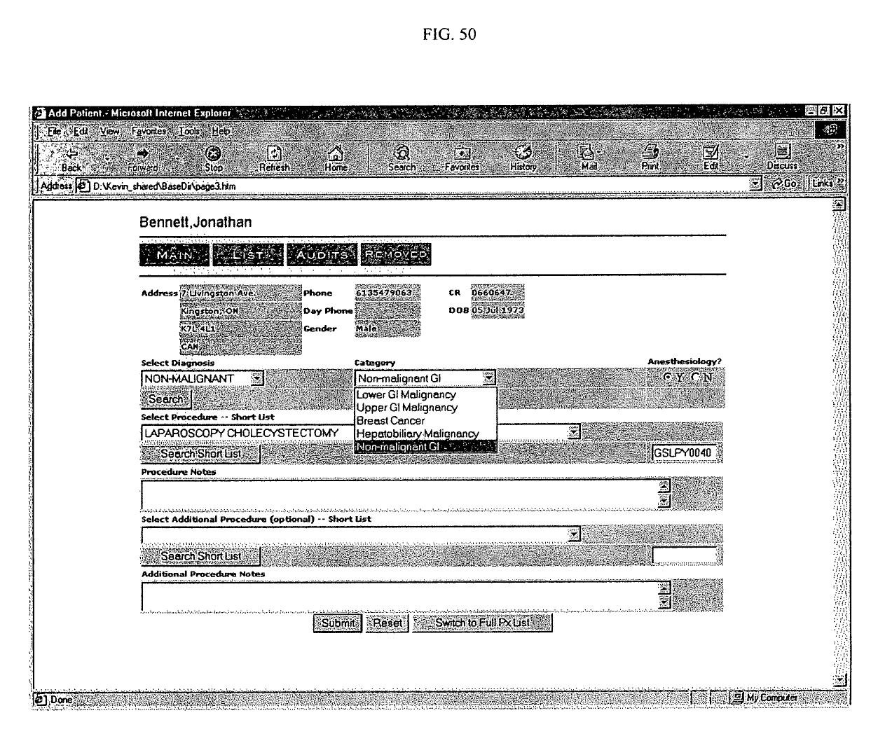

When no hospital ID number exists place-holding data can be entered by the user directly and subsequently updated when the patient receives a hospital ID number. Patient diagnosis, relevant to the procedure or service is entered from drop down menus. Patient categories, relevant to waitlist reporting e.g. large bowel malignancy or peptic ulcer disease, can be entered from drop down menus (FIG. 50).

Operative procedures are selected from drop down menus, specific to the physician specialty, that reflect the procedure listings in the operating room management system.

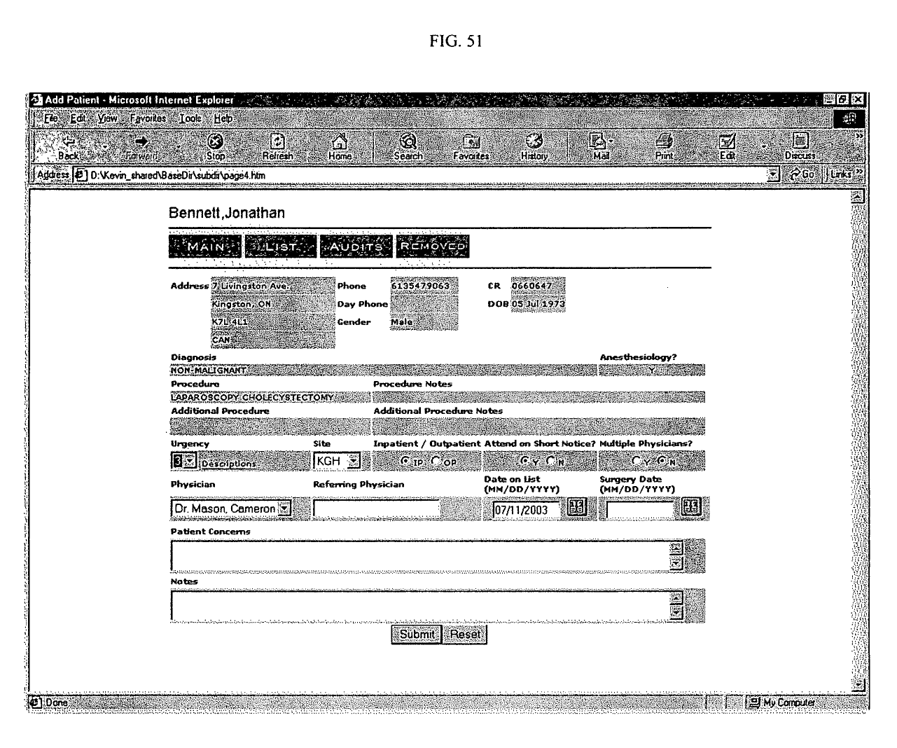

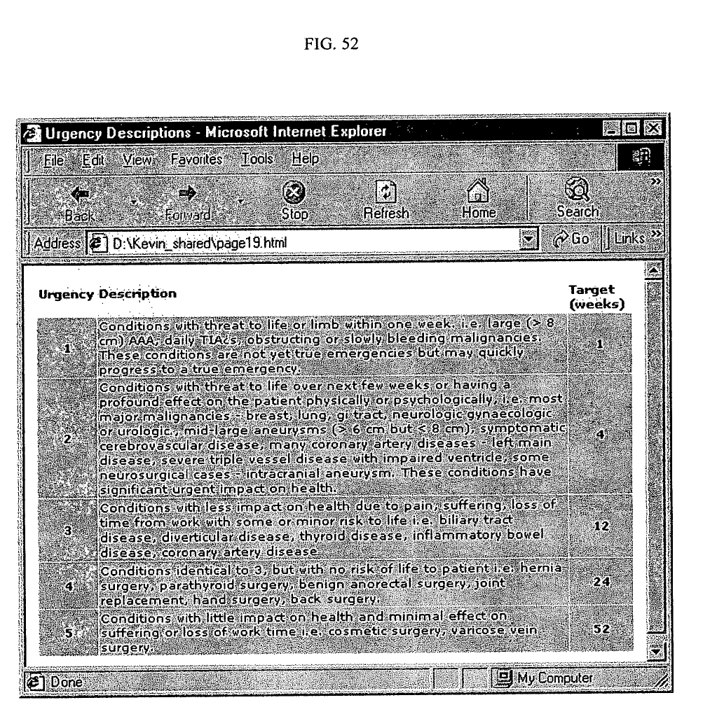

Relative Urgency Scores on a 1-5 scale are entered (FIG. 51) (Pop up window provides definition, see FIG. 52). Other urgency scoring systems can be easily substituted and could be service or procedure specific.

Additional procedures may be entered. Anaesthesia requirements can be entered. Whether the procedure is inpatient or outpatient is indicated. The hospital site for the procedure can be selected from drop-down list. Whether the patient can attend on short notice is recorded. The physician responsible for the procedure is entered from a drop-down list that is restricted based on the user's privileges. Referring physician and additional involved physicians can be entered.

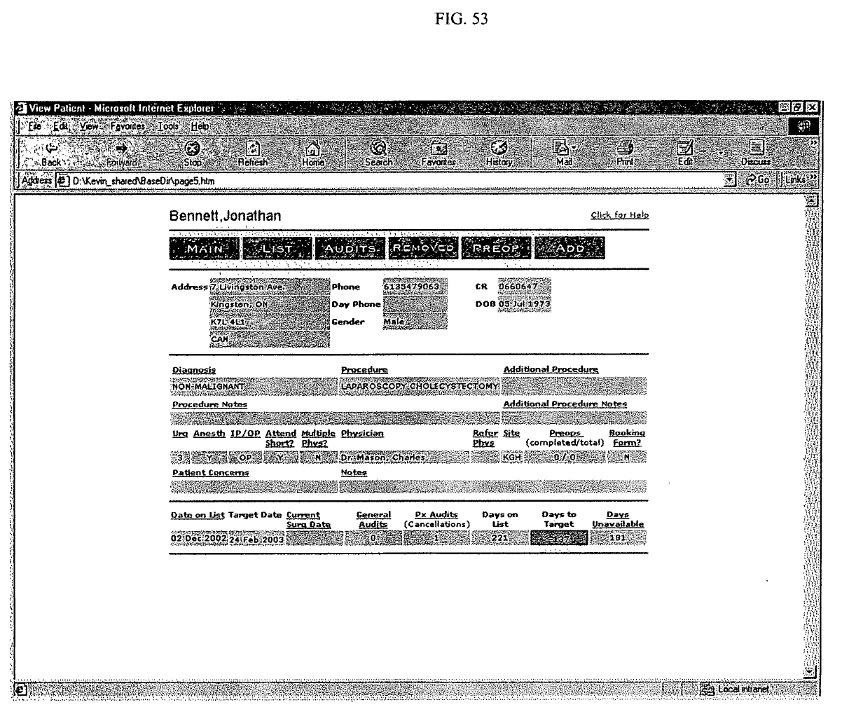

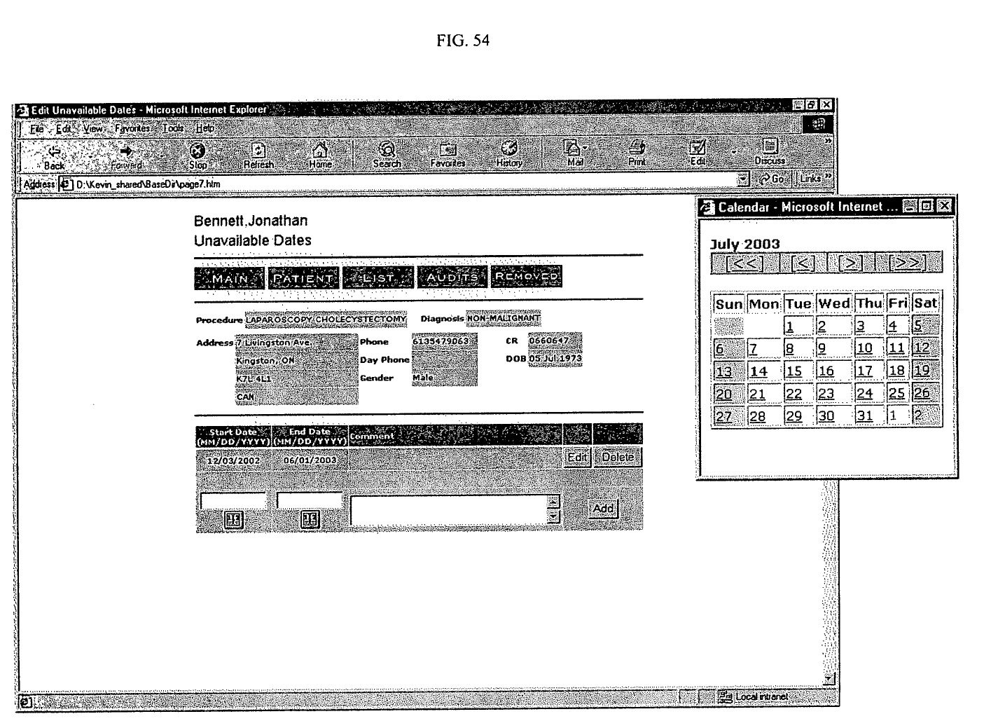

The date on the list is entered (default is date patient added to list). Procedure date can be selected from a pop up calendar and booking calendars, based on surgeons OR time allocations may be a source of procedural dates. Pre-operative requirements (which include diagnostic investigations such as MR/CT) can be selected from a drop-down menu and dates relevant to these can be entered (dates include date noted, date requested, date scheduled, date completed). (see patient overview incorporating the above information in FIG. 53)

Dates when the patient is unavailable can be selected from a drop-down menu (FIG. 54). These dates are taken into account when booking the patient for procedures and when calculating time on the list.

Additional fields for comments on procedures or patient concerns are available. Depending on content fields can be made mandatory. Certain data elements are subject to validation at entry.

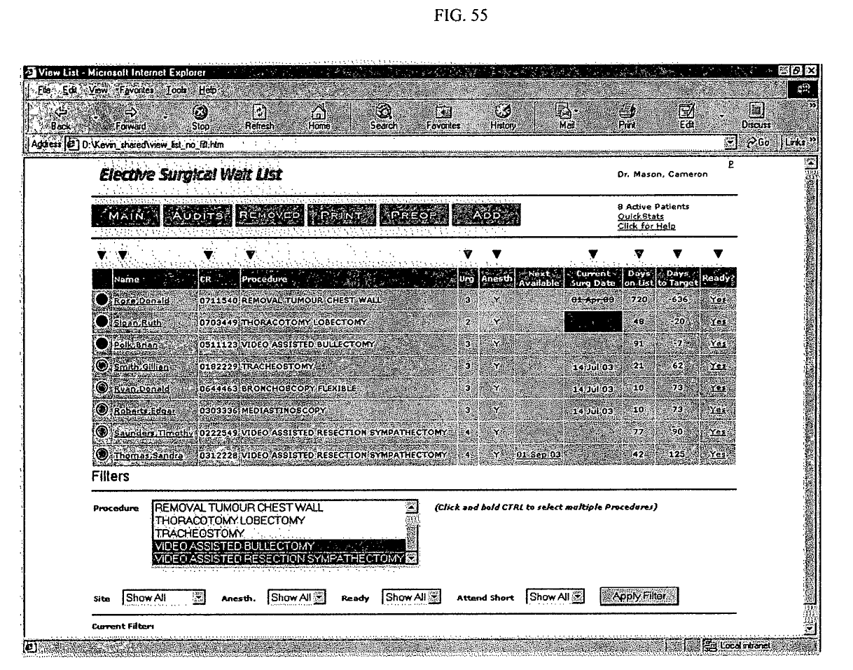

Referring to FIGS. 7.0 through 7.12, each Urgency score is associated with a target waiting time. Target waiting times are used to calculate days to target. Users can view a single surgeon's list or multiple surgeons' lists depending on assigned privileges (FIG. 55).

Users can order the lists they are viewing by:

Urgency score

Days to target

Days on list

Selected surgery date

Patient preparedness

Procedure

Patient name or ID number

Users can filter lists to select patients on the basis of:

Procedure

Patient availability to attend on short notice

Hospital site

Anaesthetic requirements

Patient readiness

Colour coding on the list identifies patients who are past or near their target dates for service. Users are informed at the time of adding patients if they are already on another list. Users can see on list any patient who is currently unavailable to receive service. Users can see on the list scheduled dates for procedures if they have been scheduled.

Users can see on list patients who have had their previously scheduled service cancelled

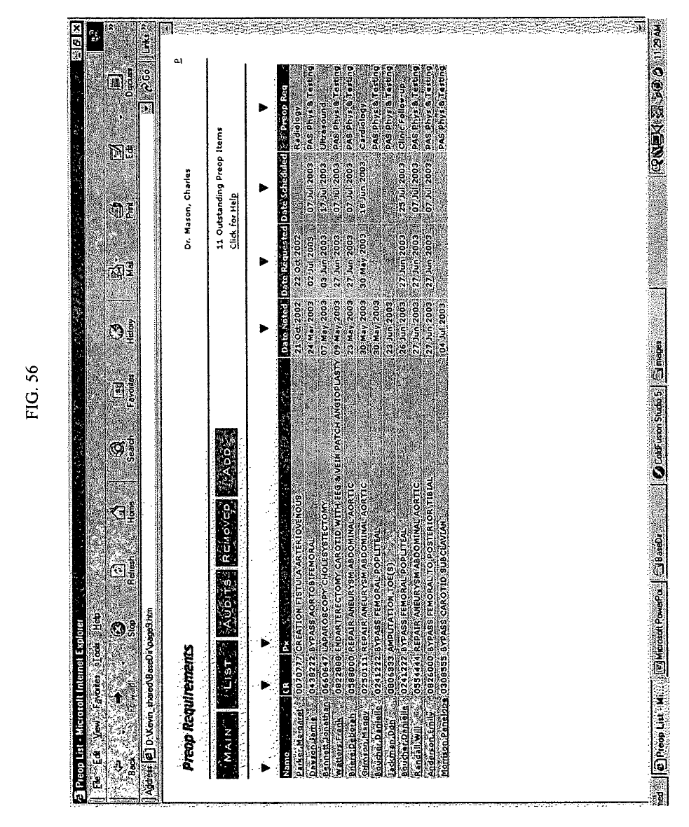

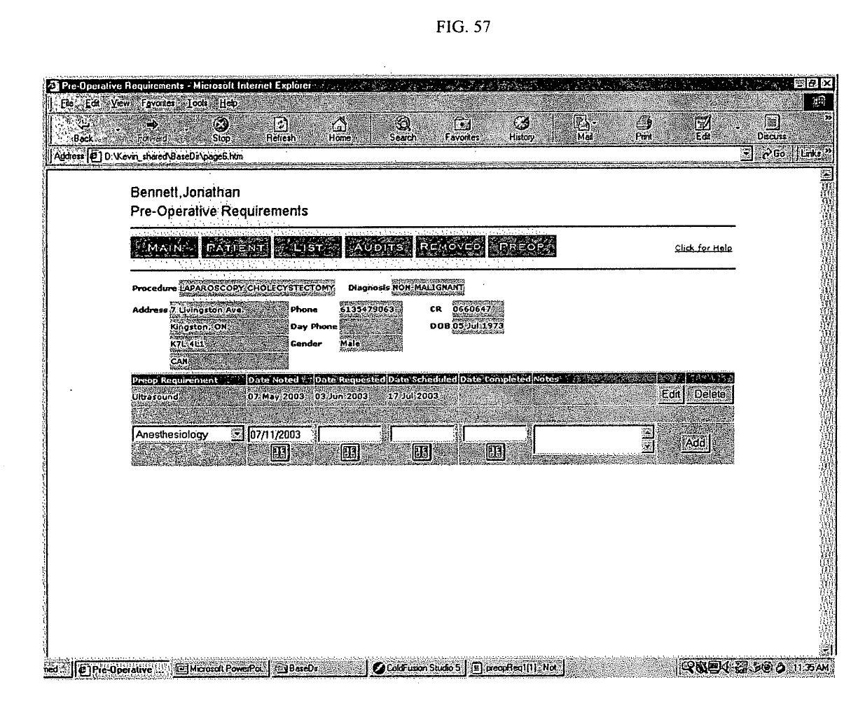

A button click provides users with a list of all outstanding pre-operative procedures, diagnostic tests or consultations and their status (FIG. 56). Users can review overall status of any patient with a click on patients name (FIG. 57)

Users can review past history of a patient's procedures and any cancellations by clicking a field.

Functionality exists to allow users to send referrals to other providers or services or even to themselves for different services (FIG. 66). This referral can be coupled with an urgency rating. This functionality can be extended to be made available to permit referral from family physicians. This functionality currently gives the referring provider (FIG. 67),

Notification that referral received

Notification that referral accepted or rejected

Notification of scheduled patient attendance Ongoing record of referrals and their status

And gives the provider receiving the referral:

Response screen to acknowledge, accept or reject the referral

Button to add patient to their list

Ability to notify referring provider of scheduled visit

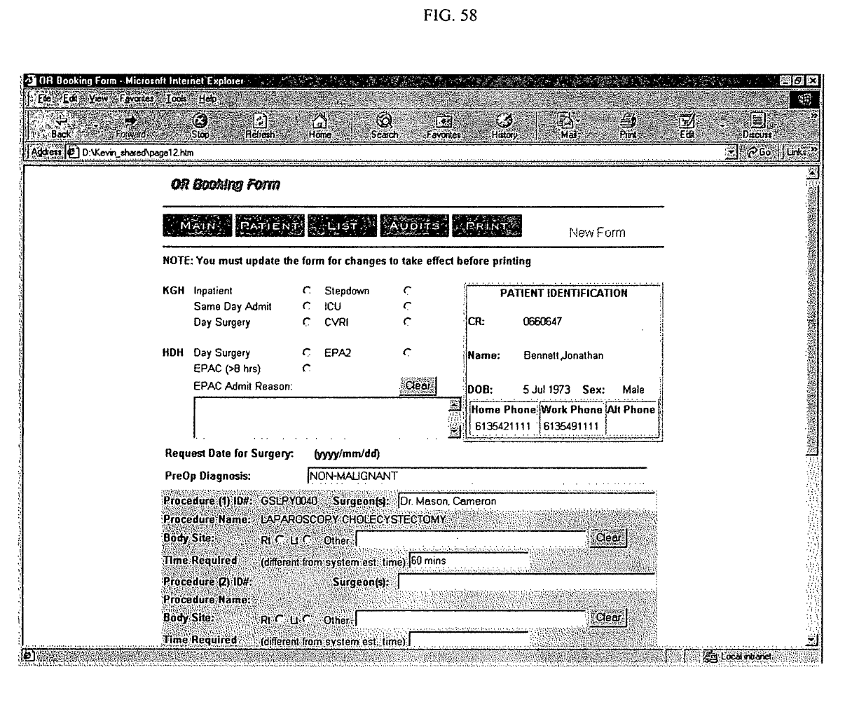

Users can complete an OR procedure booking form which is pre populated with all relevant data in the management system 0 (FIG. 58). The management system 0 supports delivery of the form by the following means:

Direct upload by interface to OR scheduling system

Via booking calendar described below and from there by direct upload to to the OR scheduling system.

Via secure email connection

Via secure fax.

A calendar based booking tool allows the user to schedule patients on a template of the surgeon's allocated operating time. Bookings of procedures on the template are associated with procedure times derived from the O.R. system. Attempts to overbook are flagged.

Users can remove patients from the list or cancel a booked procedure and leave that patient on the list to be rebooked. With each of these tasks they will be requested to record reason for cancellation or removal from the list pre-specified reasons can be selected from drop down menus.

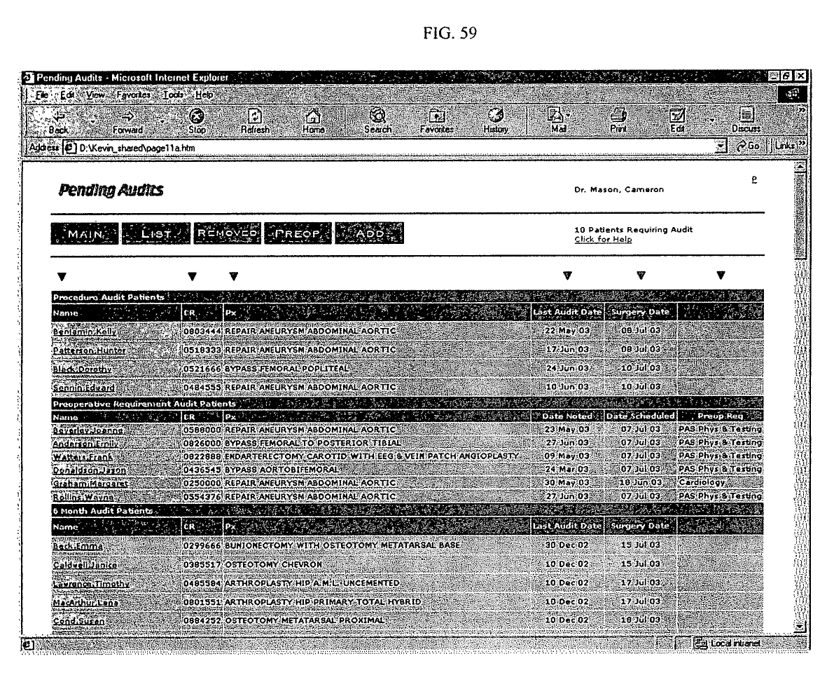

After each scheduled surgery date users are prompted to indicate if the surgery was completed and, if not, to indicate reasons from a drop down menu. For both completed patients and cancelled patients they are asked whether or not to remove the patient from the list and are given the option to rebook the patient (FIG. 59).

After a patient has been on a waiting list for a pre-specified period (e.g. 6 months) the user is prompted to contact the patient and ascertain whether the patient still requires surgery and, if not, record the reason from a drop down menu. They are also asked whether or not the patient should remain on the list (FIG. 59).

After the date for any preoperative procedure or test is reached the user is prompted to indicate completion (FIG. 59). If these post-procedure, time-based and pre-procedure testing audits are not completed, the prompts continue to be presented at each log-on.

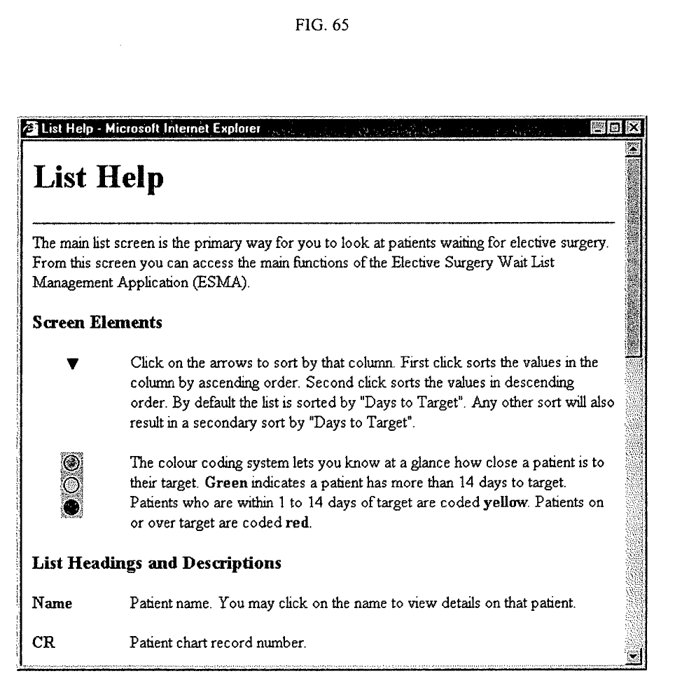

Each user interface screen has a help button to access help specific to that screen (for example, FIG. 65).

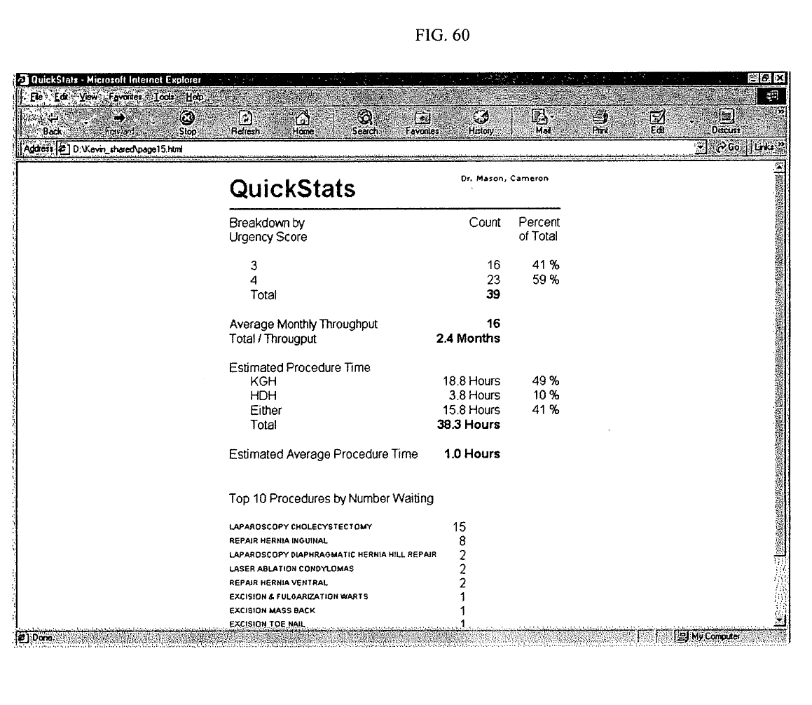

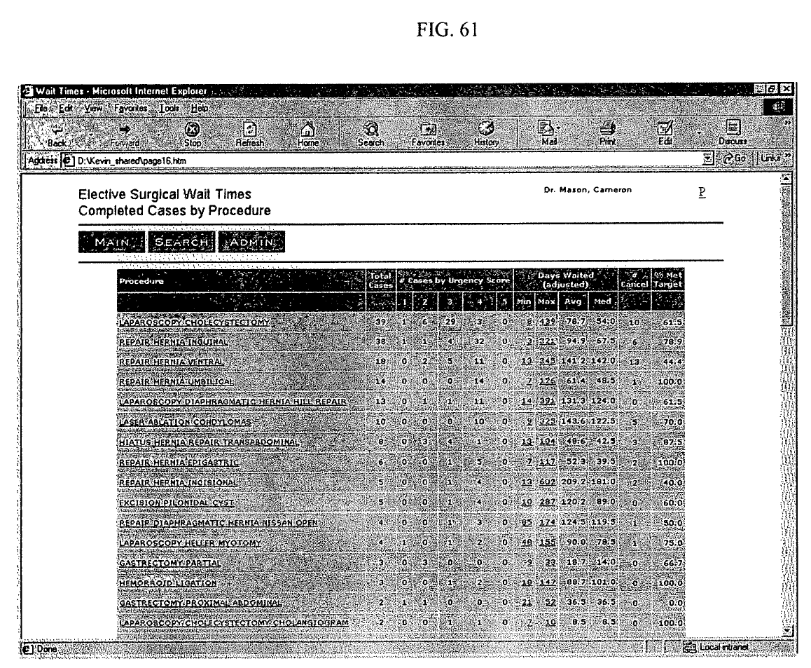

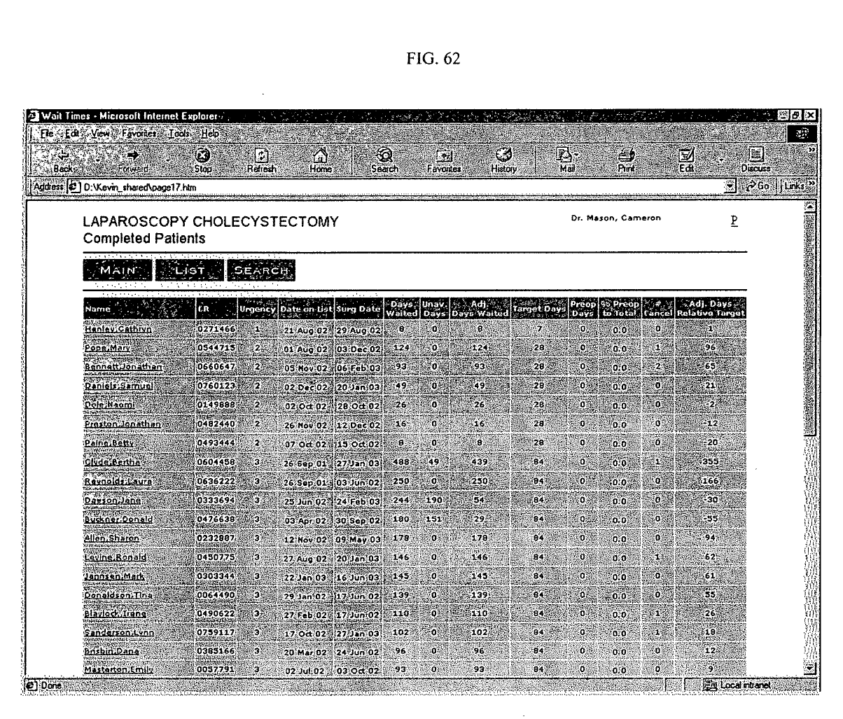

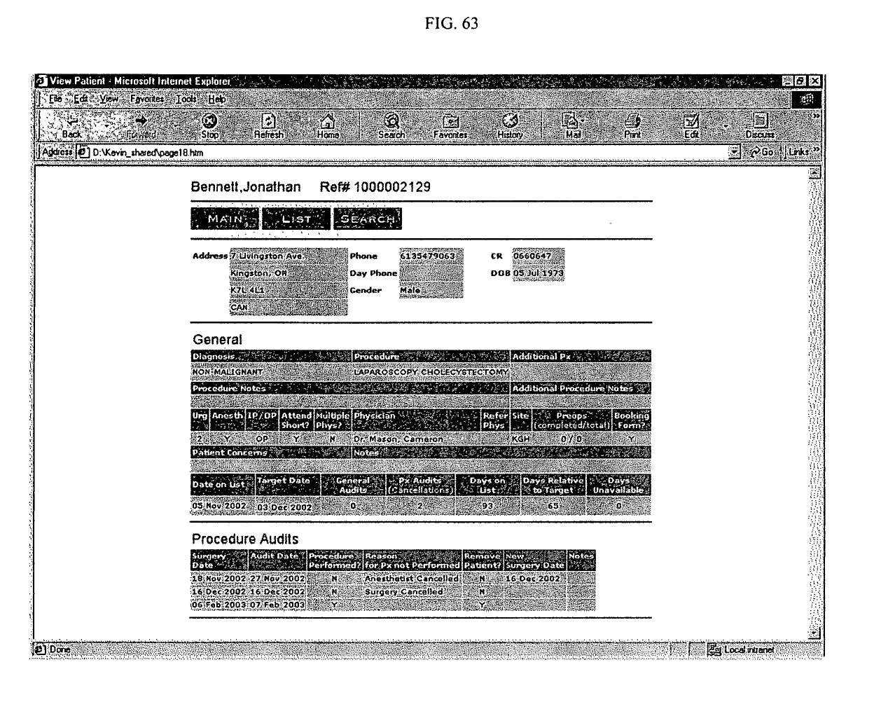

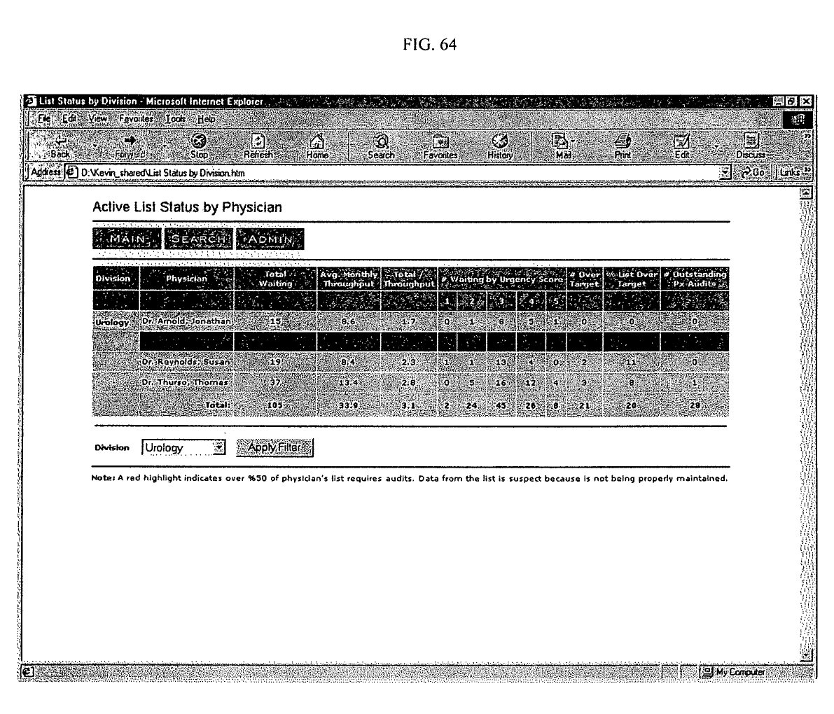

Users can view list statistics breaking down the waiting list by urgency score, monthly throughput, proceure time, or top 10 procedures by number waiting (FIG. 60). Users can also view wait times for completed cases by procedures (FIG. 61) and wait times for individual completed procedures (FIG. 62). Users can view a patient overview for an individual completed patient (FIG. 63). Users can view active list status by physician (FIG. 64).

It should be noted that the capture of all relevant dates (for some patients as many as 50; for rare patients, even more) in a relational data base makes the generation of almost any report on waiting, aggregated at almost any level, possible with standard tools. However some reports are currently built into the tool. Others can be easily added as they are identified and defined. The current waiting list reports include:

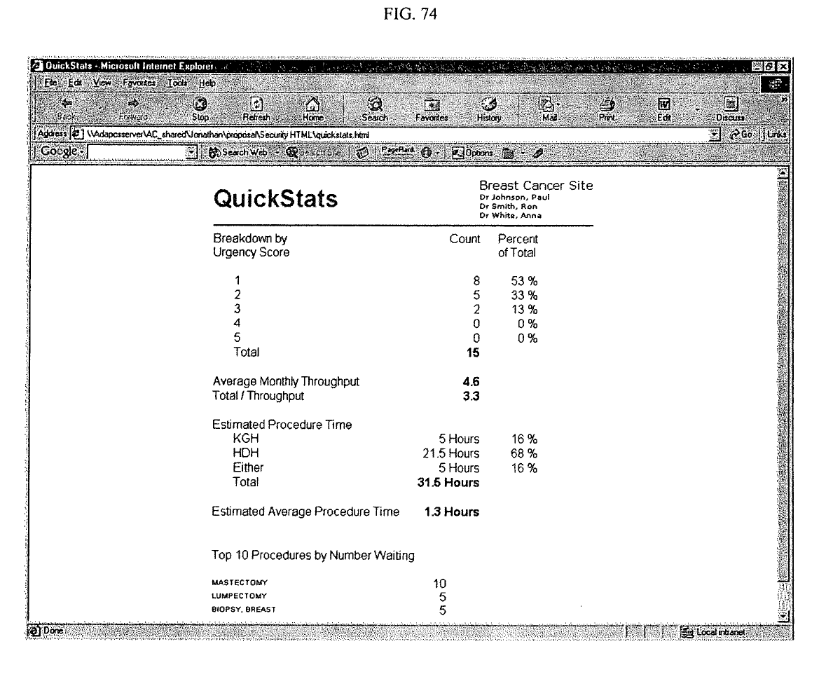

A Quick Stats Report (FIG. 74)—A Quick Stats Report is available via a text click on any main waiting list screen. (It should be noted that at log-on lists can be selected to be for a single surgeon or for multiple surgeons) These reports present a summary of those currently waiting by urgency category and the ratio of total number of patients on the list to average monthly OR throughput for that (or these) surgeon(s). These two elements allow an immediate understanding of approximate waiting time by urgency category. In addition the top ten procedures on the list are displayed along with the number waiting. Quick Stats Report supports the provision of Quick Stat formatted reports based on Diagnosis, Disease Category and Procedure at either a single provider or multiple provider level.

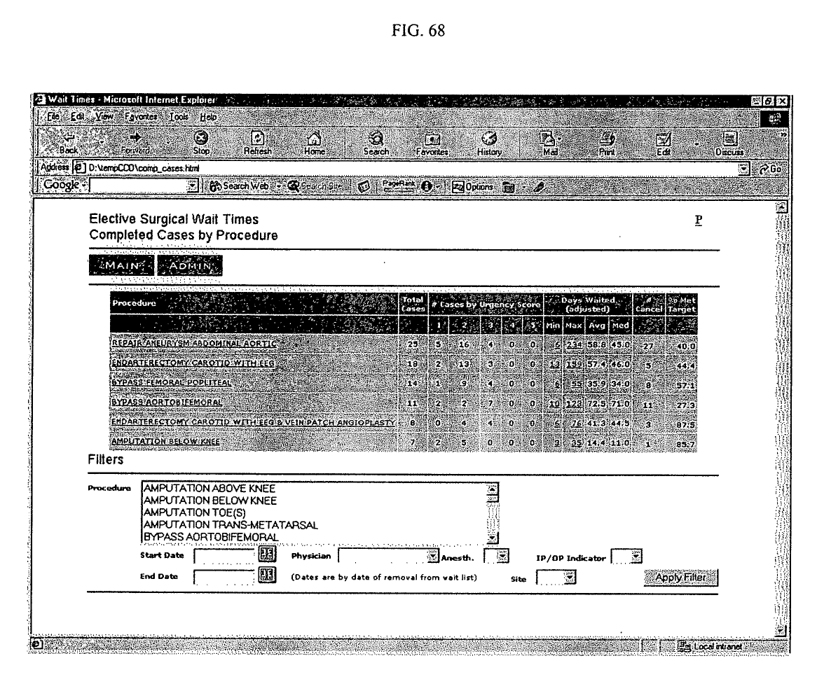

Completed Cases Wait Time Summary Report (FIG. 68)—For each surgeon or group of surgeons a list is presented of those waiting by procedural category in order of frequency. For each procedure the report presents the number of patients, the numbers by urgency category, the minimum and maximum time waited, the mean and median time waited, the number of cancellations and the percentage of patients treated within the target time. By a click on any procedure a link is made to a procedure specific wait time report.

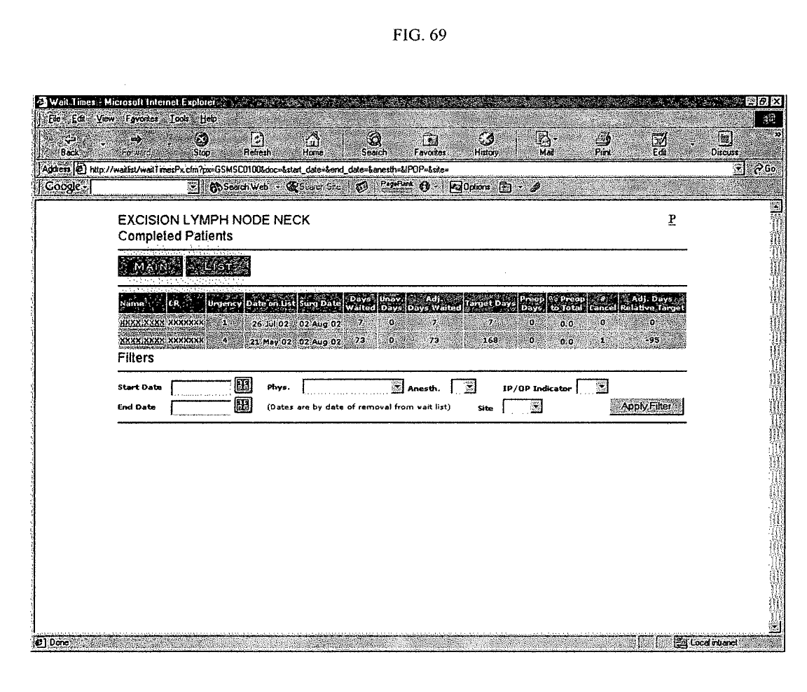

Procedure Specific Completed Wait Time Report (FIG. 69)—For each patient of that surgeon or group of surgeons with that procedure the report presents the patient's name and ID #, urgency category, date on list and surgery date, total days waited, days patient unavailable, adjusted days i.e. total days minus unavailable days, target days, days waited for preoperative procedure or test, percentage of adjusted days represented by pre-op procedure days, number of cancellations and days waited over or under target. By a click on any patient name a link is made to a summary of that patient's wait history.

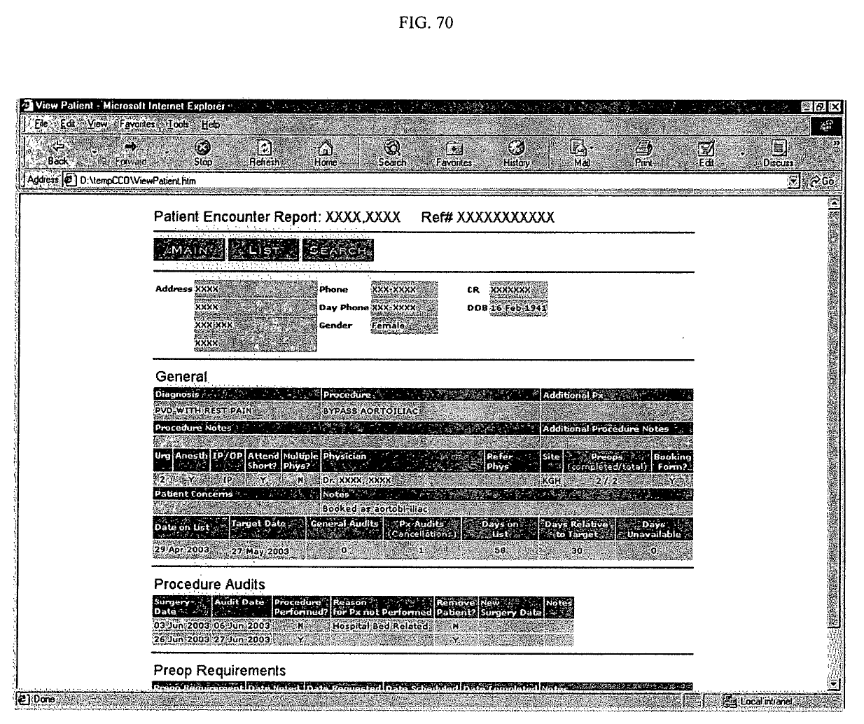

Completed Patient Summary Report (FIG. 70)—This report contains a complete summary of the patient's data including details of any cancellation.

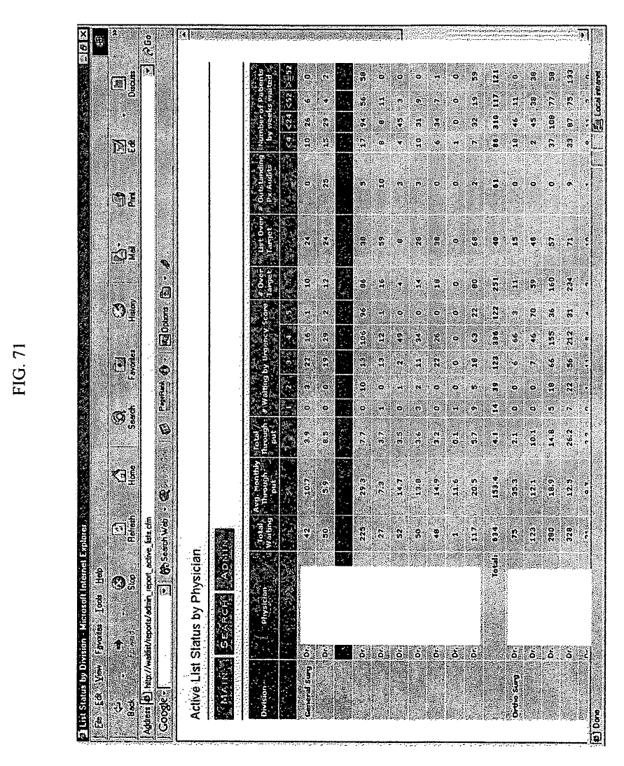

Administrative Report on Physicians Active Lists (FIG. 71)—These summary reports are available to users based on their privileges. They show for each surgeon, arranged by surgical service, the total number of patients on the list, the average monthly number of patients operated on, the distribution of list patients by urgency category, the number of patients over target, the percentage of patients over target time and the number outstanding procedures audit. This last number is an indication of whether the list is being maintained and is valid. When that number is over 50% the surgeon is highlighted on the report.

Defined users/groups have access to the management system 0 web-based administrative tool. This tool allows non-technical users to manage access to and control of the application. Administrators may add or remove users or groups of users to the application. Administrators may define user or group level access to any resources within the application. Individual resources include physician level access, report level access, and audit level access. Administrators may execute ASCII data dumps of core the management system 0 tables to a specified directory.

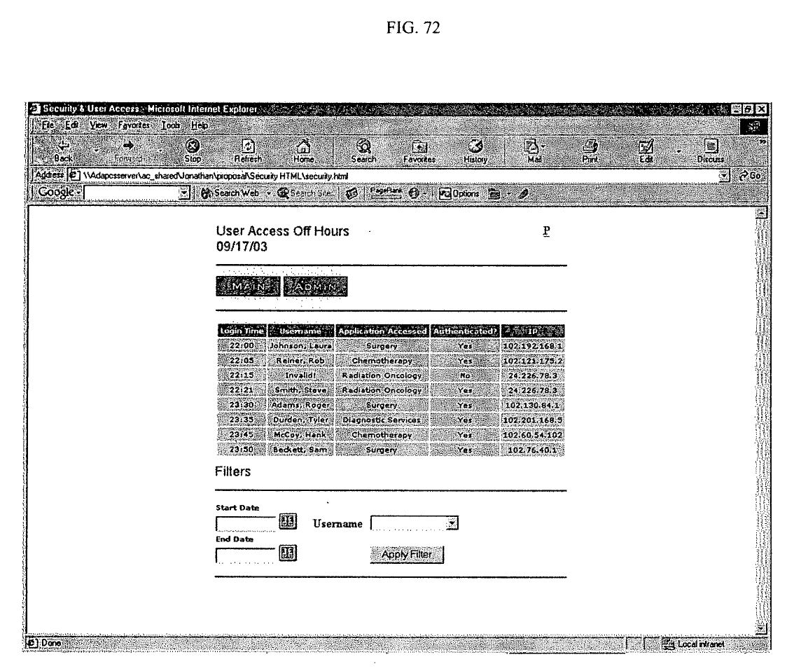

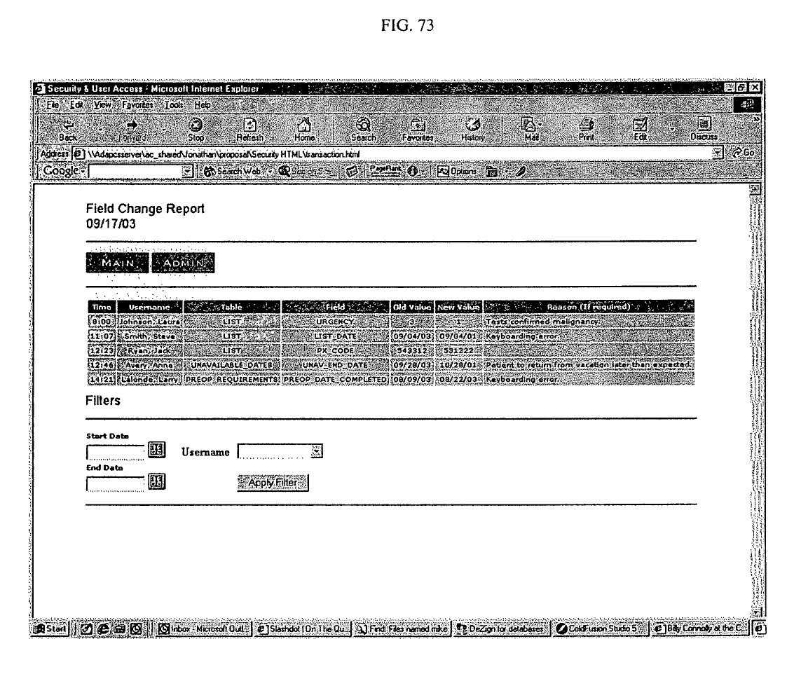

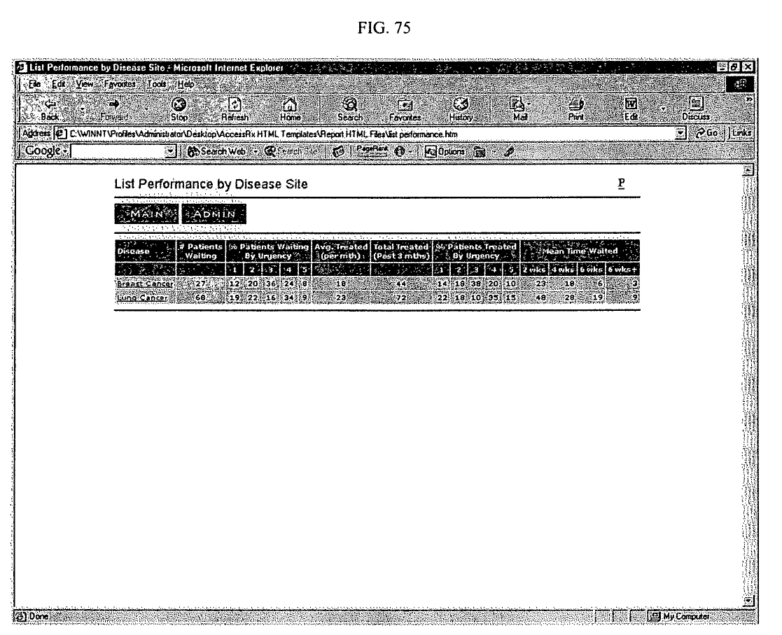

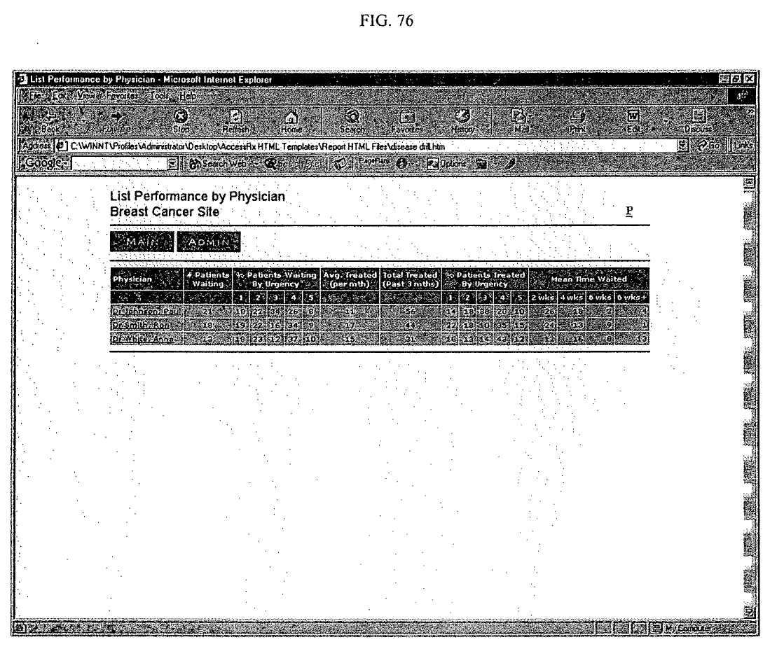

Functionality allows administrators to access server error logs to troubleshoot problems. Functionality allows administrators to track changes to specific fields in the by user and modality (FIG. 73). Functionality allows administrators to view access logs by user. Functionality allows administrators to monitor failed logon/logon during abnormal hours (FIG. 72). Functionality also provides a report showing list performance by disease site (FIG. 75) and list performance by physician by disease site (FIG. 76).

The management system 0 is an Oracle-based software is designed for integration into the workflow of physicians as well as clinic and operating room staff. The front end of the management system 0 adds value to actual workflow in the clinical environment, thus ensuring acceptance and comprehensive and accurate data entry. The back end of the management system 0 is therefore well prepared to supports a wide variety of registry reporting roles in support of administration, management and public accountability.

The product is scalable to multiple sites and networks of sites. For example, surgery data could be collected for an individual physician, for a group of physicians, for an entire hospital, or for a group of any number of hospitals forming a regional health authority or an entire province or state.

The current embodiment of the management system 0 utilizes a flexible and modular architecture to facilitate data collection and reporting on data collected in a variety of clinical settings. It can be easily customized to accommodate differences in workflow for physicians and staff in most clinical settings.

The management system 0 user interface and reports are fully compatible with different web browsers, including IE 5.0 and Netscape 4.0 and higher version browsers. The management system 0 currently supports connections including dial-up access with a 28K baud modem or higher, and broadband connections including cable, DSL, fractional T1 and higher. Latency in the commercial application is no greater than 0.5 seconds (typical, 2 seconds worst case) using a 28K baud modem connection. The current embodiment of the management system 0 utilizes either VPN or firewall protected. 128-bit SSL could be implemented to provide security certificate-based secure connectivity.

The management system 0 uses an open architecture to provide the ability to interface to other systems and is designed such that other systems may interface to and from it. Native Oracle database queries are allowed against the management system 0 databases. Import and export functionality is provided.

In the remainder of this description certain embodiments of the management system 0 will be described that may vary from those previously described. To the extent of such variations, the embodiments are alternative to those previously described and may be used in substitution for or in combination with the previous embodiments or features thereof. To the extent that the embodiments are the same as the previous embodiments, the description will not be repeated and the principles previously described will apply equally to these latter embodiments.

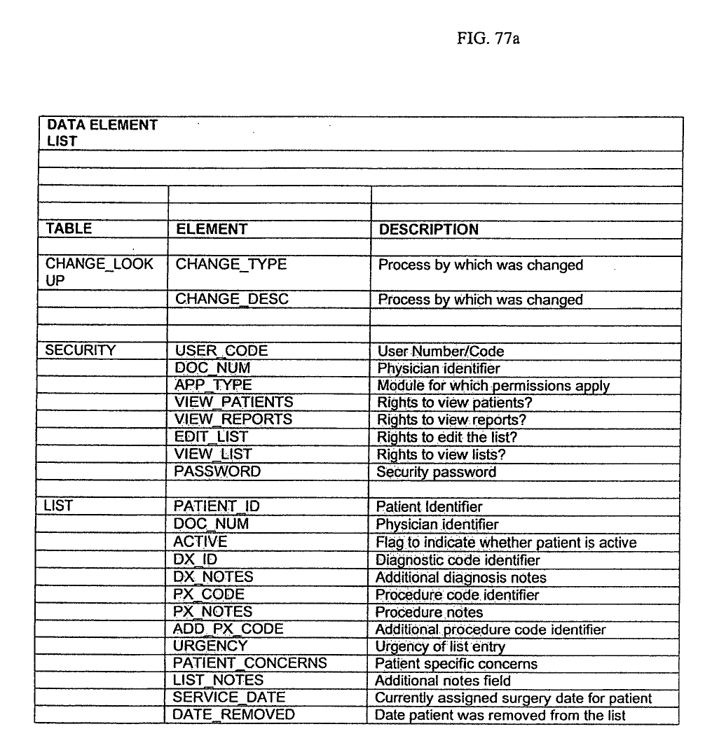

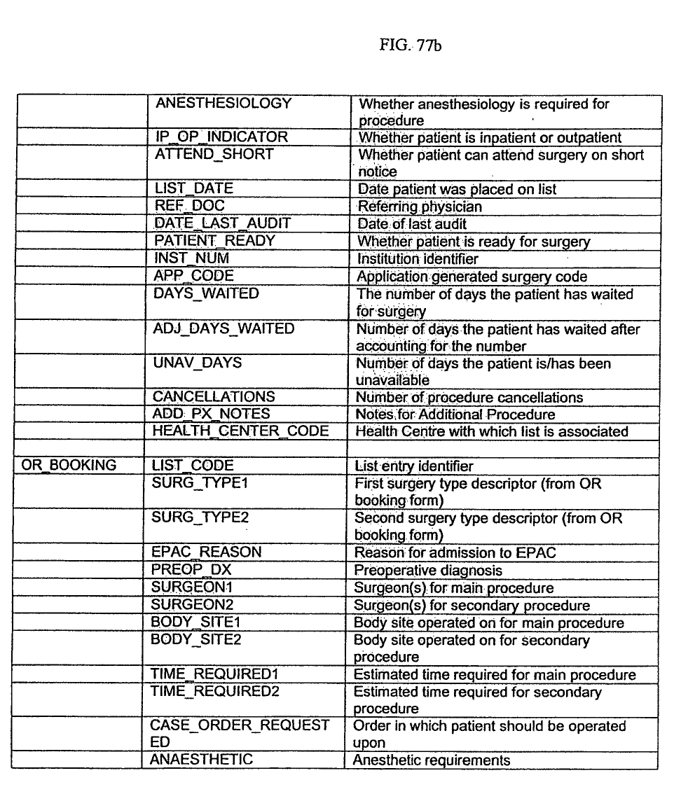

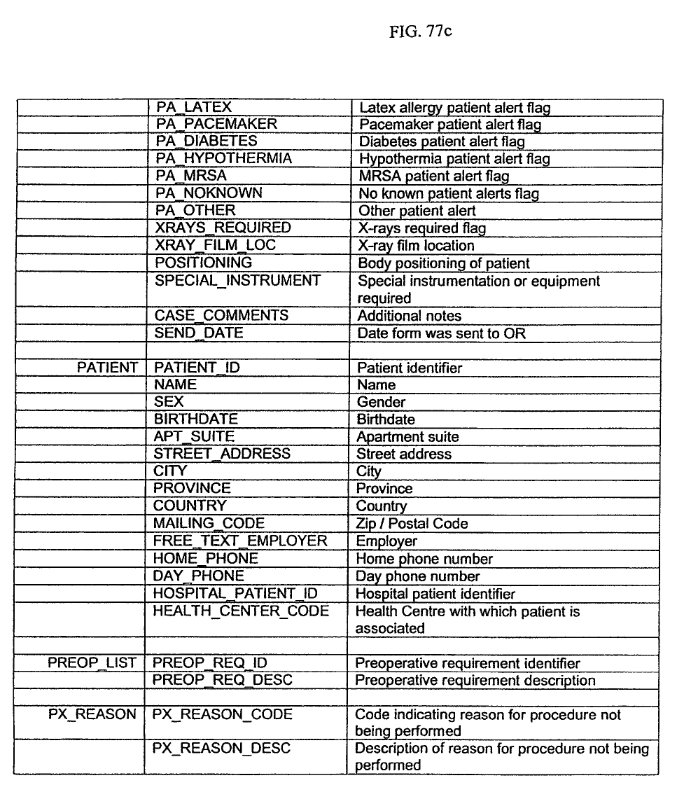

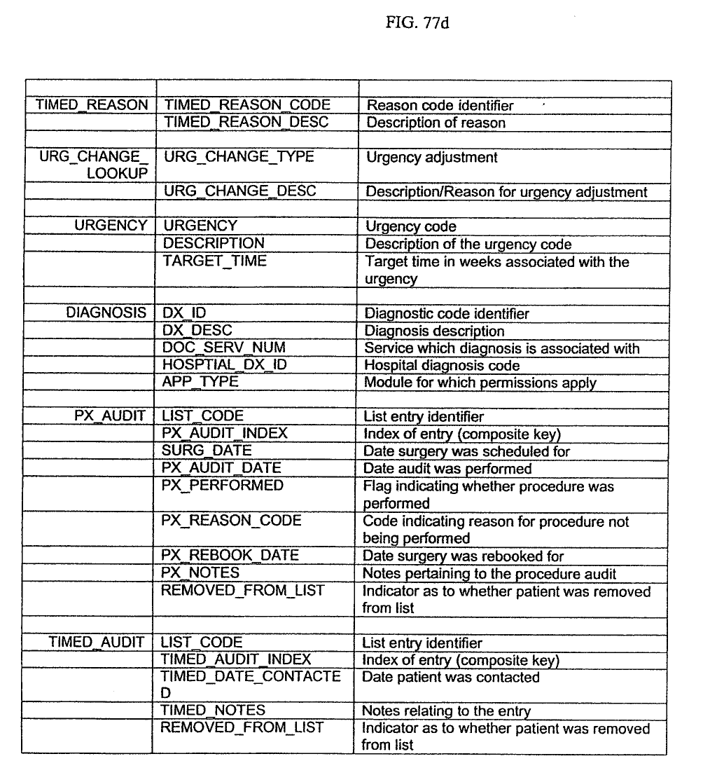

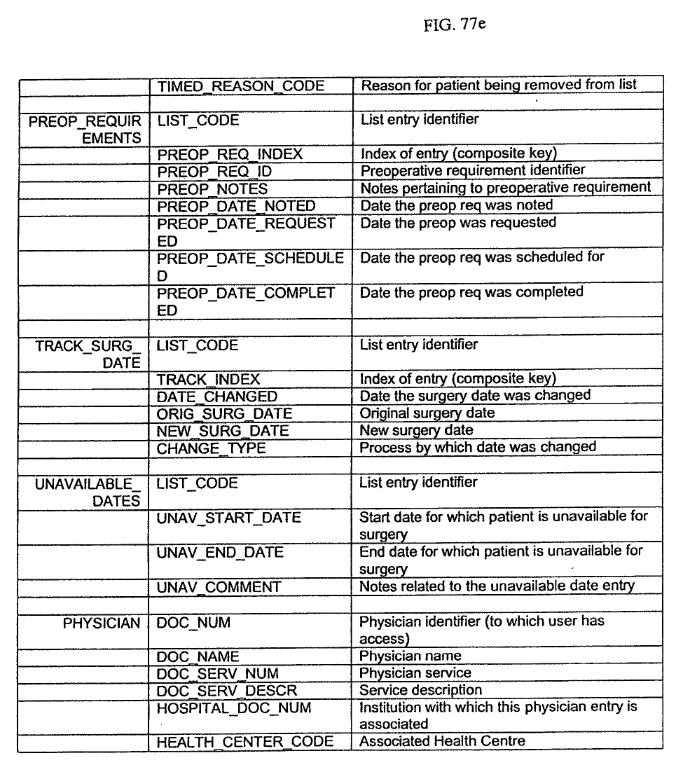

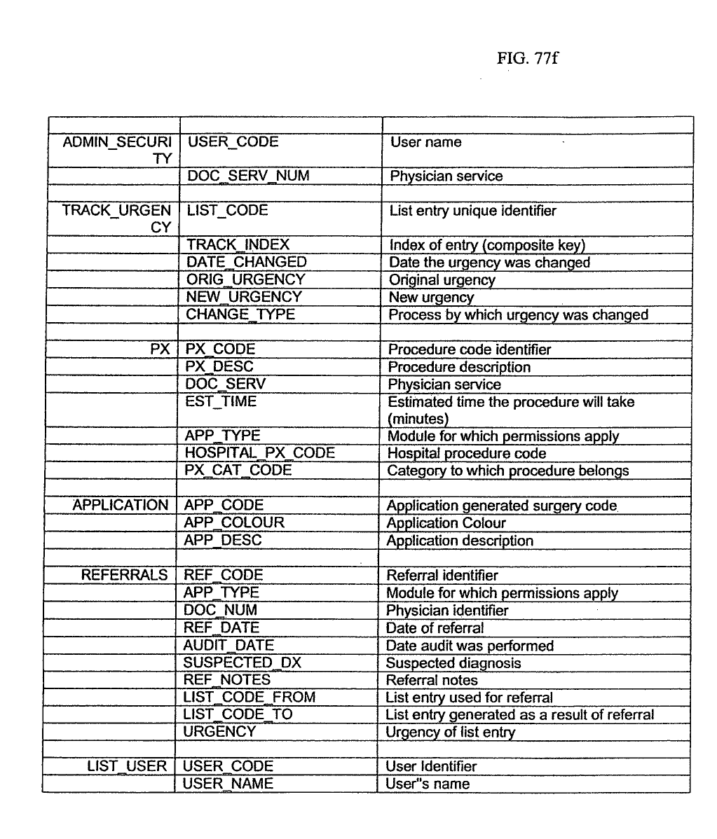

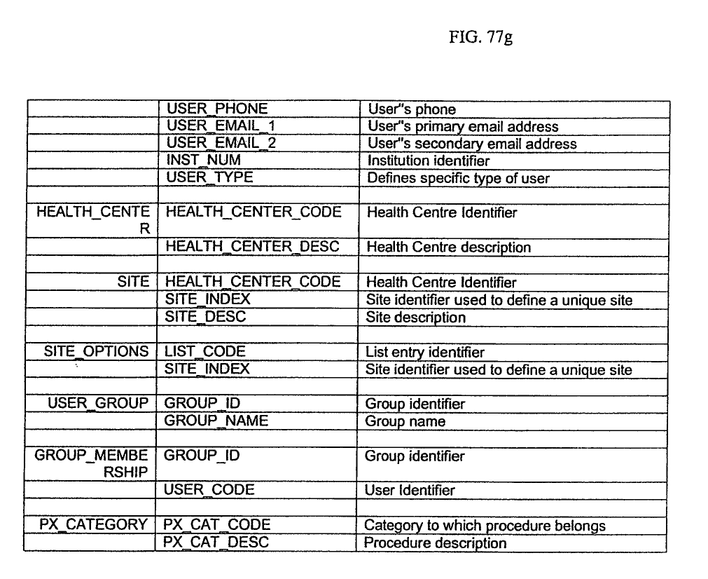

Referring to FIG. 77a through g, this embodiment of the management system 0 utilizes both a standard data dictionary for internal representation of data and metadata. The user interface uses industry and regional/local standard definitions, such as the definitions supported by the local operating room information systems and required by local physicians and operating rooms.

The current embodiment of the management system 0 is capable of capturing an unlimited number of event markers and times along the patient care continuum. Both the data model and user interface screens are designed to facilitate this capability. The management system 0 captures date-time information from electronic sources where it is available, but also has user interface screens

The management system 0 currently uses both on-screen and paper forms to meet the workflow needs of Kingston General Hospital, Kingston Hotel Dieu and their referring physicians. These forms are content sensitive to meet the varying geographic, physician specialist, O.R. policy and O.R. information system, and technology environments in which the management system 0 operates. As disease site specific care is identified the management system 0 can be adapted to provide all required on-screen and paper forms to make the disease care process both efficient and adaptable to the needs of disease site, region and location, diagnostic and therapeutic modality, and local and regional policies.

The current embodiment of the management system 0 provides a wide range of system reports for wait list management and audit control. Some examples of these reports are shown in Appendix E to illustrate the range of reports currently available. Although these reports are shown as web screen output, printed reports with the same elements and layout, but formatted for printer, are available.

The management system 0 is capable of migrating a variety of existing tables to ASCII format with user-defined delimiters, accessible by administrators. The specifics of how these files are accessed by users are easily refined. These exports can occur from the web-based administrator, or on the database level.

The management system 0 can incorporate filters and other utilities to populate the management system 0 databases using legacy data from hospitals and other facilities. The management system 0 can support technology to ensure patient confidentiality, data security and access control, and when used in association with policies, physical and information security, and client agreements can meet all applicable laws and regulations and to meet the standards established in the healthcare industry.

The management system 0 can support the ability to define users, groups, and security protocols specific to them. These permissions are completely customizable. The current embodiment of the management system 0 permits restriction of individual user access by group or user. In addition, the management system 0 can use database encryption for elements that require that level of security and confidentiality. The required level of security and scale server capabilities should be balanced with user latency performance standards at that level of encryption.

The management system 0 tracks all changes made to patient surgery date and urgency score for audit purposes.

The management system 0 supports VPN connectivity for remote troubleshooting.

As an example, the management system 0 can easily support 90 users with 15-20 simultaneous users on a routine basis using dual-processor Pentium 4 servers as web- and database-servers.

The current embodiment of the management system 0 has been developed using ColdFusion™ MX as a server platform and Oracle™ 9i as a database platform to meet performance needs well in excess of those discussed above. A Macromedia™ white paper entitled “ColdFusion MX 6.1 Performance Brief,” dated August 2003 (available on the Macromedia web site) addresses the web server performance to be anticipated in a system with, for example, 2000 users. Macromedia tested several configurations of web servers running ColdFusion 6.1 and with separate database servers. A typical database server was a 4-processor 500 MHz server running MS SQL 2000. With a web server consisting of MS Windows™ server 2000 running IIS 5.0 on a dual-processor 2.8 GHz Xeon server with 2650 Mbytes of RAM, response times of 0.6 seconds were typical with a simulated open connection load equivalent to 600 active users. Even on a dual processor 500 MHz server running Windows Server 2003 and IIS 6.0 with 1 Gbyte of RAM the typical response time was about 2 seconds. The use of a third-party high-performance web server was reported in a similar Macromedia white paper to reduce the average response time to about 0.3 seconds with a simulated load of 2000 active user sessions.

The current embodiment of the management system 0 uses Oracle 9i as a database. This database is scalable to terabyte and greater storage needs, although the management system 0 is currently limited to about 100,000,000 patient encounters, based on 2000 bytes solely by current disk capacity.

The current data model, Oracle 9i database, and specified server configurations have no practical limitations on numbers of patients, growth rates, disease sites, or number of specific diseases. The specified configurations are scalable.

The management system 0 captures data elements for patients with multiple diseases across referral, surgical diagnostic and therapeutic, endoscopic diagnostic and therapeutic, and other modalities.

An embodiment of the management system 0 for up to 2000 users with 400 concurrent users could utilize, for example:

a) Internet/Intranet Server

HP ProLiant™ DL380 G3 Intel® Xeon™ Processor

Dual Processor

2 GB RAM

36 GB HDx3 in RAID 5 configuration

20/40 GB backup tape drive

Redundant power supplies

OS—Windows Server 2003 Enterprise

Web Server—IIS 6.0

Macromedia Coldfusion MX 6.1

b) DBMS Server

HP ProLiant DL580 G2 Intel® Xeon MP

Quad Processor

4 GB Ram

36 GB HDx5 in RAID 5 configuration

Redundant power supplies

Oracle 9i Database

OS—Windows 2003 Server, Enterprise

c) Encryption

Extra-firewall Transmission—128 bit SSL through Cisco VPN

Database—Oracle Advanced Security

d) Development tool

Macromedia Coldfusion Studio MX

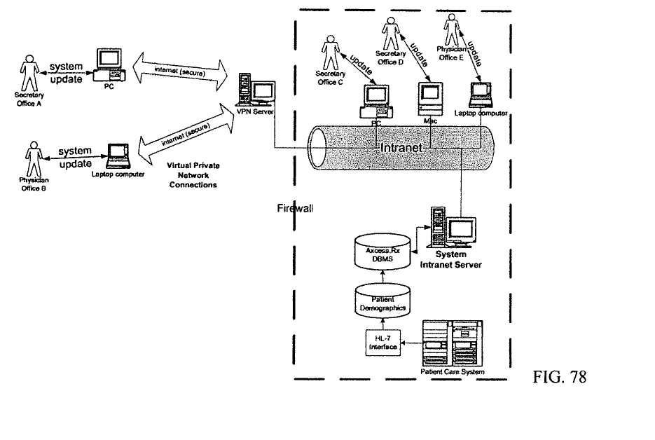

The physical and logical design and configuration of the management system 0 application is shown in FIG. 78. The acceptance of data from facility data systems and from user offices in an operational patient management mode is reflected, as is the storage of these data in a central database and operational support and reporting from this central database. The management system 0 includes secure VPN connectivity to specialist and primary care provider offices.

Referring again to FIG. 5, the current embodiment of the management system 0 embodies a patient-centric vision. Patient visits, patient treatments, and patient outcomes forming the workflow backbone of the patient care process, represented in a temporal order, and diagnostic tests and therapies are represented as occurring at specific times along this backbone. The intervals between these specific times during the care of an individual patient are the wait times that will be managed.

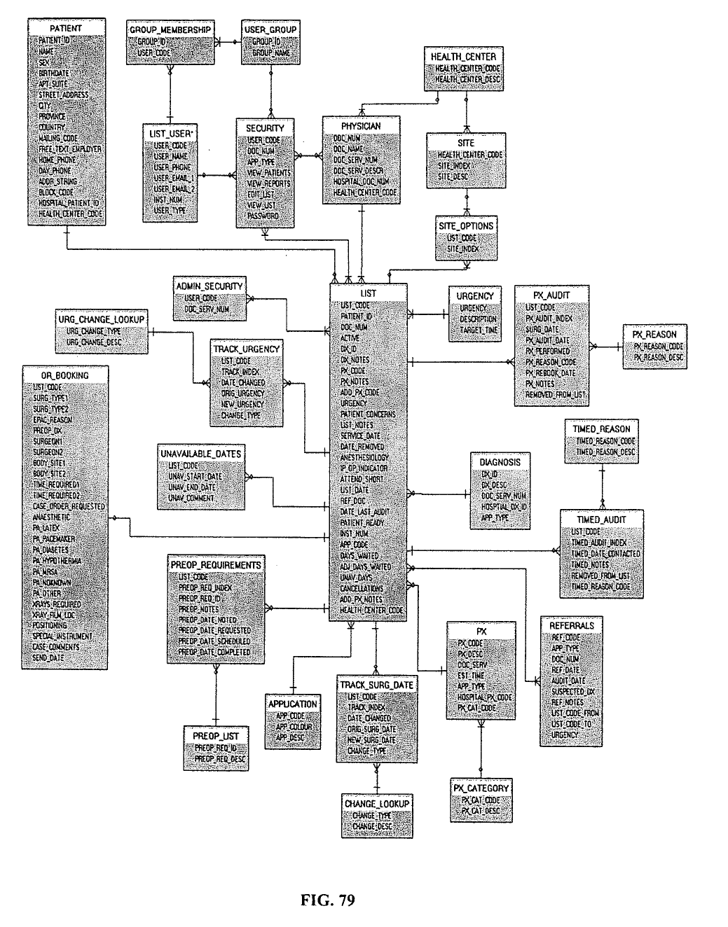

An example data model is shown in FIG. 79. This relational database model of the management system 0 reflects the above vision exactly. The central fact table (List) reflects the primacy of the patient in defining the backbone of the model, and the captured dates in related tables such as surgical and unavailable date tables and in diagnostic tables capture a potentially unlimited number of event times along the patient care timeline, a feature that is allowed by the relational nature of the data model.

Diagnostic modalities such as CT scans and Lab tests, and their related times are captured in the preoperative requirements table. The management system 0 captures all regional physicians, and it captures many physician roles and relationships. It can be adapted to capture all of the physician roles and relationships that are present in the cancer care of lung and breast cancer patients.

In order to accommodate additional disease models, minor additions are necessary to reflect the appropriate list of care providers/specialties appearing in the lists. This particular change requires no additional coding, but rather additions to rows in the database. A relatively modest change in the system. Although the details of the code changes to accomplish the above user interface are not as evident as the data model changes required to support the added functionality, the use of state-of-the-art integrated development environments and tools, i.e. Macromedia Dreamweaver™ MX and Studio, ColdFusion MX WebServer environment, and Oracle 9i makes these changes straightforward. The fact that they are also modifications of a modern, object-based application also makes them enormously less complex than a de-novo development.

The management system 0 also offers extraordinary capabilities to address patient outcomes reporting. In addition to the standard patient outcome analyses offered in the management system 0 itself, the management system 0 can leverage the state-of-the-art clinical outcomes reporting capability, such as AdapCS DYNAMO™, to extend this capability.

The management system 0 routinely interfaces with a variety of hospital systems to obtain its data. Specifically, all patient demographics are captured from a relational data warehouse. When this is an interface between Oracle products, it is a straightforward matter to develop additional interfaces to capture a greater spectrum of data. Some business logic would be added to the application to process and insert data to the central wait list database in a consistent fashion.

The current embodiments of the management system 0 are a web-based application capturing data to a centralized database, supporting 128 bit SSL encryption and may interact with a variety of client configurations.

The management system 0 can access robust, dynamic, live reports of all data captured by the system. These reports are web-based, but any number of permutations of the data may be generated from Oracle using standard query tools.

These reports are web-based, representing the most current information in the database. The users may also filter or sort the reports on a variety of criteria, which may be expanded in an almost unlimited fashion. Additional reports of nearly any conceivable variety are available on an ad hoc basis to support specific one-time requirements.

It will be understood by those skilled in the art that this description is made with reference to the preferred embodiment and that it is possible to make other embodiments employing the principles of the invention which fall within its spirit and scope as defined by the following claims.

We claim:

1. A management system, comprising:
a) a database for storing patient waiting data, including the date a patient entered onto a list for a procedure, an urgency score for the patient for the procedure, a target number of days to receive the procedure based on the urgency score, and whether or not the patient indicates that the patient is unavailable,
b) means for calculating a target date for the patient for the procedure based on the date the patient entered onto the list for that procedure and the target number of days, and
c) means for calculating, for any given date prior to the procedure taking place, the number of days the given date is from the target date.

2. The system of claim 1, wherein the database is for storing and the means are for calculating for a plurality of patients, and wherein the system ranks the patients according to the number of days each patient is from target for the procedure.

3. The system of claim 1, further comprising data entry means for acquiring at least part of the patient waiting data.

4. The system of claim 3, wherein the data entry means comprises data acquisition forms.

5. The system of claim 1, wherein the means for calculating comprise data processing modules.

6. The system of claim 1, further comprising a list management module that includes the means for calculating, and includes means for displaying the number of days each patient is from its respective target date.

7. The system of claim 2, further comprising a list management module that includes the means for calculating, and includes means for displaying the ranking of each patient.

8. The system of claim 1, further comprising means for displaying aggregate days from target date data for a plurality of patients.

9. The system of claim 8, wherein the plurality of patients are grouped according to at least one of a single procedure, a single doctor, a single site, and an administrative entity.

10. The system of claim 1, further comprising means for generating an audit of waiting list data based on the target date of a patient.

11. The system of claim 1, further comprising means for auditing waiting list data of patients that have waited longer than a defined period.

12. The system of claim 1, further comprising means for calculating a total number of days a patient is unavailable and means for calculating the total number of days a patient has been on the list, and wherein the database stores the total number of days a patient is unavailable for the procedure, and the system further comprises means for adjusting the calculated number of days that the patient has been on the list by the total number of days the patient is unavailable.

13. The system of claim 1, wherein the database further stores a record of pre-procedure requirements required before the procedure can take place, and stores whether or not each pre-procedure requirement has taken place.

14. The system of claim 13, further comprising means for providing notification of outstanding requirements related to the pre-procedure requirements.

15. The system of claim 1, further comprising means for indicating that the patient is ready.

16. The system of claim 1 further comprising means for filtering the list of patients awaiting procedures according to at least one resource criterion.

17. The system of claim 16, wherein the at least one resource criterion is selected from the group consisting of type of anaesthetic required, inpatient or outpatient facilities, and length of time facilities are required.

18. The system of claim 1, further comprising means for indicating that the patient is ready when all preoperative requirements have been met and the patient is not unavailable.

19. The system of claim 1, further comprising means to generate reports on active patient waiting list status.

20. The system of claim 1, further comprising means to generate reports on active patient waiting list status based on at least one resource criterion.

21. The system of claim 1, further comprising an interface to an operating room (OR) booking system, facilitating the flow of data to and from such a system.

22. The system of claim 1, further comprising an interface to a hospital central patient index database, facilitating the flow of data to and from such a database.

23. A management system, comprising:
a) a database for storing patient waiting data, including the date a patient entered onto a list for a procedure, an urgency score for the patient for the procedure, a target number of days to receive the procedure based on the urgency score, pre-procedure requirements required before the procedure can take place, and whether or not each pre-procedure requirement has taken place,
b) means for calculating a target date for the patient for the procedure based on the date the patient entered onto the list for that procedure and the target number of days, and
c) means for calculating, for any given date prior to the procedure taking place, the number of days the given date is from the target date.

24. The system of claim 23, further comprising means for indicating that the patient is ready.

25. The system of claim 23 further comprising means for filtering the list of patients awaiting procedures according to at least one resource criterion.

26. A database schema for use in a management system, comprising:
a) a first field for storing the date a patient entered onto a list for a procedure,
b) a second field for storing an urgency score for the patient for the procedure,
c) a third field for storing a target number of days to receive the procedure based on the urgency score, and
d) a fourth field for storing whether or not the patient indicates that the patient is unavailable, wherein data stored in the fields is available prior to the procedure taking place.

27. A database schema for use in a management system, comprising:
a) a first field for storing the date a patient entered onto a list for a procedure,
b) a second field for storing an urgency score for the patient for the procedure,
c) a third field for storing a target number of days to receive the procedure based on the urgency score,
d) a fourth field for storing a pre-procedure requirement required before the procedure can take place, and
e) a fifth field for storing whether or not each pre-procedure requirement has taken place, wherein data stored in the fields is available prior to the procedure taking place.

28. Computer program instructions on computer readable media for use in association with a database containing a first field storing the date a patient entered onto a list for a procedure, a second field storing an urgency score for the patient for the procedure, a third field storing a target number of days to receive the procedure based on the urgency score, and a fourth field for storing whether or not the patient indicates that the patient is unavailable, the computer program instructions on computer readable media comprising:
a) instructions for a computer to calculate a target date for the patient for the procedure based on the date the patient entered onto the list for that procedure and the target number of days, and
b) instructions for a computer to calculate, for any given date prior to the procedure taking place, the number of days the given date is from the target date.

29. Computer program instructions on computer readable media for use in association with a database containing a first field storing the date a patient entered onto a list for a procedure, a second field storing an urgency score for the patient for the procedure, a third field storing a target number of days to receive the procedure based on the urgency score, a fourth field for storing a pre-procedure requirement required before the procedure can take place, and a fifth field for storing whether or not each pre-procedure requirement has taken place, the computer program instructions on computer readable media comprising:
a) instructions for a computer to calculate a target date for the patient for the procedure based on the date the patient entered onto the list for that procedure and the target number of days, and
b) instructions for a computer to calculate, for any given date prior to the procedure taking place, the number of days the given date is from the target date.

30. A user interface screen comprising:
a) a first data element for viewing the date a patient entered onto a list for a procedure,
b) a second data element for viewing an urgency score for the patient for the procedure,
c) a third data element for viewing a target number of days to receive the procedure based on the urgency score, and
d) a fourth data element for viewing whether or not the patient indicates that the patient is unavailable.

31. A user interface screen comprising:
a) a first data element for viewing the date a patient entered onto a list for a procedure,
b) a second data element for viewing an urgency score for the patient for the procedure,
c) a third data element for viewing a target number of days to receive the procedure based on the urgency score,
d) a fourth data element for viewing a pre-procedure requirement required before the procedure can take place, and
e) a fifth data element for viewing whether or not each pre-procedure requirement has taken place.

32. A method of operating a management system, comprising:
a) storing in a database patient waiting data, including the date a patient entered onto a list for a procedure, an urgency score for the patient for the procedure, a target number of days to receive the procedure based on the urgency score, and whether or not the patient indicates that the patient is unavailable,
b) calculating a target date for the patient for the procedure based on the date the patient entered onto the list for that procedure and the target number of days, and
c) calculating, for any given date prior to the procedure taking place, the number of days the given date is from the target date.

33. A method of operating a management system, comprising:
a) storing in a database patient waiting data, including the date a patient entered onto a list for a procedure, an urgency score for the patient for the procedure, a target number of days to receive the procedure based on the urgency score, pre-procedure requirements required before the procedure can take place, and whether or not each pre-procedure requirement has taken place,
b) calculating a target date for the patient for the procedure based on the date the patient entered onto the list for that procedure and the target number of days, and
c) calculating, for any given date prior to the procedure taking place, the number of days the given date is from the target date.

34. A method of managing a patient, comprising:
a) selecting an urgency score for the patient for a procedure;
b) calculating a target date for the patient for the procedure based on the date the patient entered onto a list for that procedure and the target number of days,
c) calculating, for any given date prior to the procedure taking place, the number of days the given date is from the target date, and
d) storing whether or not the patient indicates that the patient is unavailable.

35. The method of claim 34, further comprising filtering the list based on at least one of the criteria in a)-d).

36. The method of claim 35, further comprising tracking pre-procedure requirements that must take place prior to the patient having the procedure.

37. The method of claim 36, further comprising providing notification of outstanding requirements related to the pre-procedure requirements.

38. A method of managing a patient, comprising:
a) selecting an urgency score for the patient for a procedure;
b) calculating a target date for the patient for the procedure based on the date the patient entered onto a list for that procedure and the target number of days,
c) calculating, for any given date prior to the procedure taking place, the number of days the given date is from the target date,
d) storing a pre-procedure requirement required before the procedure can take place, and
e) storing whether or not each pre-procedure requirement has taken place.

39. The method of claim 38, further comprising filtering the list based on at least one of the criteria in a)-e).

40. A management system, comprising:
a) a database for storing patient waiting data, including the date a patient entered onto a list for a procedure, an urgency score for the patient for the procedure, a target number of days to receive the procedure based on the urgency score, and whether or not the patient indicates that the patient is unavailable,
b) a calculator for calculating a target date for the patient for the procedure based on the date the patient entered onto the list for that procedure and the target number of days, and
c) a calculator for calculating, for any given date prior to the procedure taking place, the number of days the given date is from the target date.

41. A management system, comprising:
a) a database for storing patient waiting data, including the date a patient entered onto a list for a procedure, an urgency score for the patient for the procedure, a target number of days to receive the procedure based on the urgency score, pre-procedure requirements required before the procedure can take place, and whether or not each pre-procedure requirement has taken place,
b) a calculator for calculating a target date for the patient for the procedure based on the date the patient entered onto the list for that procedure and the target number of days, and
c) a calculator for calculating, for any given date prior to the procedure taking place, the number of days the given date is from the target date.

42. The management system of claim 1 further comprising:
a plurality of modalities, each modality utilizing the stored patient waiting data for a distinct waiting list, and
a referral process for online referral of a patient to a waiting list of one of the modalities.

43. The management system of claim 42 wherein:
the modalities utilize the stored patient waiting data for waiting lists in a plurality of healthcare fields.

44. The management system of claim 42 wherein:
the referral process permits patients to be referred from one modality to another modality, and the management system enables patient status to be tracked through all modalities.

45. The management system of claim 1 further comprising:
a calendar booking process for online booking of a patient for a procedure based on data from the database, and data of times resources for the procedure are available to be booked.

46. A management system, comprising:
a) a database for storing patient data, including an urgency score for a patient for a procedure, and whether or not the patient indicates that the patient is unavailable,
b) a plurality of modalities, each modality utilizing the stored patient data for a distinct waiting list of patients, and
c) a referral process for online referral of a patient to a waiting list of one of the modalities.

47. The system of claim 46, wherein the database further stores a record of pre-procedure requirements required before the procedure can take place, and stores whether or not each pre-procedure requirement has taken place.
